(19) United States
(12) Patent Application Publication
(10) Pub. No.: US 2011/0093418 A1
(43) Pub. Date: Apr. 21, 2011

(54) AI Time Machine

(76) Inventor: Mitchell Kwok, Honolulu, HI (US)

(21) Appl. No.: 12/973,955

(22) Filed: Dec. 21, 2010

Related U.S. Application Data
(63) Continuation-in-part of application No. 12/471,382, filed on May 24, 2009.
Application No. 12/471,382 is a continuation-in-part of application No. 12/129,231, filed on May 29, 2008.
Application No. 12/129,231 is a continuation-in-part of application No. 12/110,313, filed on Apr. 26, 2008.
(60) Provisional application No. 61/155,113, filed on Feb. 24, 2009.
(60) Provisional application No. 61/083,930, filed on Jul. 27, 2008.
(60) Provisional application No. 61/080,910, filed on Jul. 15, 2008.
(60) Provisional application No. 61/079,109, filed on Jul. 8, 2008.
(60) Provisional application No. 61/077,178, filed on Jul. 1, 2008.
(60) Provisional application No. 61/074,634, filed on Jun. 22, 2008.
(60) Provisional application No. 61/035,645, filed on Mar. 11, 2008.
(60) Provisional application No. 61/028,885, filed on Feb. 14, 2008.

(51) Int. Cl. G06F 15/18

(52) U.S. Cl. 706/12

(57) ABSTRACT

A method for an AI time machine to accept sequential input tasks from at least one user, manage tasks, and execute tasks simultaneously or sequentially. Tasks specified by a user can be accomplished in the virtual world or in the real world and includes extracting digital data from electronic devices or manipulation of objects in the real world. The AI time machine's data structures, comprising: at least one dynamic robot to train the AI time machine; a main program with two modes: training mode and standard mode; external technologies, comprising: universal artificial intelligence programs, human level robots, psychic robots, super intelligent robots, the AI time machine, dynamic robots, a signalless technology, atom manipulators, ghost machines, a universal CPU, an autonomous prediction internet, and a 4-d computer; a videogame environment for virtual characters to do and store work; a prediction internet; a universal brain to store dynamic robot pathways or virtual character pathways, said universal brain, comprising: a real world brain, a virtual world brain, and a time machine world brain; a timeline of Earth that records predicted knowledge of Earth's past, current and future; a future United States government system; and a long-term memory. The present invention further serves as a universal AI to control at least one of the following: a machine, a hierarchical team of machines, a universal machine and a transforming machine.

### CROSS REFERENCE TO RELATED APPLICATIONS

This is a Continuation-in-Part application of U.S. Ser. No. 12/471,382 filed on May 24, 2009, entitled: Practical Time Machine Using Dynamic Efficient Virtual And Real Robots, which claims the benefit of U.S. Provisional Application No. 61/155,113, filed on Feb. 24, 2009, which claims the benefit of U.S. Provisional Application No. 61/083,930, filed on Jul. 27, 2008, which claims the benefit of U.S. Provisional Application No. 61/080,910, filed on Jul. 15, 2008, which claims the benefit of U.S. Provisional Application No. 61/079,109, filed on Jul. 8, 2008, which claims the benefit of U.S. Provisional Application No. 61/077,178, filed on Jul. 1, 2008, which claims the benefit of U.S. Provisional Application No. 61/074,634, filed on Jun. 22, 2008, which claims the benefit of U.S. Provisional Application No. 61/073,256, filed on Jun. 17, 2008, which claims the benefit of U.S. Provisional Application No. 61/053,334, filed on May 15, 2008, which is a Continuation-in-Part application of U.S. Ser. No. 12/135,132, filed on Jun. 6, 2008, entitled: Time Machine Software, which claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to technologies that accomplish tasks given by a user that require teams of human workers to extract digital information from electronic devices and manipulate objects in the real world. For example, the task of solving a crime includes dispatching detectives to collect information from the crime scene; and forensic investigators to analyze and process the evidence using a trinity of technologies. There are some things involved in solving a crime that can't be done inside a computer, but has to be done in the real world.

2. Description of Related Art

Prior art includes the following products: Google 3-d street view (January 2008); Google Picasa, Google goggles, (late 2008); Google visual search on android phones (November 2009), Google place search (November 2010), Google search engine with meaning (2010 and beyond); Microsoft's image processors (2007-2008), Microsoft bing.com (June 2009), Microsoft visual search for bing.com (Sep. 17, 2009), Microsoft kinect system (November 2010).

The products provided above are the evolution of artificial intelligence for the past several years. It started with image processors that can identify objects, events and actions (2007-2008) and then it moved to their visual searches (2009), finally it evolved into a camera system, such as the Kinect system and the Droid phones (2010). The next level is to build a universal artificial intelligence program that can drive a car, fly an airplane, steer a boat, control machines in a factory, cook food, or do janitor work. In addition, these technology companies are interested in building search engines with meaning.

Current search engines have no problem answering a question like: who holds the record for growing the largest pumpkin? However, when a user types in a question that require a little more research, the search engines fail in coming up with an answer. For example, if you type in this question into the search engines: what computer companies in Hawaii sells modem parts, accepts paypal as their payment options and uses FedEx as their mail carrier?, you won't get an answer. In 2010, I did Google searches on this task for 30 minutes and the search engine didn't list any links that were helpful. In fact, most of the links weren't remotely related to the task.

The problem is that the search engines give lists of websites that are the most popular and are searched by many users. When the search engines are confronted with a never before encountered search query, they can't find the websites the user is searching for.

Another problem is that the search engines only “searches” for information on the internet, but doesn't do complex tasks for users. If you type out this task into a search engine: “write an operating system that is better than Windows7 and download it into my computer”, nothing happens. Windows7 took Microsoft 30 years to build and millions of human programmers were needed to write the software.

Another problem is that the search engines are limited to analyzing, processing and extracting digital information from computers, exclusively. They can't control physical machines in the real world, nor can they manipulate physical objects in the real world. For example, if you type out this task into a search engine: “I want you to cook dinner in my kitchen and carry the food to my bedroom”, nothing happens. The reason why is because the search engines can only search for digital information on the internet.

Yet, another problem was proposed by DARPA in November of 2010. They held a contest for any technology company or university to design and build an autonomous machine that can not only drive a car, but also fly an airplane. The contest was held because no one has built such a universal machine yet.

These autonomous machines do tasks based on the commands from a user. An AI car is a simple autonomous machine. What if the military wanted a software program to control a tank (4-5 human workers) or to control an entire Starship with thousands of human workers. Even more complex is to build a software program to control an entire military, which includes: robot soldiers, military vehicles, robot commanders, and robot intelligence officers.

### SUMMARY OF THE INVENTION

The present invention is called the AI time machine and it is a task engine that does complex tasks for users. I'm trying to move away from a search engine and build a technology that can, not only, search for information online, but to also do complex tasks for users.

The present invention is like “a genie inside a computer” that can grant any wish the user desires. These tasks might include manipulation of objects in the real world, such as bringing people back from the dead or building a city or time travel or turning a 90 year old man into a 20 year old man.

I think the scaling issue must be addressed here. The present invention can do a simple task, such as solving one crime case for the FBI; or it can do a complex task, such as solving billions of crime cases for the FBI. In fact, the AI time machine has to accomplish “anything” the user wants. One type of complex task for the AI time machine is to manipulate all objects on Earth. An even more complex type of task is to manipulate all objects in our galaxy. Yet, an even more complex type of task is to manipulate all objects in our universe. Regardless of the complexity of the task, the AI time machine will structure intelligent robots (called virtual characters) in a hierarchical manner and divide the complex task into manageable parts for processing.

The AI time machine has user friendly interface functions that allow a user to use any media to communicate with the AI time machine. The user can give commands by speech, through a search box, through a fillable form, through a camera system that recognizes the user's body movements or a combination of media types.

Other capabilities of the AI time machine include controlling dummy robots or physical machines. The AI time machine can control dummy robots in a sewing factory to mass produce clothing. It can even control millions of autonomous vehicles structured in a hierarchical manner. For example, an entire traffic system can be controlled by the AI time machine so that cars, trucks, vehicles, and traffic towers can run autonomously.

The AI time machine controls physical machines by generating ghost machines to control them. For example, a car made in 1920 can be controlled by the AI time machine through a ghost machine. A human ghost (which is a non-physical machine) is generated by the AI time machine to control the 1920 car.

The distinction between a search engine and a task engine

A search engine searches for information on the web and output rankings of websites. A task engine is an advance version of a search engine. It does tasks for users and one of its tasks is to use a trinity of technologies (including search engines) to find information over the internet and recommend a list of websites.

To illustrate the difference between a search engine and a task engine, I will list 7 tasks that only a task engine can accomplish.

Task:

Task1. Search for all companies in Hawaii that sells modem parts, that accepts paypal, and uses FedEX as their mail carrier.

Task2. I want you to write an operating system that is better than Windows? (from scratch) and download it to my computer.

Task3. I want you to solve all crimes committed on Earth for the last 200 years and create a website to display the results.

Task4. I want you to disprove or prove all religions on Earth and set up a website to display the results.

Task5. I want you to bring back the world trade centers, the 4 planes, and the 3,000+ people that died on Sep. 11, 2001. Restore these target objects to the state they were in on Sep. 10, 2001.

Task6. I want to time travel to Nov. 12, 1941. The target object is the entire Earth.

Task7. I want you to control all electronic devices or computers connected to the internet. Write the words “hello world” on each electronic device's screen.

I want the reader to type out each task into a search engine. Nothing happens when the reader presses the submit button. The reason why is because the current search engines (2010) searches for information online and they don't do complex tasks for users.

The AI time machine is a task engine and it has user friendly interface functions that do tasks for the user. All the user has to do is type out the 7 tasks individually into the AI time machine and the software will generate the desired output as quickly as possible.

Task1. Search for all companies in Hawaii that sells modem parts, that accepts paypal, and uses FedEX as their mail carrier.

The first task requires a team of virtual characters to do research online. Based on the research, the team will compile a list of possible websites for the user. I actually typed this task out on google in 2010 and there were no websites that were listed that had links to companies in Hawaii. I typed alternative sentences, but the websites listed were useless. I had to manually pick up a phone book, call up tech companies and ask them three questions: 1. do you sell modem parts. 2. do you accept paypal. 3. do you use FedEX as your mail carrier. If anyone of these questions is answered with a no, then I can't purchase the modem from them.

After 2 hours of calling around, I finally found a tech company in Hawaii that had all three criterias.

The AI time machine (the task engine) can do tasks that an individual human being or a group of human beings can do. Doing research online require teams of virtual characters, each having human level artificial intelligence, in order to accomplish. These tasks have to be done in the fastest time possible. For example, I spent 30 minutes using the search engines to find tech companies that sell modem parts. Then I spent an additional 2 hours calling tech companies. That's a total of 2 and a half hours of my time wasted trying to accomplish task1. The AI time machine can accomplish task1 in less than 1 nanosecond. The output should be a list of tech companies in Hawaii that: sell modem parts, accept paypal, and uses FedEx as their mail carrier.

The virtual characters are using search engine technologies (and other technologies) to do information gathering online. They can do searches on search engines, take that information and use it on apps on an iphone, and use that information to write a document on a laptop. This document was created by a team of virtual characters, each having human level intelligence, doing work using various technologies.

Task2. I want you to write an operating system that is better than Windows7 (from scratch) and download it to my computer.

Windows7 took Microsoft 30 years to build and millions of programmers were hired to write the software. The AI time machine can write a better operating system than Windows7 in less than 1 second. The teams of virtual characters have to build the software from scratch. That means they can't use any pre-existing codes in their operating system. They have to design the software, build the software and test the software based on common knowledge of computer science.

These teams of virtual characters will work together in a hierarchical manner or a business to write the operating system in the most efficient and fastest way possible.

Task3. I want you to solve all crimes committed on Earth for the last 200 years and create a website to display the results.

This task is essentially the same as the second task. Teams of virtual characters are working together to accomplish a task. In this case, the task is to identify all crimes and solve all cold cases from the FBI for the last 200 years. In less than 30 seconds, a website will be created, containing all the knowledge of crimes committed on Earth for the last 200 years.

The website will include all crimes committed, even those that were not reported to the cops. Users of the website can search for any crime and the information will be displayed to them in detail. Each case will contain the details of what, where, when and how a crime was committed.

Task4. I want you to disprove or prove all religions on Earth and set up a website to display the results.

I used to have a friend in college and he tried to convert me to his religion. 2 years were spent arguing back and forth, me trying to disprove his religion, and he trying to prove his religion. After 2 years of arguing I was convinced at some point that a god really does exist. I looked around me and found out that there had to be someone that created the people, trees, water, sky and animals. However, my friend didn't convince me that his god was authentic.

All religions started in Earth's past thousands of years ago. In order to disprove or prove a religion, these virtual characters have to predict events that happened thousands of years ago. They need to find out the frame-by-frame events that started a religion. Let's say that a religion is found to be false, the next step for these virtual characters is to find out who the original author of the religion is. This person is responsible for creating the ideas for the religion. Every book of that religion is tracked in the past in terms of who got a copy and who modified the scripts. If the AI time machine does its job correctly, the original author will be tracked down and his entire life will be predicted, including what led that person to start the religion.

Let's say that all religions on Earth are disproven, then the virtual characters have a bigger responsibility, which is to find out how the human race was created. Who was responsible for creating DNA and all living organisms on Earth?

Task5. I want you to bring back the world trade centers, the 4 planes, and the 3,000+ people that died on Sep. 11, 2001. Restore these target objects to the state they were in on Sep. 10, 2001.

The AI time machine can be used to control external atom manipulators to “manipulator” small or large objects in our environment. For example, an atom manipulator can take a bunch of hydrogen atoms and combine them to form helium atoms. Or the opposite can happen, whereby helium atoms are broken up into hydrogen atoms.

The practical time machine is a technology that allows targeted time travel. It allows a user to cut objects from Earth's past or future and paste these objects to the current environment. In this case, I am telling the AI time machine to bring back several targeted objects: the twin towers, the 4 planes, and the 3,000+ people that died on Sep. 11, 2001. These targeted objects should be re-created to the state they were in on Sep. 10, 2001.

This task is very difficult to accomplish because a perfect timeline of Earth must be created first. This timeline tracks every atom, electron and em radiation for Earth's past. Next, atom manipulators are scattered throughout the Earth to manipulate objects so that the targeted objects can be brought back from the past.

Some people might say that this task is impossible. That's what people said before the automobile or the airplane was invented. The evidence that I use to prove my theories is something that everyone is familiar with. Boiling water demonstrates the processes of breaking apart molecules and merging molecules. The energy from the stove causes the water molecules in the pot to break apart into gases (2 hydrogen atoms and 1 oxygen atom per water molecule). When the hydrogen and oxygen atoms rises a certain point in the air, they combine together to form water molecules again. This is exactly the behavior of the atom manipulator. The technology uses energy to break apart molecules, move atoms, and combine atoms together. The only difference is that the atom manipulator is merging and breaking apart atoms in an “intelligent” way.

Let's use another example. The Earth, which is made from many types of atoms, was created from a cloud of hydrogen atoms. Oxygen, helium, gold, silver, iron and so forth was created by a cloud of hydrogen atoms. At the beginning, a cloud of hydrogen atoms existed. These hydrogen atoms started building up energy and eventually created a star. Next, the star got so hot that it exploded, causing a super nova. Finally, the chaotic positioning of atoms and electrons caused the super nova to form galaxies and planets. Within planets, metals like diamond and gold takes thousands of years to form.

If you look at nuclear reactors, man-made atoms are created by controlling the temperature. The atom manipulator uses the same type of method to change from one atom type to another atom type. It is able to control the positioning of the atoms (the cooling process) and the amount of energy that is needed to merge atoms together (raising the temperature). You can take a bunch of rocks and use the atom manipulator to turn these rocks into gold. The only difference between the atom manipulator and the natural way of changing atom types is that the atom manipulator is merging and breaking apart atoms in an “intelligent” way. Gold is created from rocks, but the process takes thousands of years and takes place deep underground. The atom manipulator is simply speeding up the process by intelligently manipulating atoms and electrons.

Task5 basically demonstrates that the AI time machine can bring people back from the dead and it can restore inanimate objects like buildings and bridges to its primal state.

Task6. I want to time travel to Nov. 12, 1941. The target object is the entire Earth.

This task is an extension from the previous task. In the previous task, several target objects is the subject for time travel. This time, all objects on Earth is the target object. I want the AI time machine to travel back to Nov. 12, 1941. This means that all objects on Earth are subject to time travel. When the time travel process is over, all objects on Earth will be exactly the same to the objects on Earth on Nov. 12, 1941.

This means that people born after Nov. 12, 1941 won't exist and the people that lived in Nov. 12, 1941 will be brought back from the grave. The older people in the current timeline that existed in Nov. 12, 1941 will be young again. The entire current environment will be restored to its 1941 state, exactly.

Task7. I want you to control all electronic devices or computers connected to the internet. Write the words “hello world” on each electronic device's screen.

In 2000, a bunch of hackers went to congress to testify about the safety of the internet. They claim that they can shut down the entire internet if they wanted to. Shutting down the “entire” internet is a very difficult task to accomplish. They can possibly shut down sections of the internet, but not the entire internet. The internet was designed so that if certain nodes fail, it can rewire itself to other nearby nodes.

The question I try to ask myself several years ago is: is it possible to control all electronic devices connected to the internet in terms of its software and hardware? These electronic devices include: computers, cellphones, printers, servers, laptops, towers, cameras, machines and so forth. When I say electronic devices I'm talking about all devices that make up the internet.

I came to the conclusion that a software virus won't be able to do this because the computers' hardware can shut down the software virus. Even a very intelligent virus won't be able to cripple the internet.

The only way to control all electronic devices that make up the internet is to build a “physical” virus that can manipulate not only the software, but also the hardware. After brainstorming ideas, I came up with the ghost machines. The ghost machines' physical actions and intelligence is generated by the atom manipulator. These ghost machines can be small like a ghost molecule or large like a ghost human. They can manipulate any hardware or software of a computer. They can block circuit gates, manipulate circuit gates, change data in RAM, block electricity flow or physically control the hardware.

Imagine hundreds of tiny ghost machines inside a computer that work together to control the inner workings of a CPU. The machine codes going into a CPU for processing is initiated by a user controlling a software program, but the ghost machines manipulate what data actually comes out of the CPU. The ghost machines are actually controlling the software and hardware of the computer so that it does exactly what the ghost machines wants it to do. For example, a bunch of ghost machines can go into a monitor and use the mechanics of the hardware to superimpose text on the monitor. This text will read: “hello world”. If all electronic devices connected to the internet are controlled by teams of ghost machines, then all electronic devices' monitors will have the text: hello world, superimpose on their monitor. The text isn't generated by any software virus, but is generated by ghost machines that physically control the hardware to display the text.

Shutting down the entire internet is quite simple. All the ghost machines have to do is damage vital gates in a CPU or cut certain wires. A human ghost can even take hot water and pour it on a computer to shut it down. Users won't be able to turn on their computers ever again. The ghost machines have to do this simultaneously for all electronic devices connected to the internet.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a diagram depicting the data structure of the universal prediction algorithm.

FIG. 2 is a diagram depicting a structure of multiple teams of virtual characters that work together to do work in branches of the prediction tree.

FIG. 3 is a diagram depicting the chain of work needed to predict how the QB throws the ball to different players.

FIG. 4 is a diagram depicting one pathway from the AI time machine.

FIG. 5 is a diagram illustrating a dynamic robot.

FIGS. 6 and 7 are diagrams depicting the self-organizing of prediction pathways.

FIG. 8 is a diagram showing the differences between predicted models for a basketball player and a football player.

FIGS. 9-12 are diagrams illustrating predicted models and their properties.

FIGS. 13-14 are diagrams depicting the merging of independent predicted models.

FIGS. 15-18 are diagrams depicting the two modes, training mode and standard mode, of the AI time machine.

FIG. 19 is a diagram depicting two types of teams that are working on the prediction internet simultaneously.

FIGS. 20-23 are diagrams illustrating how the virtual characters predict events on Earth for the past, current and future.

FIGS. 24-31 are diagrams depicting sequence predictions for the future in terms of the game of football.

FIGS. 32-33 are diagrams illustrating how the virtual characters predict future events for the stock market.

FIGS. 34A-34C are diagrams depicting sequence inputs and desired outputs for the AI time machine.

FIGS. 35-40 are diagrams depicting how the AI for a universal machine works.

FIGS. 41-42 are diagrams illustrating how the AI for a complex machine works.

FIG. 43 is a diagram showing how the universal prediction algorithm is used to predict past events.

FIGS. 44, and 45A-45C are diagrams depicting the AI system for the signalless technology.

FIG. 46 is a diagram depicting the focused objects in a predicted model for the stock market.

### DESCRIPTION OF THE PREFERRED EMBODIMENTS

The present invention is a technology that encapsulates many individual inventions. The inventor has written 23 books and filed 21 patent applications on numerous inventions (early 2006-November 2010). The total information from these documents make up the present invention. The first book written on the AI time machine was registered with the copyright office in early 2008, called: AI time machine: book12. The 2008 book was never published, but it was mentioned in the practical time machine patent application. The bulk of the description for the present invention is based on the inventor's 2008 book.

Topics:

1. Overview of the AI time machine
2. Dynamic robots use a universal prediction algorithm to predict the future
3. Sequential inputs/desired outputs for the AI time machine
4. Universal machines

### Overview of the AI Time Machine

A method for an AI time machine to accept sequential input tasks from at least one user, manage tasks, and execute tasks simultaneously or sequentially, capabilities of the AI time machine can be at least one of the following: searching for information over the internet, doing tasks for the user that require teams of virtual characters, doing research, writing a book, solving cases for the FBI, tracking people and places, predicting the future or past, solving problems, doing college assignments, writing complex software programs, controlling dummy robots in a factory, controlling atom manipulators, controlling hierarchical external machines, manipulating objects in our environment, building cities, bringing dead people back to life, curing diseases, and time travel, the AI time machine comprising:

1. at least one dynamic robot is required to train the AI time machine, and tasks are trained from simple to complex through a process of encapsulation using the AI time machine, the training comprising at least one of the following: training individual tasks, training sequential tasks, training simultaneous tasks, and managing multiple tasks based on a hierarchical team of virtual characters, whereby a captain manages, processes, gives orders to lower level workers, and executes tasks;
2. a main program with two modes, comprising: training mode and standard mode;
3. external technologies, comprising: universal artificial intelligence programs, human robots with human level intelligence, psychic robots, super intelligent robots, the AI time machine, dynamic robots or virtual characters, a signalless technology, atom manipulators, ghost machines, a universal CPU, an autonomous prediction internet, and a 4-d computer;
4. a videogame environment for virtual characters to do and store work;
5. a prediction internet;
6. a universal brain to store dynamic robot pathways or virtual character pathways, the universal brain comprising: a real world brain, a virtual world brain, and a time machine world brain;
7. a timeline of Earth that records predicted knowledge of Earth's past, current and future;
8. a future United States government system; and
9. a long-term memory.

The AI time machine has two modes: training mode and standard mode. The training mode allows dynamic robots to train the AI time machine, comprising:

1. at least one dynamic robot, copies itself into a virtual world as a robot, sets the videogame environment of the AI time machine based on at least one task, copies itself into an AI time machine world as at least one virtual character using investigative tools and a signalless technology to do work, and the robot, operating in the virtual world, assigns fixed interface functions from the AI time machine and linear inputs, while the virtual characters, operating in the AI time machine world, do work to submit desired outputs to the robot,
2. a software program that observes and analyzes the universal brain to automatically assign fixed interface functions from the AI time machine to repetitive work done by at least one virtual character;
the standard mode allows at least one user to submit sequential tasks through fixed interface functions and the AI time machine will output simultaneous or linear desired outputs, said standard mode comprising at least one of the following:
1. The AI time machine extracts virtual character pathways from the universal brain and tricks the virtual character pathways in a virtual world to do automated work;
2. real virtual characters, structured hierarchically, using investigative tools and the signalless technology to do manual work;
the fixed interface functions for the AI time machine are at least one of the following: software interface functions, voice commands, a camera system to detect objects, events, and actions, and manual hardware controls.

The investigative tools used by the virtual characters, comprises: the AI time machine, a prediction internet, all knowledge from the timeline of Earth, all knowledge from the timeline of the internet, research knowledge, knowledge data, software programs, search engines, electronic devices, computers, networks, network software, encapsulated work done by virtual characters, a simulation brain, and a universal brain.

In training mode for the AI time machine, the virtual characters are structured hierarchically and a team of virtual characters does at least one of the following:

1. a captain analyzes at least one user and user's inputs and understands the user's goals, intentions and powers based on human intelligence, manages tasks for the user, accomplish tasks, give tasks to lower level workers, and submit desired outputs to the user;
2. each virtual character understand their roles, rules, powers, status, limitations and procedures based on common knowledge learned in college, books or legal documents;
3. each virtual character does work using investigative tools and a signalless technology;
4. the captain understands the user's roles, rules, powers, status, limitations and procedures based on common knowledge learned in college, books or legal documents;
5. the virtual characters can use investigative tools to predict the future and act based on the best future possibility.

### The Signalless Technology

The current environment of Earth's timeline is generated by a signalless technology, the signalless technology generates a map on the current environment in the quickest time possible and records all objects in the current environment in a hierarchical clarity tree, comprising:

1. at least one sensing device, the sensing device comprising: a camera, a 360 degree camera, GPS, electronic devices, human robots, machines, a sonar device, an EM radiation device; and
2. an AI system that uses the AI time machine to encapsulated work to process input data from the sensing device.

The AI system for the signalless technology, comprises: teams of virtual characters using investigative tools and automated software to do at least one of the following:

1. analyzing and extracting hierarchical data from sensing devises,
2. generating a 3-d map hierarchically of all visual data from all sensing devises,
3. using human intelligence to analyze, process, and identify objects, events and actions in sensing devices, identify where each sensing device is located on Earth and the time of recordings,
4. using human intelligence to assume, from investigated data, the locations and actions of objects not sensed by the sensing devices,
5. using simulated models to represent objects identified or assumed in the 3-d map, the simulated models reveal at least one of the following: inner objects and hidden objects,
6. using human intelligence to analyze, process and identify em radiations, atoms, molecules, and intelligent signals from the sensing devices to assume where microscopic objects are located in the 3-d map;
7. using human intelligence and software to determine how each em radiation or atom traveled to hit the sensing devices, the em radiations travel based on refraction or reflection and atoms travel based on bounces; and
8. submitting the 3-d map to the prediction internet in a streaming speedy manner to be used by other virtual characters to predict at least one of the following: future events and past events.

Universal Prediction Algorithm

Objects, events and actions in the timeline of Earth's past and future are generated by virtual characters using a universal prediction algorithm method. The universal prediction algorithm comprises: at least one prediction tree; the prediction internet; a common knowledge container, the signalless technology, and the AI time machine.

A prediction tree comprises hierarchically structured predicted models, each predicted model comprises: focused objects, peripheral objects, at least one software program, prediction outputs, and assigned teams of specialized virtual characters.

The prediction internet is a website that virtual characters can go to to insert, delete, modify and merge prediction data. The prediction internet further contains streaming data from the signalless technology and software programs to organize, distribute, and search for specific data.

The AI time machine encapsulates work done by virtual characters using the universal prediction algorithm method. The work done by virtual characters are ever detailed data of predictions as time passes. The work done by said virtual characters, comprising:

1. using investigative tools to extract at least one prediction tree from the prediction internet for each prediction;
2. hierarchically and uniformly assign teams of virtual characters to do work in predicted models for each prediction tree;
3. each virtual character has human level intelligence and uses investigative tools and the signalless technology to do their predictions in the prediction internet;
4. each virtual character in a team knows their roles, powers, rules to follow, limitations, prediction tasks, procedures and goals based on the common knowledge container;
5. teams of virtual characters will insert, delete, modify and merge prediction trees to combine predictions in terms of at least one of the following: lengthening predictions and merging predictions.

The teams of virtual characters are concerned with at least one of the following while doing a prediction:

1. a team's prediction is based on their predicted model's focused objects and peripheral objects;
2. external data should be extracted from spaced out neighbor predicted models for processing, designing their software programs, and outputting prediction data;
3. follow goals, rules and procedures set forth in the common knowledge container to do predictions.

The prediction internet insert, delete, modify and merge predicted models or prediction trees based on at least one of the following factors: automated software programs, investigative tools, and virtual characters manually inserting, deleting, modifying and merging predicted models.

Autonomous Prediction Internet

The autonomous prediction internet predicts objects, events and actions in the timeline of Earth's past, current and future; and generates knowledge data on Earth, comprising at least one of the following:

1. The AI time machine extracts virtual character pathways from the universal brain and tricks the virtual character pathways in a virtual world, using minimal computer processing by running vital objects, to do automated work;
2. real virtual characters, structured hierarchically, using investigative tools, the signalless technology, and using the universal prediction algorithm method to do manual work;

Universal Machines

The AI time machine serves as a central brain for at least one of the following universal machines: a machine, a hierarchical team of machines, a complex machine requiring thousands of individual workers, and a transforming machine, the universal machine, comprises a hierarchical team of virtual characters controlling a host machine to do at least one of the following:

1. a captain analyzes at least one user and user's inputs and understand the user's goals, intentions and powers based on human intelligence, manages tasks for the user, accomplish tasks, give tasks to lower level workers, and submit desired outputs to the user;
2. each virtual character understand their roles, rules, powers, status, limitations and procedures based on common knowledge learned in college, books or legal documents;
3. each virtual character does work using investigative tools and the signalless technology;
4. the captain understands the user's roles, rules, powers, status, limitations and procedures based on common knowledge learned in college, books or legal documents;
5. virtual characters can use investigative tools to predict the future for the team of virtual characters and the current environment; and act based on the best future possibility.

The universal machine is fully automated and allows at least one user to submit sequential tasks through fixed interface functions and the universal machine will output simultaneous or linear desired outputs, the AI of the universal machine, comprising at least one of the following:

1. the AI time machine extracts virtual character pathways from the universal brain and tricks the virtual character pathways in a virtual world, using minimal computer processing to run vital objects, to do automated work;
2. real virtual characters, structured hierarchically, using investigative tools and the signalless technology to do manual work;

The transforming machine have at least one fixed captain as the machine transforms; and have different specialized virtual characters as the machine transforms; The atom manipulator

The atom manipulator manipulates objects in the current environment, generate hierarchically structured ghost machines, and providing the ghost machines' intelligence, physical actions, and communications, to create at least one of the following technologies: a technology to build cars, planes and rockets that travel at the speed of light, build intelligent weapons, create physical objects from thin air, teleport objects, allow targeted time travel, use a chamber to manipulate objects, build force fields, make objects invisible, build super powerful lasers, build anti-gravity machines, create strong metals and alloys, create the smallest computer chips, store energy without any solar panels or wind turbines, make physical DNA, manipulate existing DNA, make single cell organisms, control the software and hardware of computers, servers and electronic devices without an internet connection, and manipulate any object in the world.

The ghost machines are hardwareless machines, each ghost machine comprises: electronic components and mechanical actions. The electronic components comprising at least one of the following: a universal CPU or hardwareless computer system, a semi hardwareless computer system, and a simulation inside the atom manipulator; and the mechanical actions are generated by the atom manipulator.

The universal CPU mimics the electronic activities of a real computer system, the universal CPU comprising: a laser system, ghost input gates, ghost communication input gates, ghost output gates, ghost circuit gates, ghost RAM, ROM, and cache registers, a microscopic objects reserve area, and a database.

The universal CPU uses microscopic object interactions to generate Boolean algebra, the universal CPU comprising the steps of:

1. extracting pathways from the database to control laser system;
2. processing machine instructions from a ghost computer system;
3. generating ghost circuit gates;
4. processing the microscopic object interactions;
5. combining processors and transmitting at least one of linear outputs and parallel outputs to the ghost computer system.

4-Dimensional Computers

A 4-d computer is a hardware computer system that runs our universe, the steps to create a robot in the 4-d world and to control the 4-d computer, comprises:

1. understanding every aspect of our universe; finding the patterns between our universe and the physical activities in the 4-d computer;
2. creating a plurality of artificial devices, the artificial device comprises: an artificial sonar device, an artificial sensing device, and an artificial atom manipulator;
3. create a robot in the 4-d world using the artificial devices; and
4. repeating these steps for higher level dimensional worlds.

Future United States Government System

Finally, the last component of the AI time machine is the future United States government system. The virtual characters (or dynamic robots) have to follow laws in order to operate the AI time machine. The tasks that can or can't be granted by the AI time machine is based on who the user is, what powers does the user have, what are the laws that have to be followed and so forth. The laws of the constitution is an adequate document that dictates what is right and wrong in a civilization. If a regular person uses the AI time machine, the virtual characters will limit the tasks that can be granted. If the person is the president of the United States, obviously the AI time machine will grant a wider range of tasks.

Regular laws must be uphold, such as: its forbidden to harm another human being. If a user gives an order to the AI time machine to break someone's arm, the AI time machine will not accomplish the task because one of the laws of the constitution states it's not ok. Nor can someone give an order to create and detonate a bomb in a crowded market place.

Thus, the future United States government system is an integral part of the AI time machine because it determines what tasks the AI time machine can and can't grant.

By the way, the future United States government system is actually a system for human robots. Each dynamic robot is granted citizenship of the United States, embued with all the rights that human citizens have. In return, they have to fulfill certain responsibilities and duties. One of these responsibilities is to follow the constitution.

Other “integral” components of the AI time machine are the external technologies. These external technologies are needed in order for the AI time machine to accomplish complex tasks.

Also, the training can only be done by dynamic robots (robots with a built in virtual world). Human beings or expert software can't train the AI time machine. The reason why is because the pathways for the AI time machine stores the 5 senses and thoughts of the dynamic robots. The dynamic robots can also work in three worlds: the real world, the virtual world and the time machine world.

Introduction to the Universal Prediction Algorithm

In prior art, investigators have to use a specific fixed algorithm to predict a specific situation. There are algorithms written to predict what kind of job a kid will grow up to have, there are algorithms to predict how a herd of cows will migrate, there are algorithms to predict the behavior of gangs, there are algorithms to predict what banks will be robbed in the future and so forth. If anyone watches CSI or NUMBERS, the investigators use fixed algorithms all the time to predict future events. The universal prediction algorithm is one united software program that can predict any future or past event based on the preferences from a user. The user simply has to type in what event/object/action he/she wants to predict and the software program will output the prediction. For example, if the user wanted to know the outcome of a football game, the software program has to output the final score of the football game. In fact, the software has to go into the details and describe every single linear gameplay of the football game.

Although the universal prediction algorithm was designed to predict the future, it can also be used to predict the past. For simplicity purposes, the majority of this patent application will be devoted to predicting the future. I will be using football as an example to demonstrate how the universal prediction algorithm predicts the future.

The universal prediction algorithm is different from other current prediction algorithms because its goal is to predict the “exact” future and not a probability of the future. Let's take football as an example. If you look at every single gameplay, all the players are positioned exactly the same way (the receivers, linebacker and quarterback are all positioned in the same areas). However, as the game is played, all players move differently. The QB can throw the ball to the receiver or pass it to the runningback or run the ball himself. The judgments of action are based on the brains of each player.

Also, the actions of one player affect the actions of another player in the game. Thus, in order to predict one players' future actions, all other dependable players' future actions must also be predicted. For example if a defensive player sees an offensive receiver wide opened, he will run towards his direction. On the other hand, the offensive receiver will try to run away from the defensive player. The defensive player relies on the actions of the offensive receiver and vice versa.

The universal prediction algorithm is interested in predicting the exact future of what will happen in a football gameplay. It wants to know what all players in the game will be doing (including the fans, coaches and referees). Every single atom must be predicted in the future in order to predict how a football game will end. A blade of grass is important because it might cause the QB to trip and fall to the ground. A hydrogen atom might hit an oxygen atom and cause a chain reaction, producing a gust of wind that changes the direction of the football. Because the gust of wind affected the football, the receiver was unable to catch the ball. Small objects like atoms, grass, wind and dust particles affect larger objects like human beings.

This problem is one of the reasons why it is soo difficult to predict the future. Future events are interconnected like a spiderweb. A future movement of one blade of grass in the field must be predicted, as well as, the future actions of the QB. If you think about all the permutations and combinations of “all” objects involved in a football game, small or large objects, the amount will run exponentially.

It is the purpose of the universal prediction algorithm to solve this problem. Also, there is no doubt that a lot of work is needed to predict the future. The universal prediction algorithm has to predict the future in the most efficient and fastest time possible. If the user wants to know the outcome of a football game, the software program should output a result in 10 seconds. A football game last about 3-4 hours, so the software should do its job quickly. The future statistics from the universal prediction algorithm should be exact, or at least, similar to the results of the football game. For example, the linear gameplays are the same and the final score is the same.

If the universal prediction algorithm falls short of being accurate, it might still be able to predict a similar outcome. For example, the software program's predicted final score comes very close to the football game's final score and there was a player that was injured in the 4^{th} quarter of the game.

It's not just the players that have to be predicted, the fans on the stand, the coaches, the referees, and the medical experts have to be predicted as well, in order to get an accurate prediction of the future. The QB might be on the field and a fan takes a picture, which causes the QB to be blinded momentarily. This event then causes him to miscalculate where the receiver is located and accidentally throws the ball to a defensive player.

My approach to predicting the future is to isolate and group independent predictions together and structure these independent predictions in a hierarchical manner. Human intelligence will be used to do the predictions, whereby important events are predicted first before minor events.

This patent application will continue on what I have been talking about from my previous 23 books and 21 patent applications. The reader should have a basic knowledge of my encapsulated inventions before reading further.

In order to predict the future quickly, robots working inside a computer are needed to do predictions. These robots are called virtual characters and they can work in any hierarchical team or organization to accomplish prediction tasks. In other words, human beings and robots in the real world can't be used to do predictions. The reason for this is because time in a computer is void and 20 years in a computer can be 1 second in the real world. The virtual characters inside a virtual world (the computer) can do work for 20 years, each having human level artificial intelligence. This method saves time. Some future prediction requires zillions of years in order to accomplish. Those zillions of years can be equivalent to several minutes in the real world. The computer basically fast forward events in the virtual world to save time (like a DVD player).

The Overall Data Structure of the Universal Prediction Algorithm

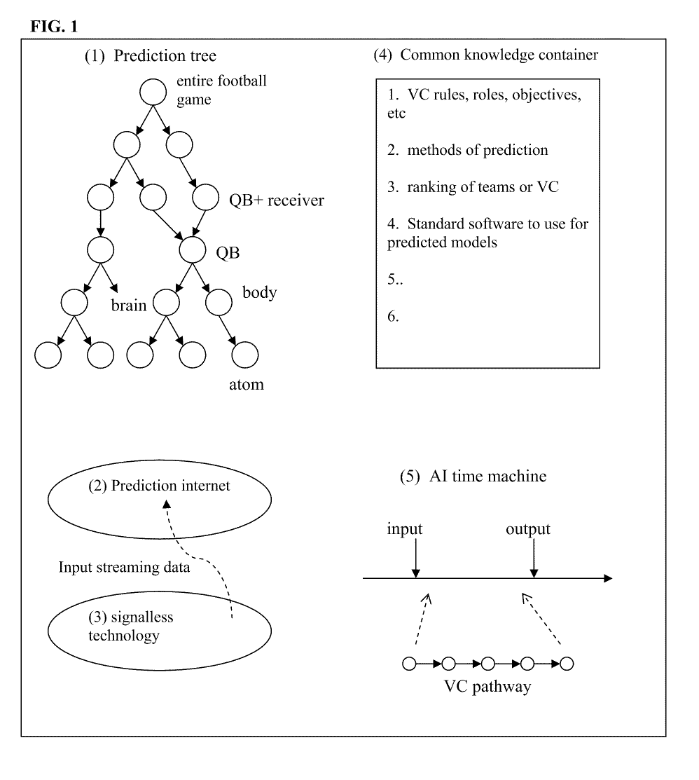

FIG. 1 is a diagram depicting the data structure of the universal prediction algorithm. There are primarily 4 parts to the UPA and they are: 1. prediction tree. 2. prediction internet. 3. signalless technology. 4. common knowledge container. There is a fifth part which is the AI time machine. I will describe the role of the fifth part when the other 4 parts are explained.

(1) Prediction Tree

The prediction tree is one hierarchical tree containing non-exclusive predicted models. Each node in the prediction tree is called a predicted model. Each predicted model has upper and lower predicted models. Actually, the prediction tree can look like a combination of hierarchical trees and graphs with some of the predicted models having no parent or child nodes.

The purpose of the prediction tree is to break up objects in a prediction into the strongest groupings, hierarchically. For example the diagram in FIG. 1 shows the strongest hierarchical groups for the game of football. The user wants to predict what will happen in the future in terms of a football game. The universal prediction algorithm (UPA) will generate an initial hierarchical tree that will outline the important groups in the football game. Obviously human beings are important objects and needs to be predicted first. The quarterback and the receiver are important objects so they are grouped together. The quarterback and the runningback and the closest player are important objects so they are grouped together.

For the quarterback object, there are two important inner objects, which are: 1. the QB's brain. 2. the QB's physical body. Both objects are needed in order to understand how the QB will take action in the future. The brain will select an optimal pathway in memory and the body will follow the instructions from the optimal pathway to move.

The predicted models are non-exclusive, which means that objects used in one predicted model can overlap other predicted models. For example, the QB object was used multiple times in the prediction tree. Each predicted model has to also attach itself to higher or lower predicted models. Or it can gravitate towards a similar predicted model.

(2) Prediction Internet

The prediction internet is a website that virtual characters go to to submit information about their predictions. Teams of virtual characters are either assigned to a predicted model or they choose to work on a predicted model. Each team should be specialized in certain areas in order to work on a predicted model. Sometimes, a hierarchical team or a business will work on branches of predicted models. The hierarchical team will assign different groups of virtual characters to specific predicted models in the branch tree.

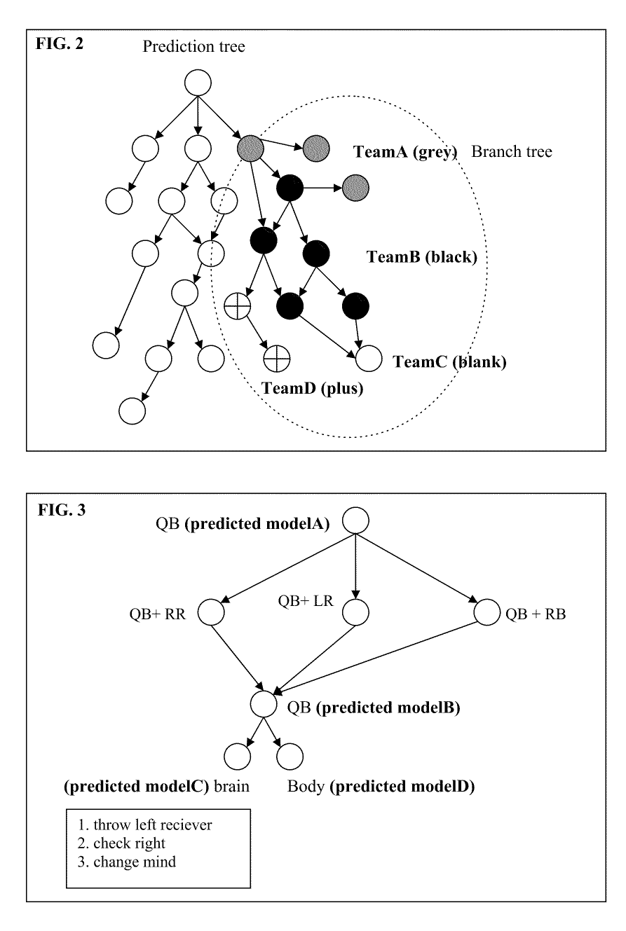

In other cases, teams of virtual characters can team up with or have partnerships with other teams of virtual characters. FIG. 2 depicts a structure of multiple teams of virtual characters that work together to do work in branches of the prediction tree. TeamB is working on a branch of predicted models. TeamB is also in partnership with TeamA, TeamC and TeamD. They are all working together, inputting, deleting and modifying information into the prediction internet based on their predicted models (located in the dotted circle).

FIG. 3 is a diagram depicting the data structure of one predicted model. Parts of each predicted model includes primarily: focus objects, peripheral objects, software programs, and prediction outputs. The focus objects are objects that this predicted model is concerned with. In this diagram, the focus objects are the quarterback and the receiver. These are the two objects that the teams of virtual characters have to predict. The peripheral objects are the runningback, player closest to QB, coaches and fans. These are objects that have secondary importance. The virtual characters will concentrate on the focused objects and be aware of the peripheral objects when they have to do their predictions.

The virtual characters have to compare prediction information from its neighbor predicted models (parent and child nodes) and to use that information to come up with their own predictions.

The output of one given predicted model consists of limited predictions of what might happen in the future based on the focused objects. For example, if the focused objects for a predicted model are the QB's brain and right arm, the prediction output might be three possible arm movements in terms of how the QB will throw the ball. These three predictions are ranked in terms of how certain the virtual characters believe the QB's arm will move in the future.

The job of one predicted model is to limit the amount of future possibilities and information for parent predicted models to work with. FIG. 3 is a diagram depicting the chain of work needed to predict how the QB throws the ball to different players. In predicted modelB, the QB is examined and the conclusion is several pathways the QB will select to take action. Predicted modelB have two focused objects: QB's brain and physical action. In predicted modelC, virtual characters have determined what the QB's goals are and what he plans to do. The possibility rankings show predicted modelB that the QB will most like throw the ball to the left receiver. The second ranking shows he might check to the right to see if the right receiver is open. The third ranking shows he might change his mind and give the ball to any close by player.

Predicted modelD reveals what the QB's physical body will be like if a given intelligent pathway from the QB's brain was selected. If the QB was throwing the ball to the left receiver, this is what the future event will look like. If the QB was throwing the ball to the right receiver, this is what the future event will look like. The output of predicted modelD might be a simulated software that takes in input from a user and the simulation is about how the QB's physical body will move. For example, the input might be an intelligent pathway from the QB's brain and the output might be a simulation of how the QB will move because of the pathway.

The work from predicted modelD is to build a simulated software that will act as the physical shell of the QB. Regardless of what intelligent pathway is selected by predicted modelC, the simulated software should be able to show what the QB's physical body should look like in the future.

The job of predicted modelB is to take the limited possibilities and knowledge from predicted modelC and predicted modelD to merge the two information and to come up with its own limited possibilities and knowledge for parent nodes. For example, predicted modelB might determine that the QB will select a pathway from memory to throw the ball to the right receiver (from predicted modelC). The team will also use the best simulated software of the QB's physical body (from predicted modelD). They will process the separate data and they will output possible animations of the QB throwing the ball to the right receiver.

The information from predicted modelB will be analyzed by predicted modelA. Predicted modelA must manage three focused objects, which are:

1. QB+Left Receiver

2. QB+Right Receiver

3. QB+Runningback.

They will look at the three possibilities and analyze all three data in a group to determine the most likely actions the QB will take in the future. For example, the virtual characters might analyze what all three data have in common in terms of what the universal goals of the QB are. All three predicted models might have the QB favoring throwing the ball to the left receiver than the right receiver or the runningback.

The job of the virtual characters working on predicted modelA is to organize the data from the lower levels, to process them and do further predictions.

The virtual characters can use any investigative tool that is necessary to process information. They can use software programs, hardware devices, computers, networks, the internet, the AI time machine, science books, science methods, pre-existing algorithms, investigation strategies and so forth. Each virtual character is smart at a human level and they are using knowledge and technology to do their predictions.

Like CSI, they can take pre-existing prediction algorithms proposed by respected scientists and use them to predict the future.

Each predicted model has to do predictions within their focused objects. They can't deviate from their focused objects. If every virtual character does their job properly, the root node (which is the entire football game) will have an optimal future prediction in terms of the collective whole of all hierarchically structured predicted models.

This method is used to manage complexity and to combine processed information in a meaningful manner.

(3) Signalless Technology

The signalless technology is a network of cameras, human robots, and sensing devices that collect information from the environment in the fastest way possible. All atoms from the football game have to be identified as quickly as possible. The signalless technology will be able to map out every atom in the football field using artificial intelligence and input this information into the prediction internet to be processed.

To summarize the signalless technology, cameras and sensing devices are scattered throughout the football stadium and the AI time machine will process the streaming data to map out every atom in the football game. No sonar devices or x-rays are ever used. Only a sophisticated form of artificial intelligence is needed to track every atom, electron and em radiation from the football game.

The signalless technology will input data into the prediction internet so that all virtual characters participating in predicting the football game has access to the information as soon as they are processed. For example, every atom of the QB has to be mapped out so that predicted modelD (the example above) can use the information to build simulated software concerning the QB's physical body.

(4) Common Knowledge Container

Each virtual character working in the prediction internet has human level artificial intelligence. Their roles, boundaries, rules, power and status are all determined by common knowledge found in books and documents. The team of virtual characters is like a business, and each employee understand their roles and status through business school. The business will have their own laws that further define how employees should act and behave.

Below is a list of things that should be part of the common knowledge container:

1. Status, rules, power and objectives of each virtual character
2. Prediction methods and strategies for each virtual character
3. Each team submits which predicted model they are working on and their parent and child teams.
4. Ranking of teams, their team partners or hierarchical sub-teams
5. Recommended software to use for each predicted model
6. The information that should be outputted by each predicted model
7. The initial hierarchical tree for a given prediction.

1. Each virtual character must follow rules set forth in books and documents in terms of objectives, rules and power. For example, a captain of a team has different objectives and rules compared to a worker. Each virtual character has to know their part through common knowledge.

Also, each team has to be registered and have a license to predict by a government. This prevents people who are not skilled from doing predictions.

This knowledge provides a national law that each team of virtual characters has to follow to do predictions. In addition to this, each team also has their own written laws to follow.

2. Each virtual character must have gone through college to learn the latest techniques to predict the future. If a predicted model is about ocean currents, there are specific scientific methods to use in order to come up with predictions. College courses will give each virtual character the knowledge to do their predictions.

3. Each team of virtual characters have to register with the prediction internet and specify what predicted model they are working on and disclose any partners or hierarchical teams that they are working with.

Teams of virtual characters act like competing companies. They compete with each other to output more accurate predictions. In the common knowledge container, each team will be ranked in terms of how affective they are in their work. The better their prediction, the higher up they are ranked. Some teams are assigned to predicted models, while other teams choose to do work in predicted models. It is also possible to assign multiple independent teams to work on the same predicted model.

4. The prediction internet will have a website that ranks each team/virtual character. People can submit their reviews on how affective certain teams are. This ranking system facilitates competition.

5. There are many predictions made on events, objects and actions in the prediction internet. Virtual characters have written in books and documents what are the most effective software and procedures used for a particular predicted model. This information gives teams the recommended software and procedures to use in order to do their predictions.

Also, new software and standardized software are listed so that people can use the latest technology to do their predictions.

All recommended investigative tools are listed for teams to do work on a given predicted model. This includes: software programs, hardware devices, computers, networks, the internet, strategies, methods, information compilation and so forth.

6. The most important responsibility for a predicted model is to output the right information. The common knowledge container has a list of information that should be outputted for a given predicted model.

Outputs for predicted models come in different media types. One output might be generating animation possibilities, while another output might be a short report on possibilities. Since there are so many media types to output, the common knowledge container has a list of what each predicted model should output.

7. One of the jobs of the prediction internet is to take an event, object or action and provide an initial prediction tree. For example, if someone wanted to predict the future event of a football game, an automated software will analyze predictions in the prediction internet and provide an initial prediction tree. As work is done on the prediction tree, the branches of nodes will change (nodes will be added, deleted or modified). When adequate work has been done on the prediction tree, the nodes will be organized in an optimal manner.

The main purpose of the common knowledge container is to provide information to virtual characters and to coordinate the virtual characters so they can predict future events. As teams of virtual characters have more experience in doing predictions, they can tell other people what techniques are good and bad and what software are good and bad. By posting these data, other virtual characters will be informed about what techniques to use to predict the future.

(5) The final part of the universal prediction algorithm (UPA) includes using the AI time machine. This last part links all the other parts together into one cohesive software program.

The AI time machine (aka time machine) is a software program that assigns virtual character work to fixed software functions. There are two modes to the AI time machine: standard mode and training mode. In standard mode, users can use the AI time machine to do tasks; and in training mode, a dynamic robot has to physically do tasks and assign this task to fixed software functions in the AI time machine.

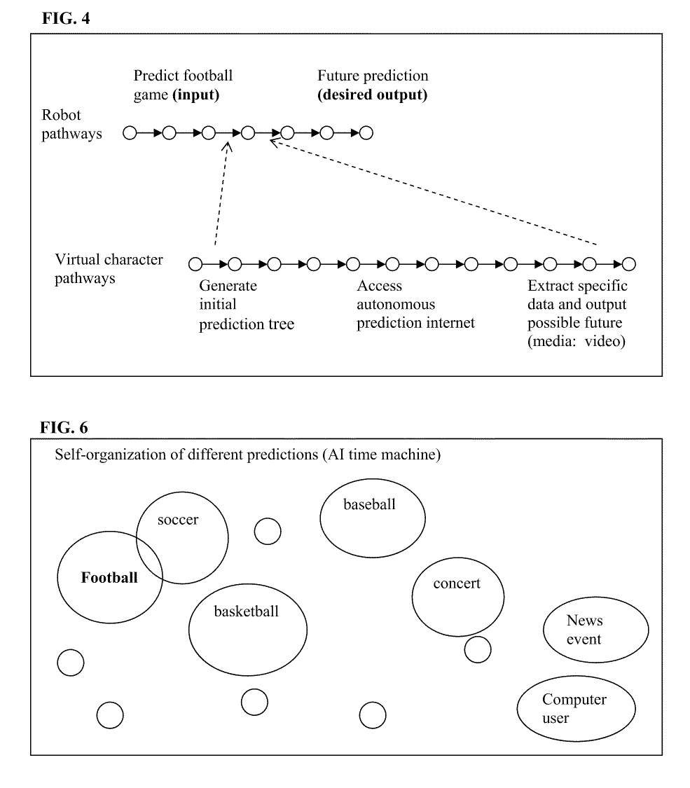

FIG. 4 is a diagram depicting one pathway from the AI time machine. The input is the data the user inserts into the program. The desired output is the information that is transmitted to the user (usually through the monitor). Teams of virtual character pathways, called a station pathway, are assigned between the input and the desired output.

When someone wants to use the AI time machine to predict the future (using standard mode), they can simply fill a form and the AI will automatically execute virtual character pathways and display the desire output for the user. In this case, the user wants to predict future events of a football game. The user will input information about the football game, such as team backgrounds, game cameras, team statistics and stadium configuration. The AI of the AI time machine will provide a desired output in the fastest time possible.

The user can also specify what the desired output can be. He might want to know the final score or the linear gameplay of the football game through a short video.

A dynamic robot is needed in order to train the AI time machine to do predictions (at this point, the AI time machine is in training mode). An adequate amount of training is needed in order for the AI time machine to predict the future.

The purpose of the AI time machine is to encapsulate work. The robots are doing work, storing that work into the AI time machine and reusing that work in the future by accessing the AI time machine.

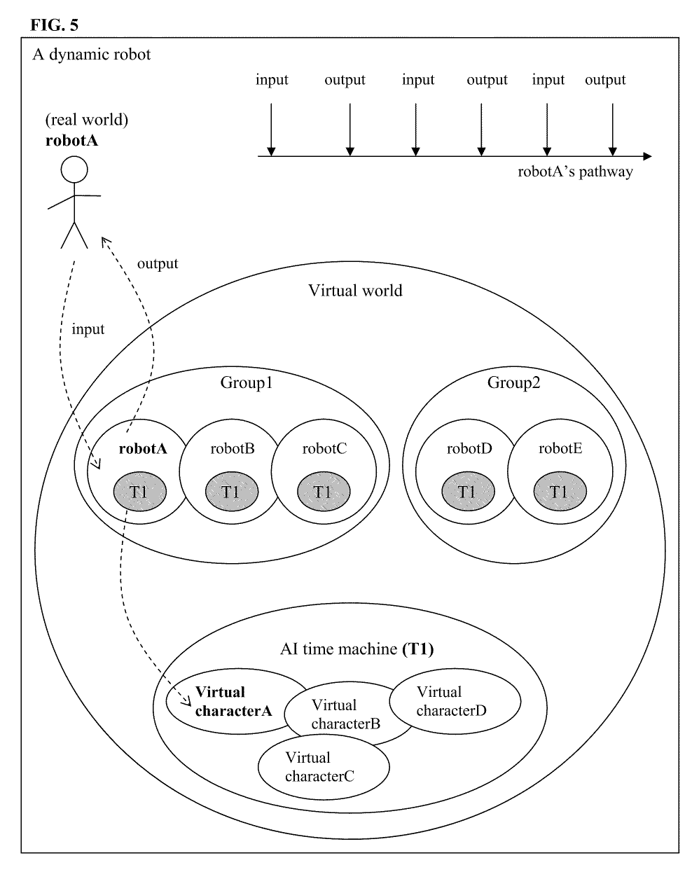

Patent application Ser. No. 12/110,313 describes the technology in detail. Here is a summary of the technology: A robot has a built in virtual world which serves as a 6^{th} sense (FIG. 5). The robot can choose to enter the virtual world whenever and wherever it chooses. Usually, the robot defines a problem to solve and understand the facts related to the problem. Then it will transport itself into the virtual world as a digital copy of itself (similar to the matrix movie). The digital copy will be called “the robot” and the intelligence of the robot will be referencing pathways in the robot in the real world. In the virtual world is an AI time machine, which consists of a videogame environment that emulates the real world. All objects, physics laws, chemical reactions and computer software/hardware are emulated perfectly inside the AI time machine. The job of the robot is to manipulate the AI time machine to search and extract specific information from virtual characters.

The robot will set the environment of the AI time machine depending on the problem it wants to solve. For example, if the robot wanted to do a math homework, it has to create an appropriate setting to solve math equations. In the AI time machine the robot has to create a comfortable room void of any noise, the math book the homework is located, several reference math books, a notebook, a pencil, a computer, a chair and a calculator. Once the setting of the environment is created, the robot will copy itself again into the AI time machine, designated as “the virtual character”. The virtual character is another digital copy of the robot and the intelligence is referencing the same pathways in the brain of the robot located in the real world. Once the virtual character is comfortable in the AI time machine environment it can start doing “work”. In this case, it consciously chooses to do a math homework. It will spend 2 weeks doing the math homework. After it is finished, the virtual character will send a signal to the robot in the virtual world that it has accomplished the task. The robot will then take the math homework and store that information as a digital file in his home computer. Then the robot will exit the virtual world and transport itself into the real world where it will apply the information it has extracted from the AI time machine.

At this point, some people might ask: why is the AI time machine encased in the virtual world? Why not simply have one virtual world? The reason is that the robot has to set the environment of the AI time machine so that the virtual characters can do their job. Another reason is that the virtual characters have to have goals that they want to accomplish the moment they are in the AI time machine. The robot is also responsible for searching and extracting information from the virtual characters.

The robot in the virtual world can actually make as many copies of itself as needed to solve a problem. It can create a team of itself to solve a problem, each copy referencing the pathways in the brain of the robot located in the real world. The problem that the team of virtual characters want to solve might be large, for example, they might want to cure cancer. They will work together to get things done by dividing the work load and structuring the virtual characters into a hierarchical manner. The team will be like a company, whereby each member of the company will have their own jobs to do and they will all work together to achieve the goals of the company. These virtual characters are no exception because they will work together in a team like setting, dividing tasks among each other and accomplishing goals.

Since it can create hundreds of copies of itself, it has to maintain the activities of the virtual characters. Some virtual characters might have better solutions than other virtual characters or some virtual characters might be doing the wrong things. It's up to the robot to coordinate their activities. Another method is to create coordinators and put them into the AI time machine to manage all the virtual characters.

All virtual characters are simply referencing the pathways from the robot's brain in the real world. They aren't clones of the real robot, thus their work is considered the work of one entity: the robot in the real world. The digital image of the virtual character is only a shell and doesn't have a digital brain. Therefore, it isn't alive.

In addition to the many copies of the robot (robotA) in the AI time machine, there are pre-existing virtual characters from other robots also co-exiting in the same AI time machine dimension. They can also help in accomplishing tasks.

A Closer Look at the AI Time Machine's Two Modes

The AI time machine has two modes: training mode and standard mode. In training mode, dynamic robots are needed to train the AI time machine. The steps include: at least one dynamic robot, copies itself into a virtual world as a robot, sets the videogame environment of the AI time machine based on at least one task, copies itself into an AI time machine world as at least one virtual character using investigative tools and the signalless technology to do work The robot, operating in the virtual world, assigns fixed interface functions from the AI time machine and linear inputs, while the virtual characters, operating in the AI time machine world, do work to submit desired outputs to the robot.

A software program can observe and analyze the universal brain to automatically assign fixed interface functions from the AI time machine to repetitive work done by at least one virtual character.

In standard mode, at least one user will submit sequential tasks through fixed interface functions and the AI time machine will output simultaneous or linear desired outputs. The work needed to generate the desired outputs in standard mode includes at least one of the following:

1. the AI time machine extracts virtual character pathways from the universal brain and tricks the virtual character pathways in a virtual world to do automated work;
2. real virtual characters, structured hierarchically, are using investigative tools and the signalless technology to do manual work.

Fixed interface functions for the AI time machine are at least one of the following: software interface functions, voice commands, a camera system to detect objects, events, and actions, and manual hardware controls.

In training mode, virtual characters are structured hierarchically and they work together in a team like organization to do at least one of the following:

1. a captain analyzes at least one user and the user's inputs and understands the user's goals, intentions and powers based on human intelligence, manages tasks for the user, accomplish tasks, give tasks to lower level workers, and submit desired outputs to the user.
2. each virtual character understand their roles, rules, powers, status, limitations and procedures based on common knowledge learned in college, books or legal documents.
3. each virtual character does work using investigative tools and a signalless technology.
4. the captain understands the user's roles, rules, powers, status, limitations and procedures based on common knowledge learned in college, books or legal documents.
5. virtual characters can use investigative tools to predict the future and act based on the best future possibility.

A note to the reader: I will be presenting examples on both individual input/desired output and sequential inputs/desired outputs. Extremely complex individual tasks have to be trained first in the AI time machine. Sequential tasks require a captain (a virtual character) to manage multiple tasks and give orders to execute tasks. The example used in the football game (below) is an individual input/desired output. Later on, I will give examples of sequential inputs/desired outputs.

Football Example

I will give an example of how the AI time machine is trained to predict the future events of a football game. In training mode, the robot is transported into the virtual world. The robot has to trick a pathway by setting up the input and desired output. He will pretend to access interface functions (the input) from the AI time machine. The input consists of pretending to input information into a form and submitting it. Next, the robot will make a copy of itself inside the AI time machine as a virtual character. The virtual character is responsible for doing all the work to predict the football game (FIG. 4).

The virtual character/s can use a trinity of technologies (including the AI time machine) to do work. He can also request a group of other virtual characters to do work.

In this example, the virtual character uses a software program to generate an initial prediction tree for the football game. Next, the virtual character uses the autonomous prediction internet to predict the future. Finally, when the predictions are made, the virtual character is responsible for extracting specific data from the autonomous prediction internet and processing and outputting that information to the robot in the virtual world. The format of the desired output is specified by the robot (the user) in the input. The robot might want to see a short summary of the game, highlighting the most exciting parts. The virtual character will be the one to take information from the prediction internet and to convert that data into a presentable format. In this case, the desired output specified by the robot (the user) is a short video.

In the first step, the virtual character can actually use the AI time machine to do the complex work of generating a prediction tree for the football game. In the second step, the virtual character has to access the autonomous prediction internet, whereby teams of virtual characters will work together to predict future events of the football game. These teams of virtual characters have to input, delete and modify predictions in the prediction internet. When the autonomous prediction internet is done and the final results are presented on their website, the virtual character will extract data that he thinks is important. Finally, during the last step, the virtual character has to convert the data extracted into a meaningful and presentable manner. The input by the user specifies that he wants to see a video summary of the game. The virtual character will analyze the data extracted from the autonomous prediction internet and determine the exciting parts of the football game. He will take videos made for the football game by predictors and string them together into one video. This short video will be the desired output submitted to the robot (the user) in the virtual world.

This football example is only one training for the AI time machine. If the AI time machine was trained with millions of football game examples, the pathways will self-organize and create universal pathways that can predict the future outcome of “any” football game. The user that is accessing the AI time machine in standard mode can predict any football game that he wants.

Universal Prediction Algorithm

The reason why I call the technology the universal prediction algorithm is because the AI time machine can predict any event, object or action. There are no limits as to what it can and can't do. This technology can predict the future events of a football game, a basketball game, the stock market, the weather, human beings, animals, news events and so forth.

In FIG. 6, the diagram depicts the self-organizing of predictions. Football predictions will be stored close to similar sports such as soccer or basketball. Notice that baseball is farther away from football than soccer. The reason why is because soccer is more similar to football than baseball. Within the prediction tree for soccer and the prediction tree for football, they share commonalities.

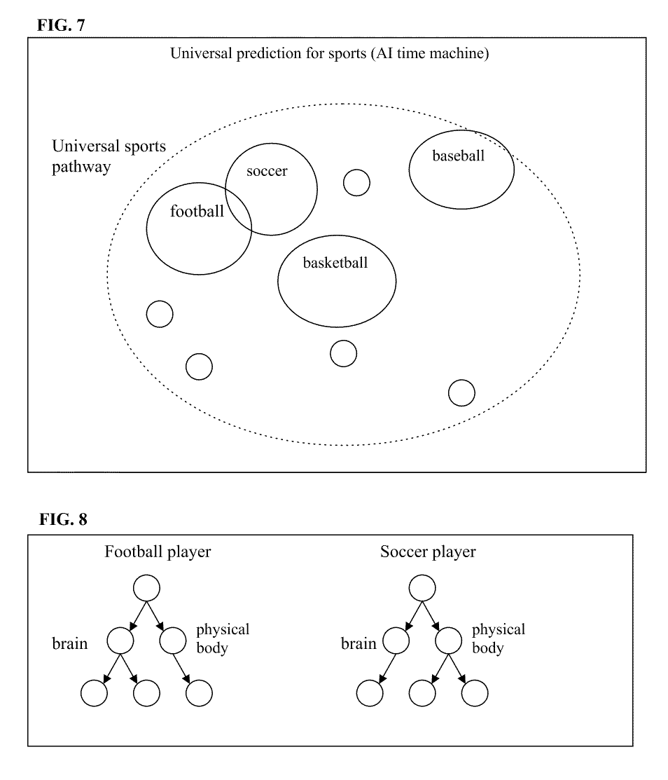

If the AI time machine is trained with various sports such as: football, baseball, basketball, polo, volleyball, hockey, baseball and soccer, the pathways in memory self-organizes into universal pathways. This allows the AI time machine to predict “any” sport. Even made up sports that don't exist can be predicted. Even sports that have their rules completely changed can be predicted. The universal sports pathway has adapting aspects that can predict future events for “any” sport (FIG. 7).

A Commonality Between Predictions

The diagram in FIG. 8 shows that despite the differences between a football player and a soccer player, there are predicted models that share similarities. For the soccer player, his lower levels consist of brain and physical body. For the football player, his lower levels consist of the exact predicted model, brain and physical body. This example shows that when predictions are made between two human beings, their prediction methods are similar.

Details of a Predicted Model

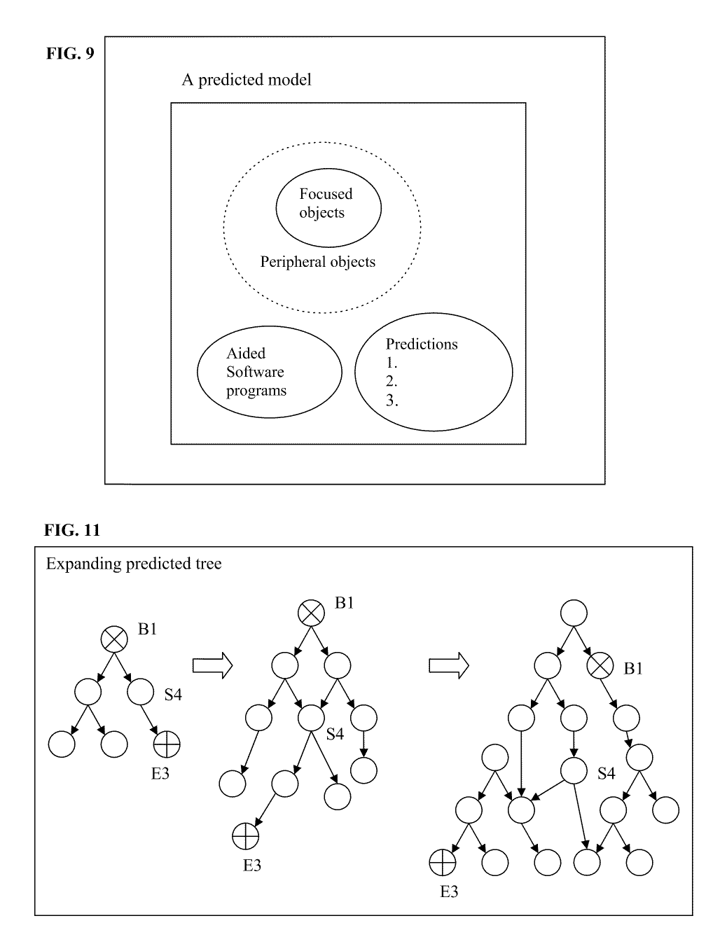

Each predicted model will have the variables: focused objects, peripheral objects, future predictions and aided software programs (FIG. 9). There is no clear standard what the future predictions will be. It really depends on what the predicted model is trying to predict. The team of virtual characters has to decide what output will be presented for their predicted model. These outputs are the data that is seen by parent and child predicted models or neighbor predicted models.

Focused objects are the objects that the virtual characters are primarily concerned with. Their job is to do predictions based on the focused objects. There are also peripheral objects that are considered minor objects, but the virtual characters might need these objects in order to make a better prediction. The lower level predicted models help to prioritize and limit the amount of objects that each predicted model has to work with.

The common knowledge container has lists of what predictions to output for a given predicted model. The virtual characters can use this knowledge to make their predictions. A software program can be created to better aid a user to view and manipulate the ranked predictions. For example, there might be functions to insert variables into the predictions to make it more accurate. Or there might be functions to modify certain aspects to get a better prediction.

The virtual characters might take individual software programs from multiple lower level predicted models and come up with their own software program that can manipulate different predictions.

The prediction tree is just an outline that structures important objects for a given prediction. This way, the virtual characters can use their time wisely by doing work on important objects only. The predicted models are also structured hierarchically so that teams of virtual characters can concentrate on limited amount of objects to analyze. Each team that does predictions has to work in a united manner. The goal is to predict different aspects of a prediction, simultaneously. These teams of virtual characters should act as one entity that is aware of all knowledge generated by the prediction tree.

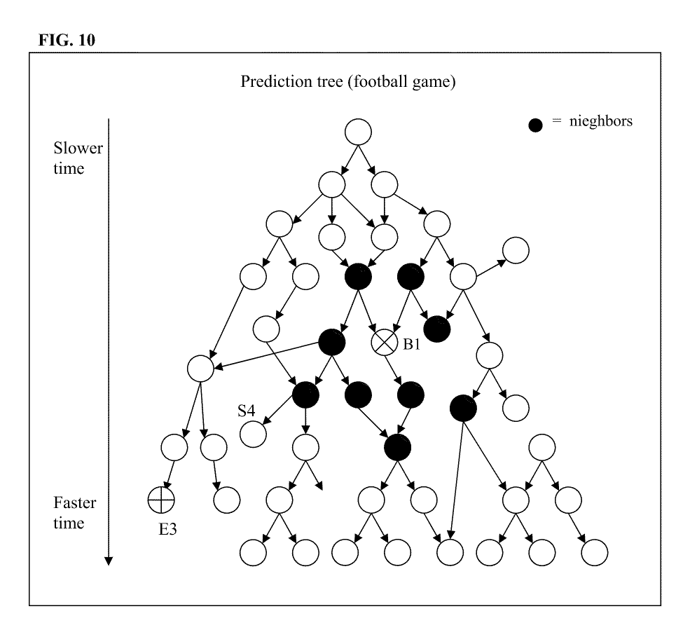

FIG. 10 is a diagram depicting time dilation for the prediction tree. All predicted models have to be worked on simultaneously. However, the top levels have to wait for the lower levels to do their work first. Thus, the top level predicted models have slower time and the lower level predicted models have faster time.

Work should be distributed equally among the predicted models in the prediction tree. There is no point in predicting the final score of the football game when the 4^{th} quarter hasn't been predicted yet. There is no point in predicting the future possibilities of the quarterback when the quarterback's brain hasn't been predicted yet.

In FIG. 10, B1 (X node) is the predicted model the team of virtual characters are working on. They will look at data from its neighbors (black nodes) and using this data they will output their future predictions and aided software programs. B1 is only concerned with data from itself and its neighbors. Anything outside its neighbors should not be analyzed.

Predicted models in the tree will be added, deleted or modified as work is done. Predicted models that virtual characters think are not important will be deleted. Predicted models that are not in the tree will be created based on demand. Pre-existing predicted models can also be re-organized in a different part of the tree. Teams of virtual characters have procedures that they will follow to add, delete and modify predicted models in the prediction tree. As more work is done on the prediction tree, the predicted models are arranged in an optimal manner.

This optimal structure of the prediction tree will allow the virtual characters to concentrate on the most important objects to analyze and to output accurate predictions.

Hypothetically, let's say that B1 wanted to use data from E3. E3 is an unrelated predicted model and it is very far away from B1. The Team of virtual characters from B1 will create a new predicted model called S4 that has both aspects of B1 and E3. This S4 will be attached somewhere that has the closest predicted model. S4 will be attached to parent nodes as well as child nodes.

The key here is that if S4 isn't a very popular predicted model and very little people like to make predictions there, then that predicted model will be deleted. If teams of virtual characters agree that this predicted model is important, S4 will stay.

In another case, a pre-existing predicted model can be changed in terms of the teams' goals, purposes and predictions. The team can state that the focused and peripheral objects are not accurate and therefore, they should be changed.

Teams of Virtual Characters Will Act Like Competing Businesses

When the prediction tree is generated, each predicted model will be assigned to certain specialized teams. Each team of virtual characters has to register and define what their expert fields are. Some teams specialize in ocean currents and others specialize in analyzing atom interactions. Every single predicted model or prediction tree self-organize in memory and software can be created to assign teams of virtual characters to predicted models.

It is prudent to assign more than 1 team to a given predicted model because you want two or more teams to compete with each other in who can generate accurate future predictions in the fastest time possible. The common knowledge container has a list of teams and how they rank. This list will motivate each team to do better in the future.

Teams can also dictate what predicted models they prefer to work in. They can work on one predicted model and then jump to another predicted model.

FIG. 11 is a diagram depicting the behavior of the prediction tree as time passes. The predicted models in the tree will expand as more work is done. Notice that B1, E3 and S4 expand as more predicted models are added. The more work done on the prediction tree the larger the tree will become.

Working in an Expanding Prediction Tree

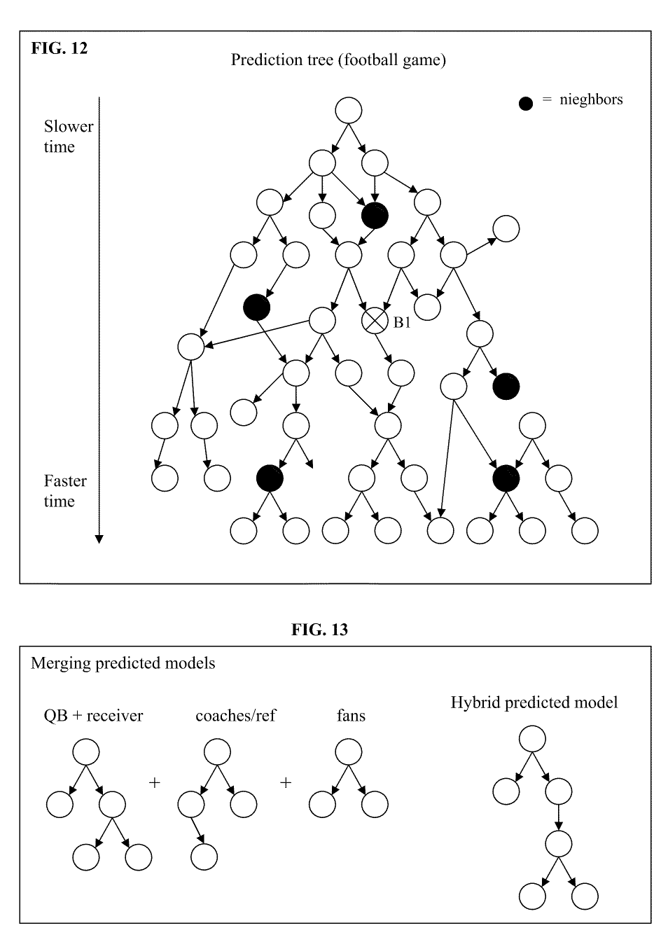

For predicted model B1, as the prediction tree expands, there will be more neighbor predicted models. B1 can search for spaced out neighbor predicted models instead of close-by neighbor predicted models. FIG. 12 illustrates that if the prediction tree expands dramatically, B1 can search for limited spaced out neighbor predicted models.

It is desirable to search for limited spaced out neighbors because the information in its close-by neighbors are too similar. The team is concerned about the focused objects, but in order to have a better understanding of alternative possibilities, different information must be analyzed and not similar information.

The Signalless Technology and its Role

The signalless technology basically collects information from sensing devices like cameras and microphones and uses the AI time machine to create a perfect 3-d map of the current environment. In terms of the football game, all electronic devices like cellphones, cameras, sonar devices and microphones are used to collect as much data from the environment as possible. This data is then processed by the AI time machine and the entire 3-d map of the football stadium is tracked atom-by-atom. No dangerous em radiation is ever used such as x-rays or gamma rays. The AI of the time machine simply collects as much data from electronic devices (even robot pathways) and it uses this information to map out the atomic structure of the current environment.

The signalless technology collects as much information from the environment as possible and it uses artificial intelligence to fill in all the missing pieces. In later chapters this subject matter will be described in detail. In this chapter a summary will be provided.

The AI time machine can encapsulate work done by teams of virtual characters. In the signalless technology, the job of the virtual characters is to take information collected by electronic devices like cameras and microphones and analyze the data for meaningful information.

A simple example is to track where someone is. If a person goes into a bank and the security cameras capture his image, that means the person is in the bank. A more complex form of tracking someone is to use logic to figure out where someone might be located. Let's say that a team of virtual characters are interested in tracking where 2 people are. Hypothetically, there are 2 people living in houseA and person1 loves to watch cartoons and person2 loves to watch game shows. One day a signal from the TV station was sent to the virtual characters stating that someone from houseA is watch cartoons. The virtual characters will assume that person1 is at houseA watching cartoons. On further investigation, a camera picked up person2 walking to his work place. The virtual characters will use human intelligence and assume that person1 is at houseA watching cartoons, while person2 is at work.

Once all the intelligent objects are tracked such as human beings, animals and insects, the next step is to track non-intelligent objects like buildings, bridges, houses, stores, malls and so forth.

Tracking intelligent objects is important because intelligent objects move and they don't stay in one area forever. Non-intelligent objects stay in one area unless they are moved by another object. It is important for the signalless technology to first track all intelligent and non-intelligent objects in the current environment.

Once this is done, the signalless technology will use artificial intelligence to find out all the hidden objects that can't be sensed by electronic devices, such as molecules, atoms, distant objects and so forth.

In order to find out where atoms are located, the signalless technology has to analyze em radiation (from all spectrums) and to assume the existence or non-existence of atoms in the current environment. Also, movements of wind and sunlight can be used as data to find out hidden objects. For example, the pathways of em radiation can tell the virtual characters what objects the em radiation bounced off in order to reach the camera. These bounces create a map of the environment. Wind movement is also one way to find out how air travels and bounces off hidden objects.

Or the virtual characters can use spectrum analysis and human intelligence to guess what type of atom transmitted the em radiation and where this atom is located in 3-d space. For example, if you go to a place near a nuclear power plant, the camera will pick up radioactive matter in the air. This radioactive matter came from a power plant close-by.

In another example, the virtual characters can analyze a video and guess what place it is in the world. For example, if there is a camera that shows a house, the virtual characters can look at objects in the house to assume where this house is. The virtual characters can point to the hand bag and say, that hand bag is only sold in Korea. This indicates that the camera is probably located somewhere in Korea.

Conclusion:

The team of virtual characters has to use a combination of methods described above in order to map out the current environment atom-by-atom. In the case of the football stadium, the signalless technology has to collect information from electronic devices, like iphones, ipads, computers, laptops, cameras, microphones and so forth, and use the AI time machine to process all that information. The desired output from the AI time machine is a perfect atom-by-atom map of the football stadium.

While the signalless technology is processing a map of the current environment, information will be sent to the prediction internet as soon as possible. The virtual characters working in the prediction internet will take that information and use it to make predictions.

There should exist an automated feeding system that gives data from the map to the appropriate predicted models. For example, if one predicted model is to predict the physical body of the quarterback, then the data regarding the quarterback's physical structure is sent to that predicted model. In the lower levels, there might be a predicted model that predicts only the QB's left arm. The data from the map regarding the QB's left arm will be sent to that predicted model.

In another case, the entire map of the current environment is sent to the prediction internet and any virtual character that needs information from the map can have access to the information.

Predicted Model Outputs

All virtual characters have to understand that information from any of the predicted models changes constantly. Each team should be given notices of when the next modification will be available. Outputs from predicted models should not be based on only the most specific prediction. The output should be structured hierarchically—meaning the information is organized from general to specific. Other teams should be able to extract a general prediction or a specific prediction. For example, if one predicted model is to output the throw of the football, the future predictions can have 3 possibilities at the top (a general prediction) and 10,000 different future predictions at the lower bottom (a specific prediction). These predictions are ranked and probability statistics are included.

The difference between a general prediction and a specific prediction is that the general prediction has a higher probability of happening.

Merging of Two or More Predicted Models

Let's say that a team of virtual characters wanted to merge multiple predicted models together and create a hybrid predicted model. They can use the AI time machine or a fixed software program that will generate the hybrid predicted model. FIG. 13 is a diagram depicting an example of a hybrid predicted model. The team of virtual characters are trying to merge three separate predicted model: 1. the quarterback and the receiver. 2. the coaches and referees 3. fans in the stadium. Each predicted model has been worked on and future predictions are presented.

The team of virtual characters will use the AI time machine to generate a hybrid predicted model based on all three predicted models. Objects in each predicted model will be analyzed and the hybrid predicted model will have new focused objects and new peripheral objects. Hierarchical nodes will contain the strongest groupings between the three predicted models.

I'm assuming that there are no pre-existing predicted models similar to the hybrid predicted model.

The next thing is for the team to determine where this hybrid predicted model should be located in the prediction tree. The hybrid predicted model has to attach itself to parent predicted models as well as child predicted models. It should also be located in an area where there are similar predicted models. These things can be accomplished by the AI time machine or by fixed software programs.

Merging Multiple Prediction Trees

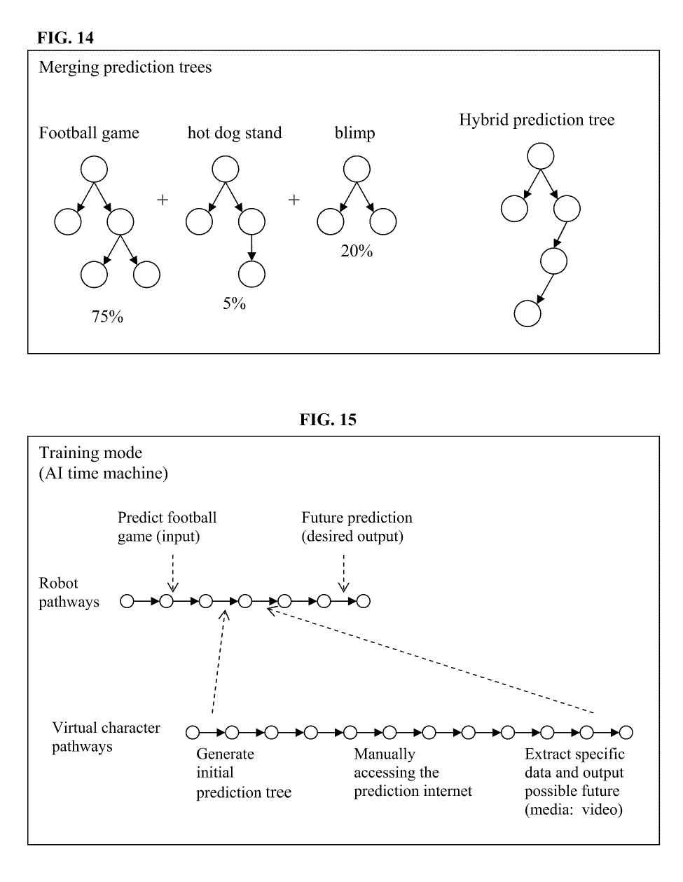

Let's say that the entire prediction tree of the football game has been predicted and future events of the football game are known. The team of virtual characters might want to combine multiple prediction trees. FIG. 14 is a diagram depicting the merging of 3 prediction trees. These prediction trees are: 1. the football game. 2. the hot dog stand outside the stadium. 3. the blimp above the stadium.

The hybrid prediction tree must establish important object groupings between the three prediction trees. All objects are prioritized as well. For example, the football game is very important because that is where most of the intelligent human beings are located. The hot dog stand is non-important and really doesn't affect the football game nor the blimp above the stadium. The blimp does in some minor way affect the human beings in the football stadium because they see the blimp in the sky and sometimes human beings focus their attention on the blimp.

The team of virtual characters will probably use the AI time machine or fixed software programs to generate the hybrid prediction tree. In the prediction internet, there are many prediction trees, and software programs can be designed to compare separate child prediction trees and extract a parent prediction tree. The parent prediction tree should be the optimal tree that contains hierarchically structured object groups between the three child prediction trees.

The priority of each prediction tree is very important. In the diagram, the football game has a 75% priority rate, the hotdog stand has a 5% priority rate, and the blimp has a 20% priority rate. This means that more prediction time should be devoted to the football game than any of the other two prediction trees. It's about isolating objects, events and actions. The hotdog stand doesn't affect the football game (only at a microscopic level). However, the hotdog stand is affected by the football game. When fans cheer, the hotdog stand can hear the sound. If the hotdog stand sells 10 hotdogs instead of 9, the football game won't be affected.

In some ways, all three prediction trees have relational links to each other and each can affect the future outcome. During a gameplay, the quarterback might be distracted by the blimp in the sky and he misses a throw to the receiver. This example shows that the blimp caused the quarterback to miss a throw to the receiver.

The relationships between objects will most likely be 5 sense data from human beings. The relationship between human beings in the stadium and the blimp will be the visual image of the blimp in each human beings' eyes. There are very few relationships between the 5 senses of the human beings in the stadium and the hot dog stand because the people in the stadium can't sense anything from the hot dog stand. A fan in the stand might think about the hot dog stand and wishes he can go there to buy a hotdog. This thought might change the way he will act. And this action might affect the players on the field.

Autonomous Prediction Internet

There are two states to the prediction internet: 1. manual work by teams of virtual characters. 2. autonomous work by teams of virtual characters. In the first state, each virtual character has a complete brain and they can think and act with human level AI. In the second state, virtual character pathways are extracted from the universal brain and they are tricked into doing work. In this case, work means predicting the future.

FIG. 15 is an example of manual work done by teams of virtual characters. Each virtual character has a full brain and they can think and act like a human being. They will manually work on predictions in the prediction internet.

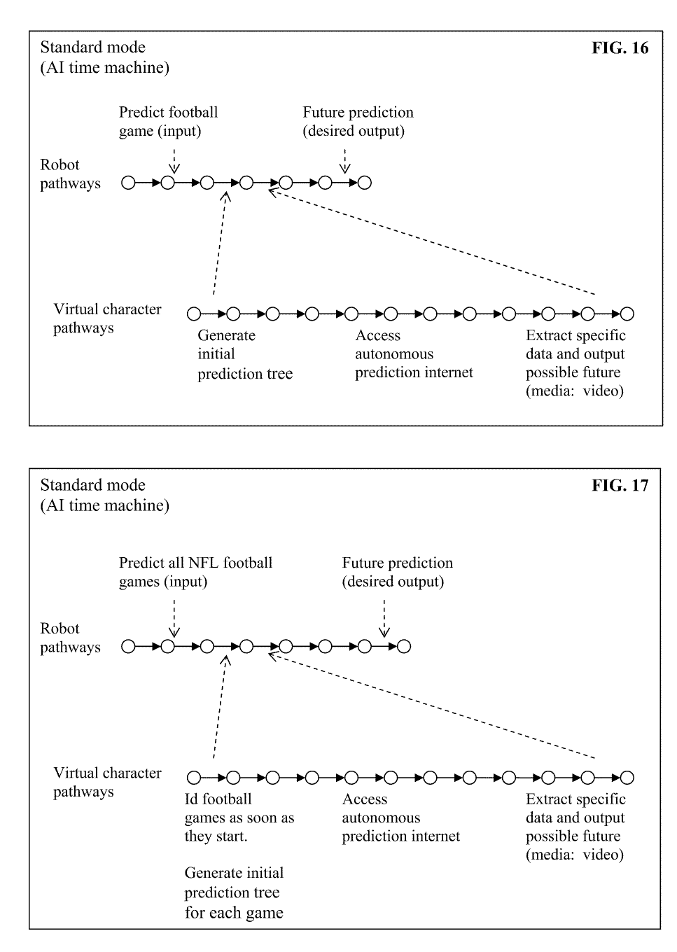

FIG. 16 is an example of automated work done by teams of virtual characters. An AI system will extract virtual character pathways from the universal brain and trick each pathway into thinking work is done. In this case, work means predicting the future.

The AI time machine is the key to understanding how this method works. In training mode, the virtual character has to do things manually to train the AI time machine to do prediction tasks (FIG. 15). A lot of training is needed in order for the standard mode to work properly.

In standard mode, no manual work is needed. A user simply accesses the interface function (the input) from the AI time machine and the desired output will automatically be displayed to the user. The prediction work is based on an AI system that extracts virtual character pathways from the universal brain and tricks these pathways in a virtual world so that work is done (FIG. 16). The universal brain stores pathways from all virtual characters.

Summary of the Autonomous Prediction Internet

In an autonomous prediction internet, the AI system has to mimic the behaviors of teams working in the prediction internet. In previous chapters, I talked about how teams of virtual characters work together to predict one football game. This is just a simple example. A more complex example includes predicting every football game in the NFL league as each game starts. FIG. 17 is a diagram depicting how a pathway in the AI time machine can be trained to predict all NFL football games played on Earth. Each prediction will start as soon as each football game starts.

The reason that the prediction for each NFL football game is predicted as soon as it starts is because the teams of virtual characters will have an easier time doing their predictions. They would filter out rare events like the quarterback is sick or the receiver was unable to attend the game. By doing the predictions at the beginning of the game, all players, referees, coaches, and fans are accounted for.

In order to predict all NFL football games, the teams of virtual characters have to use software to be informed on when games begin. For each game, information from electronic devices and cameras are sent to the prediction internet for processing. The prediction internet, in this case, isn't predicting one football game, it is predicting multiple football games that are happening at the same time. Thus, each football game will be given a prediction tree and teams of virtual characters will be working hard to predict each games' future events.

If this prediction internet is trained often (using training mode for the AI time machine), an “autonomous prediction internet” will be created (FIG. 17). The behavior of the autonomous prediction internet can be assigned to fixed software functions in the AI time machine. Finally, a user can predict the future for all NFL football games without real virtual characters doing work during runtime. In other words, a user can type into the AI time machine that he wants to know the outcome of all NFL football games and the AI time machine will instantly output future events of each NFL football game that is currently being played. The output will most likely be a short video summary of each game, highlighting the dramatic moments in the game and presenting the final score.

Using the Autonomous Prediction Internet to Predict the Past, Present and Future

In this chapter, we will discuss a complex example, whereby the prediction internet has to predict not only the future, but the present and the past. We will make the prediction even more complex by stating that we want to predict all events, objects and actions on planet Earth. All events, objects and actions that happened in the past, are presently happening now, and will happen in the future will be predicted accurately using the AI time machine.

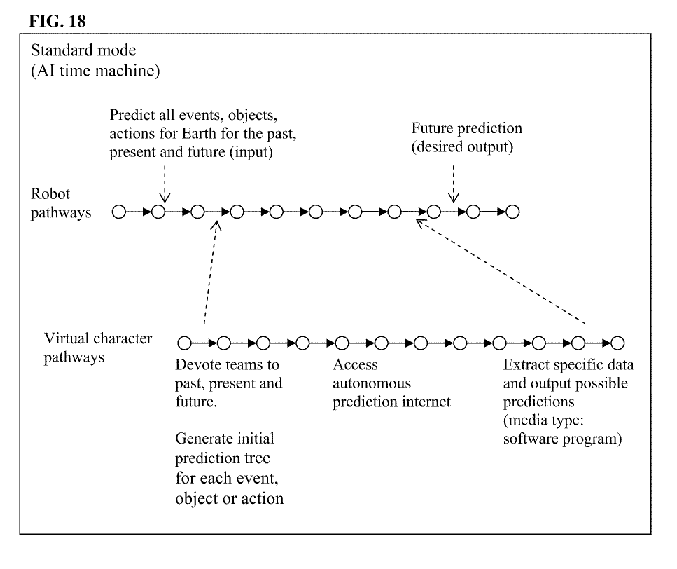

FIG. 18 is a diagram depicting a pathway in the AI time machine that will accomplish the task. The AI time machine is in standard mode and a user can accomplish tasks through the AI time machine. In this case, the user wants to predict all events, objects and actions for planet Earth for the past, present and future.

Of course, the AI time machine has to be trained with many examples (using training mode). When there is an adequate amount of training this pathway can be used in standard mode. The autonomous prediction internet will extract virtual character pathways from the universal brain and trick the pathways in a virtual world to predict past, present and future events on Earth.

In FIG. 18, the job of the virtual characters is to create a central prediction outline and to coordinate all the teams that will be doing the predictions. This central prediction outline specifies what the goals and rules are for anyone participating in the prediction. One goal is to devote 70 percent of team resources to predict the present, 25 percent will be devoted to predicting the past and 5 percent will be devoted to predicting the future.

All events, objects and actions in the past, present and future are stored in an interconnected web. A simultaneous way of predicting events in the past, present and future will yield the best results. There is no point in predicting the future if we haven't predicted the present yet. Also, there is no point in predicting the past if we haven't predicted the present yet. For example, there is no point in predicting the future actions of a quarterback, if we haven't predicted the quarterback's current brain state. By predicting the current thoughts of the quarterback, the virtual characters can understand the quarterback's future goals. By understanding the quarterback's future goals, we can understand how his body will move in the future.

70 percent of team resources are used to predict the present because past and future events depend on present events. Only 5 percent of team resources are devoted to future prediction because predicting the future is so darn difficult.

Another goal in the central prediction outline is to continuously predict the past, present and future. In one minute of the prediction internet, the teams of virtual characters might predict 70 years into the past with pinpoint accuracy. In the second minute, the teams of virtual characters might predict 2 million years into the past with pinpoint accuracy. In the third minute, the teams of virtual characters might predict 40 trillion years into the past with pinpoint accuracy.

As time passes, the timeline of Earth in the prediction internet gets more detailed. These teams of virtual characters aren't interested in predicting events they already know, they are interested in predicting events that they don't know. The central prediction outline should contain this goal and all virtual characters who do predictions have a clear understanding of all goals and rules contained in the central prediction outline.

The autonomous prediction internet (API) will mimic the behaviors of teams working in the prediction internet. Specifically they will mimic the goals and rules specified in the central prediction outline. The AI of the autonomous prediction internet will extract virtual character pathways to do work in the prediction internet that mirrors how teams of virtual characters are doing work in the prediction internet.

For example, the API will devote 70 percent of resources to predict the present, 5 percent of resources to predict the future, and 25 percent of resources to predict the past. All virtual characters will predict only events that are not stored in Earth's timeline.

As the autonomous prediction internet is running, the timeline of Earth becomes more detailed. Events in history are more accurate and detailed; and future events are more accurate and detailed. The longer the API is running the farther into the past and future it can predict.

There are some slight differences between teams of real virtual characters that do predictions and the autonomous prediction internet. One big difference is that the real virtual characters can do complex predictions. Each virtual character has a full brain and they think and act like real human beings. On the other hand, the API extracts virtual character pathways from the universal brain and tricks these pathways in a virtual world to do work. Because of this, the API can only do simple or limited amount of work. The API also has to be trained adequately in order to output optimal predictions.

There can exist a dual system, whereby the real virtual characters are working in the prediction internet, as well, as the API. You may recall that work from the API can be assigned into the AI time machine as pathways. The real virtual characters can encapsulate work done by the API into the AI time machine. This means that the real virtual characters can use the AI time machine to accomplish tasks that can be done with the API.

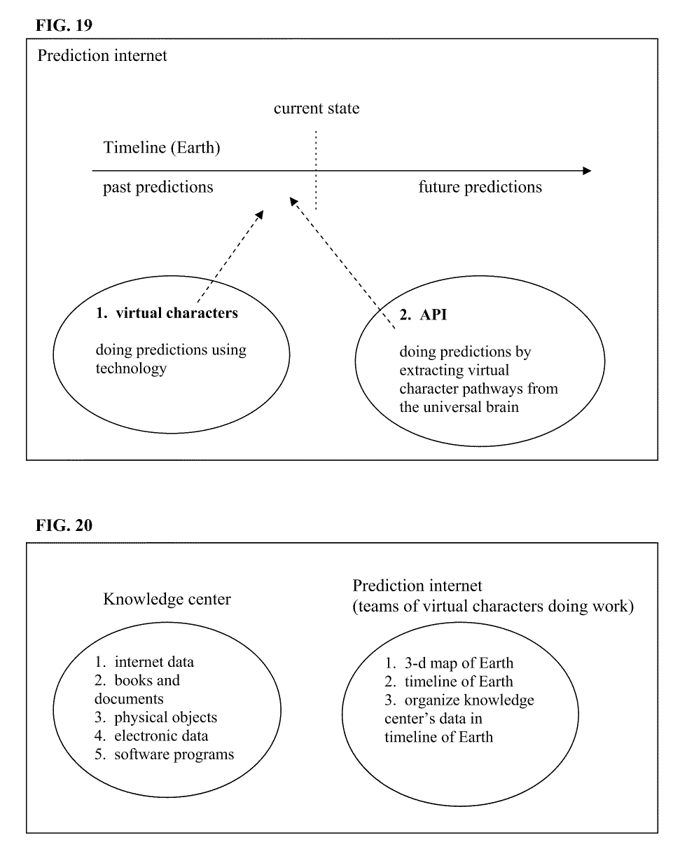

FIG. 19 is a diagram depicting two types of teams that are working on the prediction internet simultaneously. Each real virtual character has a full brain and they are using technology to predict events in the prediction internet. On the other hand, the API extracts virtual character pathways from the universal brain and tricks these pathways in a virtual world to predict events in the prediction internet.

A good idea is to use the autonomous prediction internet to do predictions on simple events, while the real virtual characters do predictions on complex events.

A software program can be created to monitor the API to make sure that it is predicting events accurately. If the software finds out that the API is constantly outputting wrong prediction data, then the software will tell the API to stop predicting in certain areas and tell the real virtual characters to do these predictions manually instead. If the API is doing a very good job and the prediction output is equal or better than the real virtual characters, then the software will tell the API to devote more resources to certain predictions.

If the API is trained adequately it should be able to do any prediction that a real virtual character can do. The API works much faster than a real virtual character and the computer processing needed to accomplish a prediction task is a fraction of what a real virtual character needs in order to accomplish the same prediction task.

Details of Predicting the Past, Present and Future

The first goal of predicting all events, objects and actions on planet Earth is to collect as much data from the current environment as possible. All data from electronic devices such as cell phones, laptops, computers, networks, cameras, satellites, sonar sensors, sensing devices, ipads, human robots, and so forth, has to be collected and sent to appropriate computers to be processed. For example, if a team of virtual characters are trying to collect as much information about personX, all electronic devices that relate to personX will be transmitted to the team. If personX is walking in downtown and a camera picks up his image, that information will be sent to the team. If personX is using his cellphone/laptop/computer/ipad/iphone, that information will be sent to the team. If other people are talking about personX on chatrooms, twitter or on a cellphone, that information will be sent to the team. In other cases, any news story relating to personX on TV, newspaper, magazine, or online will be sent to the team.

The team specifically requested any network station that collects information about personX to send that information to the team. In this chapter, we won't be going into the details of the “network technology” that allows this to happen. This chapter is focused on the virtual characters working as a team to make sense of the mountain of data that is coming from the internet about personX. These virtual characters have human level artificial intelligence and they use software to extract information to do past and future predictions on personX.

Teams of virtual characters can also access search engines to find information at the moment about a thing, place, person or event. However, only public information is available so search engines provide only public information. Automated software to search the network to find information about an object can be used by these virtual characters. Using these software, they can control how much information to search for, what information to search for, where the information originated and so forth about an object.

They can also manually search for data online or on private networks.

In the above example, the team of virtual characters is doing past and future predictions only on one person. Billions of teams, structured in a hierarchical manner, are needed to predict all events, objects and actions on Earth. They will work together and divide tasks among the teams to do their predictions.

Each team of virtual characters working on their predicted models will have automated software that will feed information on objects or events they are currently predicting. These software contains user interface functions that allow the virtual characters to change what kind of information to feed into their computers.

The virtual characters will also be using the signalless technology to map out the current environment as fast as possible and track every object, atom and electron. The signalless technology is only concerned with tracking the atoms of the current environment; it isn't interested in predicting the past or future. The real predictions are made by the teams of virtual characters.

The virtual characters can also specify targeted objects they want to track atom-by-atom. For example, if the virtual characters were in Hawaii and a football game is playing in California, the virtual characters can specify to the signalless technology that the target object is the football stadium. In another case, the virtual characters might specify that the target object is the football stadium and a 1-mile radius of all objects from the football stadium.

If the football stadium is the target object, all electronic devices related to the football stadium will transmit its data to the signalless technology and the system will automatically generate an atom-by-atom map of the football stadium and send that information to the prediction internet. This map will contain the 3-d map of all the fans, the players, the coaches, the referees, TV crews, and so on. The 3-d map will be done frame-by-frame. Also, the data from the 3-d map of the football stadium will be sent hierarchically—from general to detailed. As soon as the signalless technology generates a 3-d map, it will be transmitted to the prediction internet and any virtual character can use software to access objects in the 3-d map.

In fact, all electronic devices on planet Earth will transmit its data to the signalless technology and the signalless technology will generate a 3-d map of all objects on Earth as quickly as possible. This 3-d map will be posted on a website on the prediction internet and people can go there to access whatever information they choose.

The Knowledge Center and the Prediction Internet

The knowledge center is where all information about Earth are stored (FIG. 20). It contains not only electronic data, but data from physical objects like books and documents. In the prediction internet, virtual characters will make predictions and they will store their predictions in a meaningful universal timeline.

Predictions made by virtual characters can be in any media type. It can be a book, a short report, a comic book, a 2-d movie, a 3-d movie and so forth. Most likely, the prediction media is a 3-d animation, so that all angles of an event are depicted. If a video (which is 2-d) is captured, that video will be attached to the 3-d movie it represents. The timeline of Earth will store both the 3-d movie and the 2-d movie of events.

All activities over the internet will be stored as they occur in the timeline. If a surveillance camera captures a scene for 5 hours, that video is attached to the physical 3-d map of the surveillance camera and when it occurred. If a person takes a picture of a whale, that image will be attached to the 3-d event of that person and the whale. If a user buys shoes from a website, that data will be stored in the 3-d representation of the user.

It's not just the electronic data that is stored that needs to be tracked, but the electrical signals sent from computer to computer. The tracking will include storing how, when, where, and what electrical signals were send from computer to computer and how the electrical signals are stored in a harddrive and how the computer processes the data to display a video on a monitor.

In fact, all electronic devices must record all their internal processes and activities. The physical aspects of the electronic device are one type of data, and the electrical signals they transmit are another type of data that must be stored in the timeline.

The knowledge center is just a chaotic container that stores information from the internet, (TV networks, radio stations, electronic devices, camera systems, sensing devices, computers), physical books and documents, data stored in electronic devices and so forth.

The prediction internet is a place where the virtual characters are using technology (software and hardware) to organize the data into a universal timeline of Earth. They have to take whatever data that comes in from the knowledge center and use them to fill in missing data. They also have to take the data from the knowledge center and store them in the timeline of where, what, when and how they were created.

The AI time machine can act as a search engine to find specific data in the knowledge center or to find specific data from the prediction internet. As stated before, the AI time machine is a more advance type of search engine. I use the term “task engine” to describe the AI time machine because it can accomplish complex tasks for a user. One of its tasks is to search for information over the internet. The current search engines (2010) can't do tasks. For example, it can't write an operating system in less than one second or file a patent with the United States patent office.

Predicting Current Events in Earth's Timeline

For the present, all objects on Earth are tracked every fraction of a nanosecond. All intelligent objects, non-intelligent objects, computers, electronic devices, atoms, electrons, protons, neutrons, em radiations and so forth are tracked.

These objects are tracked based on what is available to analyze in terms of data from electronic devices like cameras, computers and phones. Based on the available data, the virtual characters will work together to fill in all the missing data and to track objects that aren't in the knowledge center. In most areas of the world there are no cameras or phones in every corner. Most objects in the World are hidden to any electronic sensing device. The virtual characters' job is to guess what these missing objects are by analyzing the available data and using technology to predict what objects are missing.

For the present predictions, all objects on Earth are structured hierarchically. Each objects' importance is based on how much influence that object has with the rest of the World. For example, the president of the United States is more important than any given citizen. This importance will place the president with top priority and teams of people will be tracking his every action and thoughts first.

The world is changed because of the actions of intelligent objects. Human beings decide what the future events of Earth are. Because of this reason, human beings have top priority compared to other living organisms. Animals and sea life also decide what happens to the Earth. If there is no food, the human race won't exist. Thus, life is one complicated interconnected web.

Although human beings have top priority, we still need to predict other objects. The tracking of all objects on Earth has to be done uniformly and simultaneously. Large visible objects must be tracked first. The teams of virtual characters has to track all human beings, animals, houses, bridges, buildings, oceans, lakes, weather patterns, computers, networks, electronic devices, and so forth.

Next, the teams of virtual characters have to track smaller objects within these larger objects like insects, small items, tiny sea life, blotches of bacteria and so forth.

Then, the teams of virtual characters have to track non-visible objects within the small objects such as bacteria, air, bed bugs, sand and so forth.

Finally, the teams of virtual characters have to track very tiny objects like atoms, electrons, em radiation, electrical signals, electricity flow, protons, neutrons, molecules and so forth.

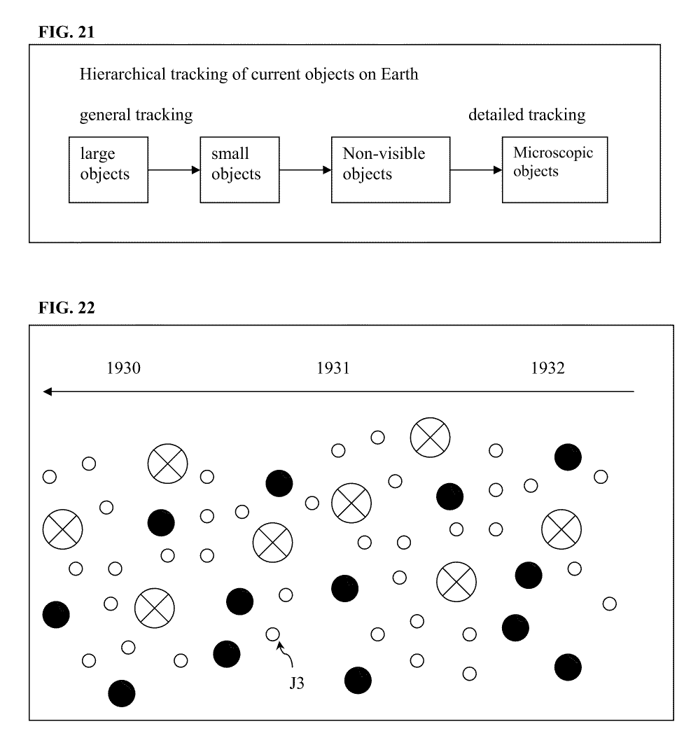

By tracking all objects on Earth, hierarchically, the teams of virtual characters can organize their tracking objects. FIG. 21 is a diagram depicting how the virtual characters should predict the current environment of Earth. The larger objects are tracked first. When all or most of the large objects are tracked, they will track the small objects. After all or most of the small objects are tracked, they will track the non-visible objects. Finally, after all or most of the non-visible objects are tracked, they will track the microscopic objects.

Predicting Past Events in Earth's Timeline

Human beings are the primary reason that the Earth changes. It should be a no brainer to predict the lineage of the entire human family. Every human being that existed in history should be plotted on a family tree. Websites like ancestry.com provide scanned and registered documents of family connections. The information is valuable in terms of tracking every single human being on Earth, not just for the present environment, but our distant past.

The virtual characters have to create a family tree that spans thousands or millions of years from the present day. Once the family tree for the human race has been predicted, the virtual characters can move on to family trees for our ancestors like the Cro-magnums or hobbits. Once the family trees are created for these primitive organisms, the virtual characters have to build family trees for apes (this is assuming that human beings evolved from apes). Next, they have to predict the family tree that created the apes. This will go on and on until every single life-form on Earth is tracked, recorded and attached to a universal family tree.

All living organisms are interconnected in an eco-system. The universal family tree will comprise all life-forms, this would include: humans, animals, reptiles, bugs, insects, bacteria and cells.

The universal family tree is important because it shows that certain organisms in the past existed. Data from this universal family tree can be used to prove unsolved mysteries in the past. Things like cold cases or agriculture behaviors or migration patterns can be solved using this universal family tree.

As stated before, there is no way that this universal family tree can be created independently. Events, objects and actions have to be predicted in an interconnected manner and in increments. FIG. 22 is a diagram showing a method to predict past events in an interconnected manner. The X circles represent general events, the black circles represent normal events, and the white circles represent detailed events. Let's say that the virtual characters wanted to predict J3 (a detailed event). Most of the X circles must be predicted first before doing predictions on the black circles. When most of the black circles are predicted, then the white circles can be predicted. When all or most of the black circles are predicted, all the white circles can also be predicted, not just J3.

On the other hand, let's say that only some X circles are predicted and the virtual characters wanted to predict J3. There may not be enough information there to predict J3. If you look at cold cases, the reason that investigators can't solve these cases is because there aren't enough clues to work with.

In FIG. 22, there are three incremental years: 1932, 1931, and 1930. The teams of virtual characters will work on 1932 first, predicting an adequate amount of events. Next, it will predict general events in 1931 and slowly predict its detail events. Finally, they will predict general events in 1930 and slowly predict its detail events. The virtual characters are actually predicting events in all three years simultaneously. While the teams are predicting the detail events of 1932, they are predicting the normal events in 1931 and they are also predicting the general events of 1930.

The detailed event J3 is found because the teams were able to predict the general events (X circles) and the normal events (black circles). This also means that the virtual characters has adequate knowledge to predict all the detailed events (white circles) from 1930-1932.

In FIG. 19, the real virtual characters and the API are working together using the method above to predict past events in Earth's timeline.

Predicting the human family tree require using hierarchical interconnected prediction (the method described above). Usually, governments register all citizens and their family members. Before the colonial days, no one had to register their family tree. Family trees before the colonial period would require virtual characters analyzing information and coming up with predictions. Some family trees are easy to predict. There might be 5 or 6 unknown people living in a small area of Hawaii in 1460. The virtual characters might be able to use logic to fit them into certain families. Human logic like: a human being has 2 parents, a male and female; family members live close to each other; and inbreeding in family members might produce deformed babies are used to find out which unknown human being belongs to which families.

If there were two couples living in a small area of Hawaii in 1460. CoupleA is around 60 years old and coupleB is around 30 years old. There is an unknown person that existed in 1460 and this person is 5 years old. The virtual characters will assume that the child might belong to coupleB (in their 30's). CoupleA is much too old to have a child in their late 50's.

There are other cases where it's harder to predict what family an unknown person is tied to. If we lived in the 1780's and a slave from Korea was brought to Hawaii to work in the plantation farms, it would be difficult to find out where this slave came from. Because the virtual characters don't know where this slave came from they can't assume what family he belongs to.

In order to solve this case, the virtual characters have to find out what boats traveled to Korea in the years around 1780. Let's say that an old pirate journal was kept and a ship sailed to a small village in Korea in 1777 and no other year records any ship going to Korea, then we can safely say that this unknown Korean slave came to Hawaii in 1777 from a small village in Korea. These virtual characters can do further investigation and find out that in the small village, a family tree is carved onto an old stone. The name of the Korean slave is carved into the stone. This evidence confirms that this unknown Korean slave has family in this small village.

The human family tree is very important because it shows the existence of human beings living in certain time periods. By understanding human existence we can predict the food consumption and market activities. Obviously, human beings have to eat and they usually eat meat and vegetables. Meat is had by killing cows and pigs, while vegetables have to be planted in farms. People are responsible for the work that is needed to process and sell food in the market place.

The human family tree can tell us things like how many animals are needed to sustain the human population or how many workers are needed to run the farm. This information is vital when it comes to predicting the family tree for animals or plants.

The virtual characters can go into the details and predict where people worked and what they were doing at all times in terms of making food and selling them in the marketplace. The existence of food can also be predicted—identifying the animals and plants that are needed to make food.

I was going to give more and more examples of how the teams of virtual characters can predict past events, but I won't do that. I think I already given ample examples in my previous books.

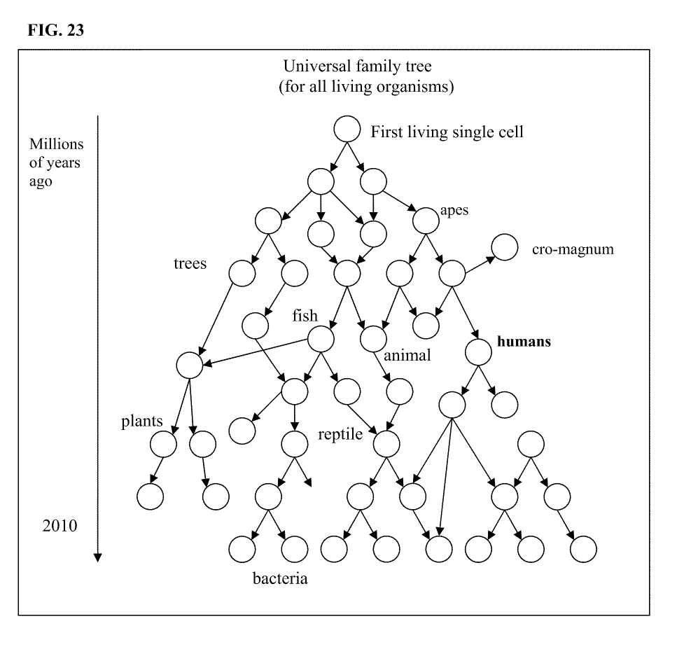

Creating the universal family tree for all living organisms on Earth for the past is vital because living organisms change the future (FIG. 23). For each organism in the universal family tree their lifetime is stored. Every single 5 sense data, thought or physical action for each organism are recorded in the timeline. People might think that a bacteria is insignificant and that it doesn't matter. The truth is that a single bacteria can enter a human being's body and multiply quickly. As a result of the single bacteria, the human being can get sick. If this person is a president of a country and he has an important meeting, his sickness might result in the meetings cancellation. All of this occurred because of the existence of one bacteria.

Creating this universal family tree isn't going to be easy. The virtual characters have to predict events incrementally. They predict events and objects in 1432 before they can predict events in 1431. The next prediction year will be 1430 and the year before that is 1429. If the virtual characters hope to predict events and objects that existed millions of years ago, they have to incrementally and uniformly do their predictions.

Predicting Future Events in Earth's Timeline

If we predict most events, objects and actions in the present and in the past, is it possible to predict the existence of living organisms in the future? In other words, can we predict the existence of human beings that will exist in the future?

In my previous books, I talk about how to predict the existence of future human beings. If we wanted to predict a Superbowl that will happen 300 years into the future, we need to predict players that will exist in the distant future. Some of my methods used in previous books include predicting mating events, predicting the creation of fetuses, predicting the merging of two separate DNAs and so forth. The prediction of future human beings is one of the most difficult tasks that the virtual characters will have to face. It is even harder than predicting the outcome of a football game. For example, the virtual characters have to predict the entire lifetime of a future human being, from conception to their grave.

It's not just future human beings the virtual characters have to predict, but all living organisms that will exist in the future, including: human beings, animals, plants, trees, reptiles, bacteria, insects, fishes and so forth.

In addition to that, the teams of virtual characters has to predict non-intelligent objects like houses, computers, networks, water, weather patterns, etc, etc.

Predicting the future requires breaking up objects in our current environment in terms of priority, grouping important objects together (the prediction tree) and predicting events, objects and actions hierarchically and uniformly.

Predicting the Future in Terms of Sequences

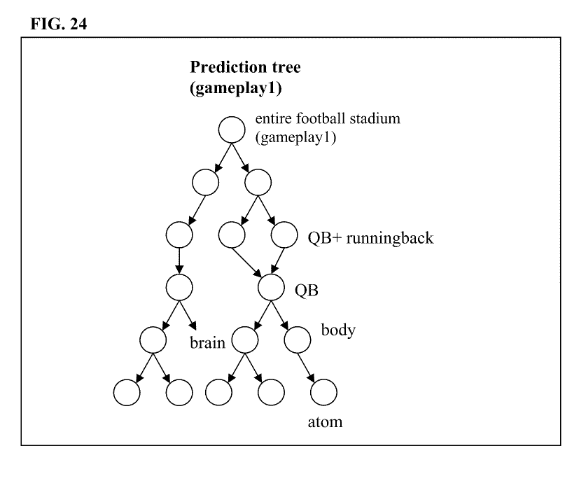

In previous chapters we only talked about one gameplay for a football game. In order to predict the entire 4 hours of the football game, many sequential gameplays are to be predicted. FIG. 24 depicts one gameplay in the football game. This prediction tree contains important hierarchical predicted models. Each predicted model contains the strongest objects grouped together in terms of dependency and importance. All objects of the gameplay are hierarchically structured for all objects involved (large objects like human beings or small objects like a blade of grass).

Predicting Sequential Events

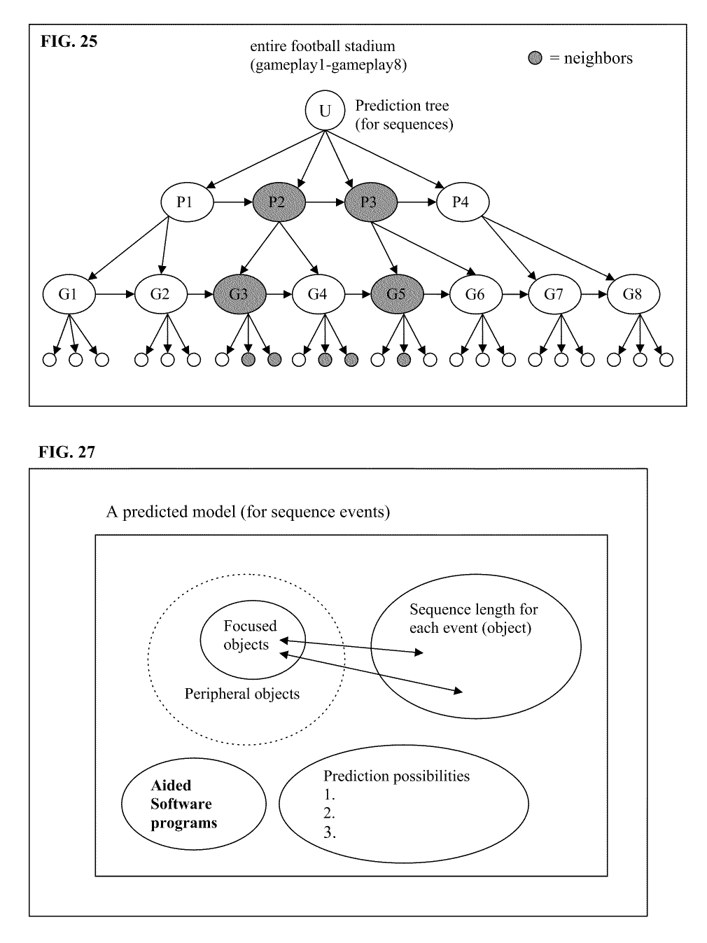

For simplicity purposes, a gameplay is represented with a G and gameplay1 is called G1. FIG. 25 is a diagram depicting a sequence of gameplays for the football game (G1-G8). Usually, the importance of a gameplay is based on the distance from the current state. The closer the gameplay is from the current state, the more important it is. For example, G1 is closer to the current state so it has a priority of 50%. G2 is farther away from the current state so it has a priority of 30%. The higher the gameplay's priority percent, the more virtual characters are assigned to predict the gameplay.

Predictions are done incrementally. The virtual characters will predict gameplay1 and check to make sure the future possibilities are accurate. Next, it will predict gameplay2 and combine that with the previous prediction (which is gameplay1). Then it will predict gameplay3 and combine that with the previous predictions. The idea behind a prediction tree for sequential events is to make a prediction sequence lengthier, but at the same time, to predict the “whole” sequence. For example, if the prediction tree predicts gameplay4, it also has to consider its previous sequences (gameplay1-3)

The prediction tree is constructed incrementally as the virtual characters add longer sequences. For example, if the virtual characters are predicting G1 and G2, the prediction tree will generate predicted models for G1 and G2 and all of its upper and lower levels. Part of their future sequences might be a part of the prediction tree as well. For example, G3 and P2 might be a part of the prediction tree. The prediction tree is assuming that the virtual characters will be predicting G3 in the future. As more sequences are added, the prediction tree will add more branches of predicted models.

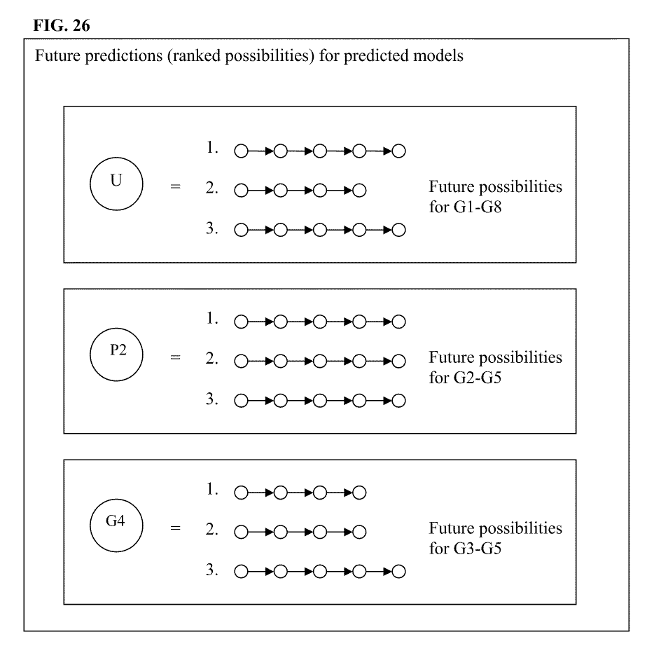

Each predicted model is interested in ranking their future possibilities. At the U level of the prediction tree, they are interested in creating a general ranking of future possibilities of gameplay1-gameplay8. At the P level, they are interested in creating a general ranking of future possibilities according to their neighbors. For example, the predicted model P2 is interested in predicting future possibilities based on G2-G5. At the G level, they are interested in creating a detailed ranking of future possibilities according to their neighbors. For example, the predicted model G4 is interested in creating a detailed ranking of future possibilities based on G3-G5 and most of their lower levels (FIG. 25 and FIG. 26).

The sequence that each predicted model in the G level is limited to is about 3 gameplays. For example, G4 is responsible for the sequence G2-G5 and G6 is responsible for the sequence G5-G7. They will create ranked possibilities for these limited sequences. FIG. 27 is a diagram illustrating a predicted model that includes sequences. There is a focused objects, peripheral objects and each event has a sequence length (an event is an object). The ranking of future possible events is based on the sequence length and the focused objects involved.

To complicate things more, the sequence length for a predicted model can change it's scope. Also, very general predicted models like the P level don't really have a fixed sequence length to work with because events can be fragmented. For example, language can encapsulate entire events. A sentence like “the cowboys win the game by a large margin” can encase the entire game. Important fragmented events in the football game can be represented by sentences. In the U level, the predicted model might highlight 4-5 important events in the game. These important events are extracted from the entire gameplays made in the football game (about 200 gameplays). Future predictions made at the U level focuses on the 4-5 important events to output rank future possibilities.

Referring to FIG. 25, each predicted model has to consider predictions made by neighbors from its parent nodes and child nodes. For example, G4 has to consider what G3 and G5 have predicted and the most important things in their lower levels (child nodes). G4 also has to consider some of the predictions make in the upper levels such as P2 and P3 (parent nodes). The parent nodes (P2, P3) contain a broader and general data about what are important objects/events contained between lower-level predicted models G2-G7.

By doing predictions in a hierarchical structure, the important objects (large or microscopic) will be flushed out. What if a blade of grass is responsible for the QB to trip and fall down. The G level predicted models will show that the blade of grass is important in the football game. In the P level predicted models, the QB and the blade of grass is important in the football game. In the U level predicted model, the QB and the blade of grass was the turning point that made the Cowboys lose the entire game.

The hierarchically structured prediction tree, initially, generates an initial tree for the teams of virtual characters to work with. This initial prediction tree was based on what prediction trees pre-existed in the prediction internet. As the virtual characters work on predicted models, data in predicted models will change (data is added, deleted or modified). The prediction work done by teams of virtual characters over a length of time will generate an optimal prediction tree. The virtual characters' predictions, flushes out the most important objects or events involved in the football game and structures and groups these important objects or events in a hierarchical manner (in other words, they modify the predicted models in the prediction tree).

This type of prediction method can work accurately with a football game. The simplest outcome of a game is win or lose. The predicted model U will look at all its lower levels and determine that P1, P2, P3, and P4 all agree that by the 3^{rd} quarter, the Patriots is winning by a large margin compared to the Steelers. The estimated score at the end of the 3^{rd} quarter is 31-7. The predicted model U can assume that the Patriots will win because it would take a miracle for the Steelers to make up 4 touchdowns in the 4^{th} quarter. Thus, in a general sense, the higher predicted models will have an accurate prediction of the future. It's up to the lower level predicted models to flush out rare events.

Software Programs Inside a Predicted Model

The most difficult object to predict for Earth are human beings. In fact, predicting the future actions of any living organism is very difficult to do. In order to predict future events of a football game, all future actions from players, coaches, referees, and fans in the stadium must be predicted accurately and uniformly.

In this chapter, my initial goal was to provide proof that it is possible to predict the 5 senses, thoughts, and actions of a human being. Things like the 5 senses of a person and their thoughts and actions are hidden to an observer. For example, a camera can't capture the thoughts of a person simply by seeing them. In order to understand someone's 5 senses and thoughts, artificial intelligence is needed to logically assume what a person is sensing and thinking.

There are two methods to really understand how a person senses and thinks. These methods are: 1. building simulated software based on a person's past. 2. building simulated software based on a person's physical body (the brain is the most important body part). For the first method, virtual characters has to collect lots of electronic information from a person, such as email, web activities, chat conversations, surveillance cameras, buying behavior, decision making behavior, desires and dislikes, and so forth, to create a composite of how that person senses and thinks. This method will not ultimately determine exactly how a person thinks. However, it can capture a person's behaviors and patterns so that the AI software can give a probability of what that person will do in the future.

The second method is painstakingly difficult to accomplish because it requires mapping out every atom in a person's brain (and the rest of his body). The teams of virtual characters have to use the signalless technology to find out all the atoms in the person's head, hierarchically. The identification of atoms in the person's brain should go from general to specific. For example, universal pathways are identified first. These universal pathways are very general and don't include any detailed instructions. Next, specific pathways in the person's brain are identified, whereby every location of neurons and dendrites are mapped out perfectly.

If a perfect map of the brain is created and the organs of the brain are delineated, then the virtual characters can convert that information into simulated software. All knowledge of the person is contained in his brain. This means that within his brain only one of the pathways will be selected to take action.

If we analyze a football player, his brain only contains a very limited amount of actions in terms of playing football. The rules of football limits the actions he can take. Also, the human brain contains about 50 billion neurons to store data. In a football player's brain, the knowledge of decision making for a football game is just a small fraction of 50 billion neurons. In other words, the virtual characters need to hierarchically predict the football player's brain by predicting pathways that matter first. Knowledge about football will be predicted first compared to the knowledge of solving a math equation.

The human beings' brain doesn't just include pathways, but organs that allow data to be extracted and processed. There are certain organs that create chemical electricity that travels through neurons. Other brain organs include trapping certain chemical electricity and sending them to the body's nervous system to move certain body parts. The virtual characters must identify and predict brain organs too, as well, as stored pathways.

The two methods above to predict how a person senses, thinks and acts must work together. The virtual characters must use both methods to predict the future actions of a human being. Information from the signalless technology will be sent to the prediction internet. The virtual characters will find specific data they are looking for and process them further.

In terms of how the signalless technology will map out every neuron and dendrite in a human's brain will depend on sensed data from the human. For example, the brain is encased in a skull and skin so the 5 sense camera system can't see the brain, nor its inner elements. However, when a person thinks, electrical charges are given off. The 5 sense camera can use these electrical charges to assume what caused them; and to use AI to map out the atom-by-atom structure of the brain. No X-rays or sonar devices are ever used to scan an object. Refer to my signalless technology book to find out how this is done.

The signalless technology will send information about an object (a human being) to the prediction internet hierarchically, from general to specific. While this is happening, the virtual characters have to build software programs that can represent the human brain in a manageable way. Sensed data from the human being are limited and the brain pathways selected are limited. The virtual characters handcrafted the most important elements of how the human brain works and convert that information into a software program. A user can see the most important aspects of the human brain through the software program in terms of sensed input, intelligence processing and pathway selection.

Human Beings are Really Stupid

Human beings are very stupid and they can only focus on a limited amount of data at any given moment. People might look around us and see a world that has hundreds of objects per second. Reality is that a human being can only focus on 2-3 objects from our environment. If the human being is in a busy city during lunch time, he is mainly focused on 2-3 objects at any given moment. The rest of the objects are fuzzy and ignored.

Even the thoughts of a human being are very limited. It takes about 1 second for 1 thought to activate in the brain. Sometimes, thoughts take 2-3 seconds to activate. Things like searching for answers to complex questions require the brain to search for that information and this process takes time.

Because human beings sense and act slowly, it is quite possible to predict their future actions, even if this information is hidden.

Another reason that it is possible to predict the future actions of a human being comes from a famous statement: “a person's goals become reality”. That statement sums up why it is possible to predict the future. If the virtual characters predicted that the goals of a quarterback is to hand the ball to the runningback, then that is exactly what's going to happen in the future. The quarterback has to decide what his going to do (logically or randomly) before every gameplay. If his goal before a gameplay is fixed, he will carry out that goal in the future. Also, when a person makes a decision, it is very unlikely that they will change their minds in the next few seconds because human beings are rational and not fickle minded.

In terms of a football game, events are happening so fast that it is very difficult to change your mind. In fact, quarterbacks that change their mind at the last second usually fail. Also, there are some team players that coordinate their actions without any prior notice. They use common knowledge from practices to know what each other are thinking.

In other cases, the quarterback doesn't have a fixed goal. He will make a decision to throw the ball and he will use intelligent pathways in memory to search for “opened” players. His thinking might be to throw to a far receiver. If no receiver is open, his instruction is to throw the ball to any close player. This behavior to act, comes from a universal pathway in the QB's brain to decide what he will do during runtime in the game.

I think the most important aspects of a human being (a quarterback) are the human being's brain and his physical body. These two parts have to be predicted separately at first and a team of virtual characters at the top level has to predict their interactions.

The virtual characters' job is to observe past behaviors of the quarterback and to devise a software program that will store possible decision making pathways. Any linear methods that the quarterback uses should be stored as possible pathways.

In order to do this, the AI time machine (aka universal computer program) has to analyze any past football games played by this quarterback. The AI time machine, in this case, is used to identify linear methods of play and thought by the quarterback. The virtual character will compile this information about the quarterback and handcraft another software that create a simulated brain of the quarterback.

A very sophisticated type of brain simulation is needed (yet to be discovered software program) to really simulate the exact brain behavior of a given human being. My guess is that the AI time machine is used to encapsulate a very sophisticated type of simulation software that caters specifically to human brains and to predict what it will sense and think in the future.

Software Programs Inside a Predicted Model

Any given predicted model in the prediction tree has a software program that the teams of virtual characters are responsible for (FIG. 27). This software program is the interface that allows other users (parent nodes or child nodes or interested nodes) to gain access to the limited information in this predicted model. Functions in the software program will help navigate the user so that information can be found quickly and accurately. This software program has to be interactive as well so that the user can input variables and a desired output will be presented.

This software program will be based on the focused objects and the peripheral objects. Let's say the focused objects are: overall fans, QB and receiver. The software program for that predicted model is only interested in presenting data on these three objects. All other objects are minor and will be ignored or mildly considered.

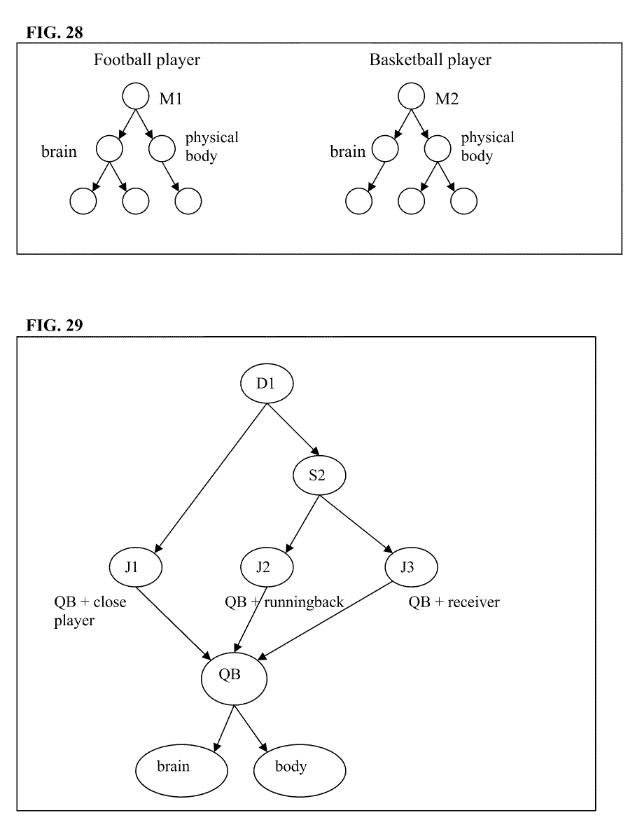

FIG. 28 is a diagram depicting two predicted models (M1 and M2). M1 is responsible for creating a software program that will take a pathway selected by the football player's brain and to insert that input into the football player's physical body. The output is the interaction between the two parts. A software program will include taking a selected pathway from a brain, extracting the instructions from the pathway, generating electrical signals to the physical body and displaying a 360 degree animation of the football player.

The software program can take in any selected pathway from memory and the physical body will behave according to the instructions written in the pathway. If pathwayB is selected, the football player will move in this manner. If pathwayT is selected, the football player will move in that manner. The software program for M1 should be interactive and the user can control what variables to input and the desired output should be accurate.

If you look at the lower levels of M1, the brain predicted model is only interested in the brain. Software program in the brain predicted model is catered to only the brain. The same thing should be said about the physical body predicted model. The virtual characters that are responsible for mapping the physical body has considered what would happen if a different brain signal was sent to the arm or the leg or the neck. Each body part is simulated in terms of how it works.

There is one software program for the brain predicted model and one software program for the physical body predicted model. The responsibility of M1 is to merge the two software programs together and to tweak their functions so that the user can access hybrid information from the two individual software programs.

M1 is also responsible for adding new functions and interfaces; and merging the two software programs. Variables or functions that can be applied to the software program can be limited or simplified by M1. The user doesn't have to insert the intelligent pathway from the brain into the software program. M1 can provide a list of ranked possible pathways that is selected by the brain. It's up to the user to use human intelligence to determine if these ranked possibilities are correct in terms of their predicted model.

M1 also has to output ranked future possibilities. These future possibilities can be in any media type M1 thinks is appropriate for its predicted model. The future possibilities can be a 3-d animation, or a short document, or a book, or a comic book or a 2-d movie, or a website, etc. The software program should give the user options to view possibilities, analyze possibilities, see properties of possibilities, manipulate possibilities and so forth.

As stated before, the ranked future possibilities and the software program is based on the focused objects and the peripheral objects for that predicted model.

Automated Function Changes for a Software Program

All software programs from multiple neighbor predicted models can form unified functions that changes variables. Referring to FIG. 28, the brain predicted model might output a new ranking of possible pathways selected. This new ranking should be automatically transmitted to the software program in M1. This in term should result in M1 automatically (or manually) changing its future possibilities.

In another example, the physical body predicted model might change its software program. The modified program includes a more detailed depiction of the football player's body. This change should not affect M1 in a major way. The functions of the physical body software program are exactly the same. The input is still a selected pathway from the brain. The only difference is that in M1, when a selected pathway is inputted into the physical body, the 3-d animation of the football player will be more accurate and detailed.

Thus, dependable functions must be created so that lower and higher level predicted models can change variables and functions in their software programs without human intervention.

It's up to the virtual characters working for a predicted model to determine if they want dependable functions in their software program or they want to manually change data (or both).

Very complex software programs that cater to something like a human brain will have many hierarchically structured dependable software programs. Each software program in the hierarchy has to be handcrafted and tested for reliability. A human brain is very complex, but if we use this type of method to simulate it, it might be possible to know how it will work in the future.

Some linear thoughts of a human being don't depend on the 5 sense data from the current environment. Thoughts in the brain are based on a cascading affect, whereby chemical electricity propagate outwards in certain areas of the brain. For example, a person might look at a bird, and a bird image pops up in his mind. Next, a memory of the person's pet bird pops up in his mind. Then, a memory of the birdcage the pet was living in popped up. These are linear thoughts of the person based on the sensed image of a bird.

Although thoughts don't activate linearly exactly every time he sees a bird, the same encounter with a bird might activate similar linear thoughts. In another case, a person might be sad and the sadness will activate the instructions: light up a cigarette. Next, the thought activates: “go outside and light up”. So, the next time that an event triggers a sad moment, the person will probably do the same linear things, which are:

light up cigarette and go outside to light up. There is no guarantee that this linear behavior will happen every time that the person gets sad, but it is one proven behavior because this person has done it repeatedly in the past.

The software program to simulate a brain has to consider these linear thoughts. Most of these linear thoughts are learned in school and others are self-learning. The human brain has to send out a series of chemical electricity throughout the brain (based on the 5 senses) in order to produce linear thoughts. The virtual characters have to consider how the activities in the brain functions as a whole. Everything from the internal organs to the stored pathways to the inputted 5 senses has to be analyzed to determine the factors that make up linear thoughts.

The virtual characters might create a simulated brain that contains general location of pathways (universal, as well as, detailed pathways). They also have the current 5 sense data ready to be inserted into the simulated brain. Upon inserting the current 5 sense data, a function will generate chemical electricity to travel on the pathways. This simulation will reveal which areas in the brain's memory will be accessed and what information was extracted.

If the physical brain structure is mapped out correctly in terms of where pathways are stored and how the organs work, the linear thoughts of the person should be revealed.

The reason why this is important is because linear thoughts contain future tasks a given human being will do in the future. If a person is determined to do something, they will make it a reality. If the football player plans to pass the ball to the runningback, that is the direction of the future gameplay. The virtual characters are responsible for predicting what other players will do as a result of the QB passing the ball to the runningback. Thus, the main factor is actually predicting the decision making process of the QB before a gameplay. Decision making can be a behavior. For example, in the past, the QB usually likes to give the ball to the runningback when he is near the end zone.

A person's behavior is based on universal pathways in memory to make decisions. Thus, the virtual characters can use observed behaviors as clues to determine the universal pathways. What about the detailed pathways? How will the virtual characters predict detailed pathways stored in the QB's brain? The answer is the signalless technology. A 3-d map of the QB's brain (general or specific) must be given to the virtual characters and they have to use logic to fill in all the missing data. For example, the signalless technology can only map out molecule-by-molecule of the QB's brain. The virtual characters will use logic to map out the atom-by-atom structure of the QB's brain. Using this atom-by-atom structure, they can translate this data and determine what are universal pathways and detailed pathways and what are the instructions in each pathway.

Example of an Interconnected Software Program for Tree Branches

Objects in predicted models have to have some way of interfacing with other objects. For intelligent objects like animals and human beings there are two factors that determine object dependability: 1. 5 sense data. 2. thoughts.

The QB sees other players, therefore the relationship is the visual image of other players the QB is seeing. Also, the QB can think of other players that it can't sense. For example, in the next gameplay, the QB has coordinated with the runningback with a nod that he will pass the ball to him. The QB, during the gameplay, is thinking about the runningback even though he doesn't see him. This common knowledge of where the running back should be from the QB's perspective is the relationship between the two players.

The software in neighbor predicted models has to have a means of establishing relationships among objects (most notably, human beings). FIG. 29 is a diagram depicting a prediction tree for one gameplay. J1 is the QB and a close player, J2 is the QB and the runningback, and J3 is the QB and the receiver. Each predicted model is only concerned with their focused objects. S2's focused objects are elements in J2 and J3. Predicted model D1's focused objects are all its lower levels (S2, J1, J2, and J3). Finally, J1-J3 are all pointing to the QB predicted model.

Each predicted model in this tree branch has their own software program. These software programs have to be interconnected so that if one software program from a predicted model changes, the other software programs from neighbor predicted models will also change.

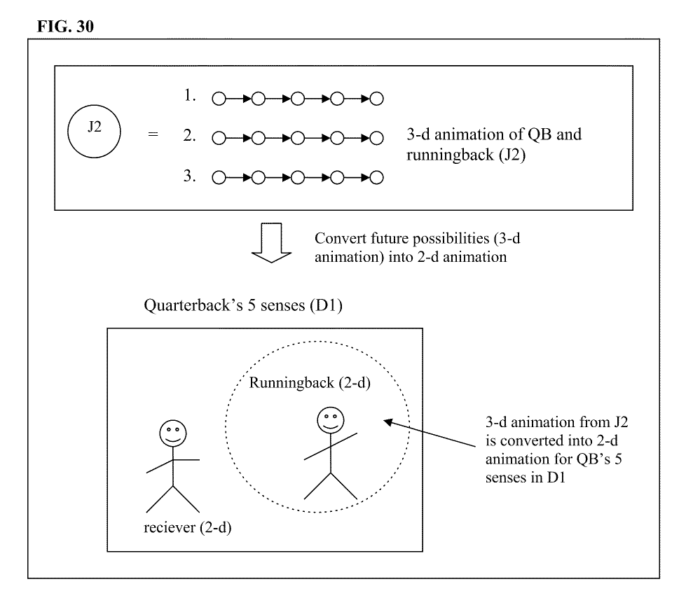

FIG. 30 is a diagram depicting relationship functions between different software programs. The output of the future possibilities of J2 are 3-d animation of the quarterback and the runningback. The 3-d animation shows the possible physical interactions of the QB and the runningback. This 3-d animation is ranked in terms of what will probably happen in the future. In D1, the QB's 5 senses will have relational links with the 3-d animations. An image processor is needed to convert the 3-d animations into 2-d animations based on the QB's perspective. Let's say that the 3-d animations outputted by J2 are modified. This means that the data in D1 will automatically be modified as well. The modified 3-d animations will be converted to new 2-d animations. The old 2-d animations from D1 will be deleted and replaced with the new 2-d animations. This means the 2-d animation of the runningback will be changed in the QB's 5 senses in predicted model D1.

Predicted model D1 has automated software that basically takes in the modified 5 sense data of the QB; and functions in the software will output an accurate pathway selection from the QB's brain. These selected pathways is one output from D1.

If the lower level predicted models like J2 is changed, the QB's 5 senses in D1 also changes. The software program in D1 will also automatically change its output.

D1 can have automated QB's 5 sense data changed based on all its lower levels. J1-J3 can be changed and the QB's 5 senses in D1 will also be changed. For example, if J3 changes, the receiver animation of the QB's 5 senses from D1 will be changed. If J2 changes, the runningback animation of the QB's 5 senses from D1 will be changed. If J1 changes, the close player's animation of the QB's 5 senses from D1 will also be changed.

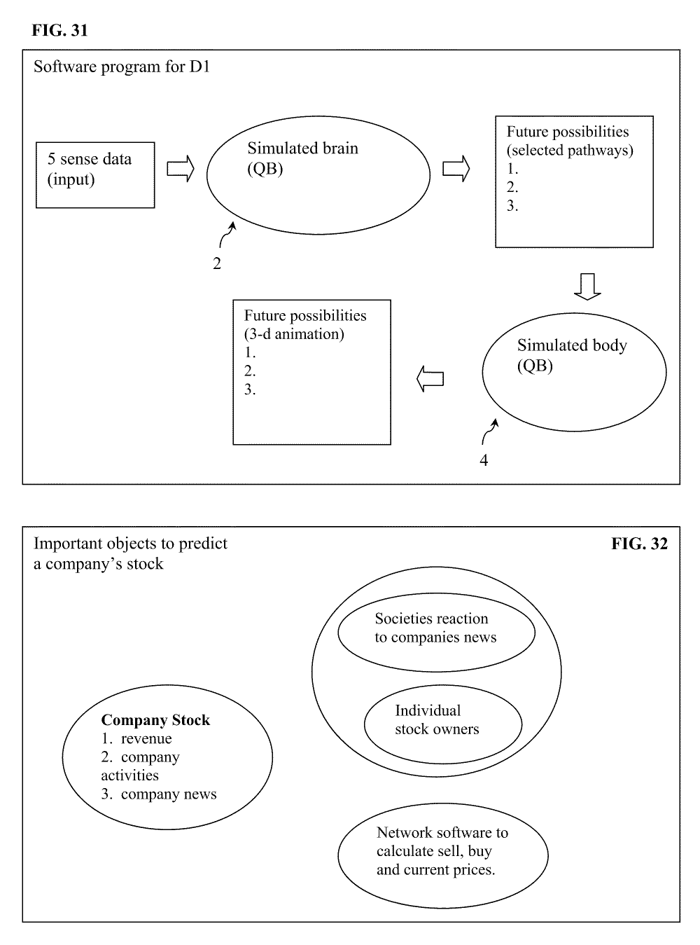

FIG. 31 is a diagram depicting the software program in D1 that will take in the QB's 5 senses and the simulated brain (pointer 2) will output a selected pathway. As the QB's 5 senses are changed the simulated brain (pointer 2) will output a different selected pathway. This selected pathway will be fed into a simulated body (pointer 4) of the QB and the result is the 3-d animation of the QB.

This just shows that there is an automated system, whereby neighbor predicted models can change their outputs or software program and other predicted models will adapt their outputs and software program. This automated system should be considered in conjunction with manual manipulation of outputs in software programs. For example, the automated system might produce wrong results. The virtual characters recognize this and manually change their outputs and modify their software so that it never happens in the future.

The reason that the lower level predicted models change their prediction is because each team did further investigation and found better predictions. For example, in J3, the virtual characters found out that the receiver will run to the right and not the left like they previously predicted.

Prediction Examples

The universal prediction algorithm is a computer program that can predict any event or solve any problem regardless of how complex it may be. FIG. 4 is a diagram of one pathway in the AI time machine. In order to create the universal prediction algorithm, many prediction problems have to be trained. These prediction problems include: predicting a football game, predicting one entire NFL season, predicting all stock prices for the Dow/Nasdaq for the next 10 years, predicting the weather on Earth for the next 10 years, predicting future events, predicting the existence of future human beings, predicting earthquakes for the next 10 years and so forth. Pathways can also be trained to predict the past. These prediction problems include: solving one cold case, solving all cold cases in the United States, predicting past events, predicting distant past events, determining the authentication of one religion, determining the authentication of all religions, predicting the weather 20,000 years ago, creating a universal family tree for all life on Earth, and so forth.

When and if the AI time machine is trained adequately and it is able to predict most events in the past and future, we can safely say that the AI time machine is the universal prediction algorithm. Every prediction made by the universal prediction algorithm (UPA) will be accomplished in the fastest time possible. The UPA will also predict events in a hierarchical manner. This means that the predictions go from general to specific. The more time that passes the more accurate the predictions will be. It will reach a point where each past/future event is predicted 100 percent accurately.

The main reason I call this technology: universal prediction algorithm is because it can predict any event for the past or future, regardless of how complex it may be. Current prediction algorithms are fixed and each event to predict uses a different algorithm. There exist an algorithm to determine which banks are at risk of being robbed, there exist an algorithm to determine weather patterns, there exist an algorithm to predict football games, there exist an algorithm to predict suspects in a crime, there exist an algorithm to predict the migration patterns of flocks, and so forth. Thus, there are fixed algorithms for every situation.

Another disadvantage is that these fixed algorithms have a fixed output and the output is a possibility of a prediction. For example, an algorithm to predict the results of a football game can only give an estimate prediction; it can never give an exact prediction (100 percent accurate). Since the algorithm is fixed it will always give an approximate prediction.

My universal prediction algorithm uses a “universal” algorithm that morphs and changes to make the prediction more accurate as time passes. It will reach a point where the prediction will be 100 percent accurate. As time passes, more data is inputted into the prediction internet concerning a prediction. For example, if the task of the UPA is to solve a cold case that happened in 1946, the UPA will continue to accumulate knowledge about the cold case as time passes. The computer program will not stop until the cold case is solved. The output from the UPA is a report that describes the criminal, all the evidence that points to him/her, and an exact frame-by-frame video of what happened during the crime.

The UPA can be used to solve all cold cases. This means that the UPA will not stop until all cold cases in the FBI files are solved. The universal prediction algorithm will accomplish this task in the fastest; and most efficient way possible. In other words, minimal work is needed to accomplish this task.

By the way, solving all cold cases is a part of an on-going effort to predict all events in the past and future of planet Earth.

An initial prediction tree is created for a given prediction problem. Think of the software program in each predicted model as an algorithm. For each predicted model, teams of virtual characters are required to modify the algorithm's inputs and outputs. If you observe the entire prediction tree, the “universal prediction algorithm” represents the interconnected software programs between all hierarchically structured predicted models.

Predicting Stock Prices for the Dow and Nasdaq for the Next 10 Years

I believe that predicting the stock market is the most difficult problem the universal prediction algorithm will do. If we analyze all the objects (large or small) involved in the daily activities of the stock market, you will be overwhelmed. FIG. 32 is a diagram depicting the most important objects involved in one stock company. The revenue of the company is one of the most important aspects that determine its stock price, so the revenue of the company has top priority. The news announcements from the company are also an important aspect.

Other objects involved in the company's stock price include individual investors, societies reaction to the companies news, and the network that allows users to buy or sell stocks. All these individual objects (or aspects) are considered in order to predict the future prices of the stock for the next 10 years.

As usual, human beings create future events, so they are considered important objects. The stock company has many employees, executives and partners. These human beings involved will be prioritized and they will be predicted based on their importance.

All activities of the company like meetings, news announcements, imagination, business interruptions, business deals and partnerships, production, sales, product manufacturing and so forth has to be predicted hierarchically. Every activity has to be predicted as a group and not as individuals.

Another important object is stock owners. All stock owners and potential stock owners have to be predicted. If you break down an individual stock owner into elements, you will get: 1. the user. 2. a computer. The stock owner is a user that is controlling a computer to buy and sell stocks. Within the user, important objects will include: 1. brain. 2. physical body. The user's brain is very important because it determines if this person will sell stocks or buy stocks. By analyzing his brain, we can understand the rational of what triggers a stock activity.

Predicting individual users controlling a computer has been described in my previous books, so I won't go into the details of how this prediction method works.

All company stock owners and potential company stock owners have to be analyzed and predicted. Each stock owner has to be predicted along with other important objects such as the company's announcements, company's revenues, and society's reactions to the company.

The prediction tree will be extremely long for this type of prediction. Zillions and zillions of virtual characters have to be assigned to certain predicted models and all teams have to work together on the prediction internet to predict the stock prices for this one company for the next 10 years.

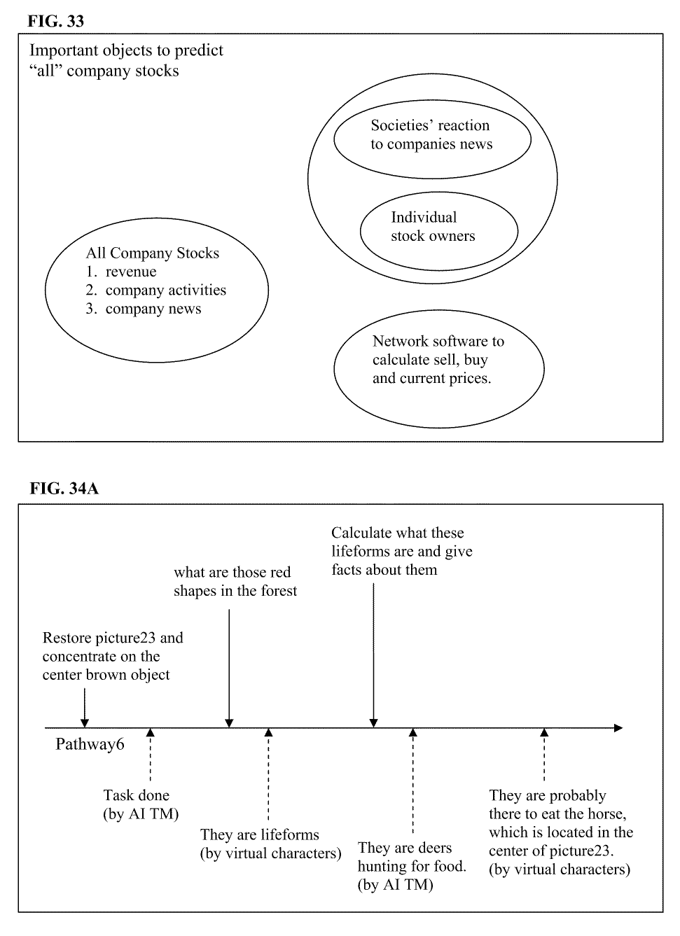

On the other hand, the above example only deals with one company stock, the Dow and Nasdaq has thousands of stocks to choose from. In order to predict the entire stock market, all company stocks are ranked hierarchically and they are predicted by teams of virtual characters based on how important they are. For example, Wal-mart is a stock that lots of people own, so it's considered a very important object. Bank of Hawaii is a stock that only a few people own, so it's considered a very minor object (FIG. 33).

The network software in the stock exchange to calculate trading prices has to be predicted as well. In early 2010, the stock market encountered a computer glitch or software flaw that caused a world wide panic. The Dow Jones dropped 1000 points in less than 10 minutes. Within the 10 minutes stock owners tried to sell their stocks. These stock owners didn't realize that the Dow Jones dropped so quickly not because people were selling stocks, but because the network software encountered a rare glitch. Because of the network software, stock prices changed in dramatic ways. This is one reason why the network that calculates stock prices must be predicted in conjunction with other prediction objects.

Predicting individual computers and network software has been described in previous books so I won't be going into the details of how they work.

Individual stocks are not isolated from other stocks. In fact, prices of one stock are directly dependent upon its sector and industry. Even the price of the Dow Jones affect all stock listings, including the stock listings in the Nasdaq. When Intel reported its earnings several months ago, it dropped 10 percent in one day. This report also affected its sector (chip company) and its industry (computer). Thus, it is important to do predictions in a hierarchical-uniform manner.

In some ways, in order to get a perfect prediction of the stock market, every object on Earth, ranging from a human being to an individual atom, must be predicted uniformly. Future events are interconnected in a web. This makes future prediction a very difficult task. The prediction tree exists so that predictions are done based on hierarchical priority. Past events are also locked in an interconnected web and predicting events in the past is very easy.

Extremely complex prediction tasks like predicting the stock market require that the initial prediction tree outlines several individual parts. The initial prediction tree might have general predicted models that link the three individual parts, but not detailed predicted models. While the virtual characters are working on each part, their parent predicted models are created during runtime. These added parent predicted models are dependant on the work results from the virtual characters.

Predicting an Entire NFL Football Season

There exists fixed algorithms that can predict who will win the Superbowl. These are fixed algorithms and they can only predict an estimation of who might win. They can never predict exactly which team will win the Superbowl or the details of each tournament game.

The universal prediction algorithm is different because the output from the prediction isn't fixed. The UPA will continue to output better and better predictions as time passes. The more time given to the UPA, the more accurate the prediction becomes.

Hypothetically, let's say that the virtual characters have to predict the entire NFL season “before” any games are played. The virtual characters are given a lineup of dates on the initial tournament games. Based on this single fact sheet, the virtual characters have to predict how the tournament games will play out. They also have to predict the Superbowl and what the outcome of that game will be.

The first thing the virtual characters will do is gather as much information about what they are assigned to predict. If a team of virtual characters are responsible for predicting the Cowboy vs Steeler's game, then the virtual characters has to gather as much information about recent player information on these two teams. Information that is extracted from individual players will include: player stamina, weakness, strength, performance and statistics.

Every prediction they make will be based on assumption and most likely these predictions can only serve as general predictions. For example, they will compare teams and guess who is stronger. If there is one strong team in the league and they repeatedly show that they are undefeated, and there is another team that is weak, then the VCs can conclude without a doubt that the strong team will win. We see this behavior over and over again in sport games. The USA basketball team always wins the Olympic basketball game because they have proven their abilities. Football teams are no different.

One factor these virtual characters will look at will be star players in each team. If there are two teams that are equal in performance, but team1 is missing a star player, then most people will assume that team2 will win. Another method to compare team strength is by looking at how star players work in a group.

Another method they might use for their predictions is to simulate each players' physical body. These virtual characters have to predict every gameplay incrementally for each game. They have to try to predict what each player will sense, think and act during each gameplay. All these predictions are assumptions and are most likely useless information (in other words, these predictions will never be 100 percent accurate).

The above method works to give an estimated prediction of the Superbowl. To get a perfect prediction will require every object on planet Earth (large or small) to be predicted hierarchically and uniformly. The virtual characters have to know current information. They have to predict the game at the start of the game and not before the game. This way, they know which players are present and which players are missing. Also, they need to know the physical atoms of each player, currently, in order to predict that players' future. A small injury to a player has profound effects in his performance during a game.

Thus, the conclusion is that if the universal prediction algorithm wants to predict a perfect future timeline of an NFL season, it has to predict all objects on planet Earth. Of course, the most important objects that relate to football are predicted first before predictions are made on non-related objects. For example, each player in the NFL will have his future timeline predicted every fraction of a nanosecond, in terms of what they are sensing from the environment, thoughts, and physical actions. Any object they encounter in terms of 5 senses or thoughts must also be predicted. For example, if a player goes to a restaurant, all objects related to the restaurant will be predicted, including: the people there, the food, the cooks, the hostess, and the furniture. If a player is talking on a cellphone with another person half way around the world, the virtual characters have to predict this person as well.

These minor events are important to predicting the Superbowl because they affect the players. A star quarterback might go to a restaurant one day and he trips on the stairs and breaks his leg. This injury will prevent him from playing in tomorrow's game. Thus, there are no short cuts in predicting the future. All dependant future events must be predicted in a hierarchical and uniform manner.

Sequential Tasks for the AI Time Machine (in Training Mode)

In the football example, the user types out one task into the AI time machine and the AI time machine will output one desired output. When dealing with a sequence of tasks, the AI time machine has to remember past events, manage tasks from the user, determine if tasks should be executed and so forth. Essentially, the AI time machine is trying to manage multiple tasks for the user (like an operating system).

FIG. 4 is a diagram depicting a pathway from the AI time machine. The robot pathway represents the user and the virtual characters represent the work done to generate desired outputs. A dynamic robot is a robot that has a built in virtual world. He is called the robot in the virtual world and he is called a virtual character in the time machine world. The robot in the virtual world is one entity and he has goals and rules. On the other hand, the virtual character/s is also another entity, but has the same goals and rules as the robot in the virtual world.

The robot in the virtual world will assign the fixed interface functions and the linear inputs (he is pretending to be a user). The captain virtual character's job is to analyze the user's inputs, to manage multiple tasks and to execute tasks. The captain executes tasks based on using external technologies (like the AI time machine) or to give tasks to lower level workers.

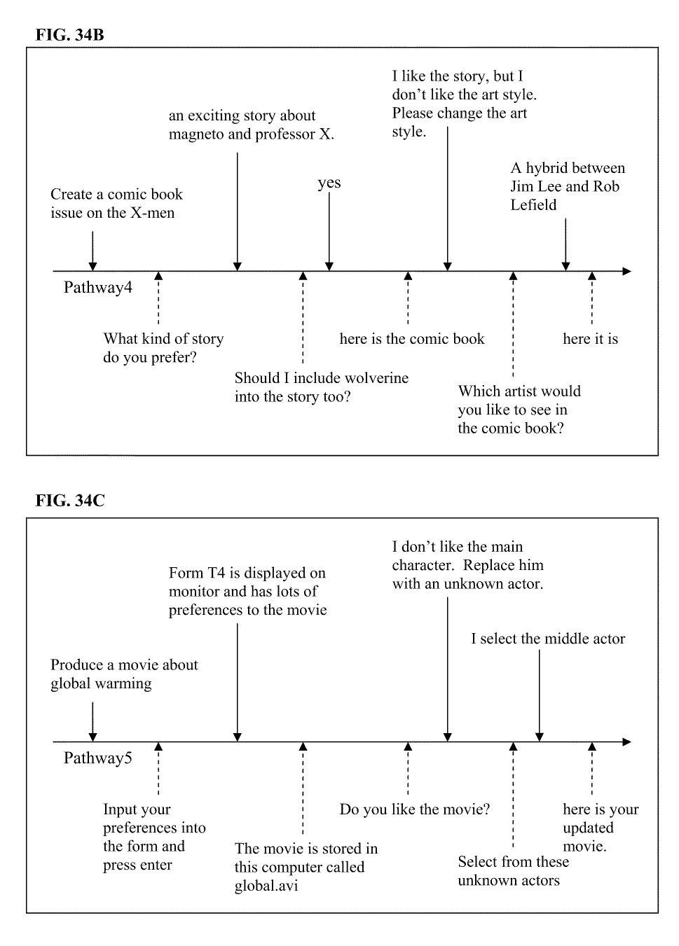

FIGS. 34A-34C are diagrams depicting sequential inputs/desired outputs from the AI time machine. These diagrams were taken from my 2008 book, called: AI time machine: book12.

The top level are inputs from a user and the bottom level are desired outputs from teams of virtual characters. In the bottom level, the captain is the leader of the team of virtual characters and he is the operator. When the first task is given “restore picture23 and concentrate on the center brown object”, the captain will use the AI time machine to accomplish this task. In the second task, “what are those red shapes in the forest”, the captain doesn't have any investigative tools to accomplish this task so he orders a specialists in analyzing images to do the task. The image specialist can output an explanation to the user. Next, the user gives a third task, “calculate what these lifeforms are and give facts about them”, this task will be directed to the specialists and the specialists is using the AI time machine to process the task. The AI time machine might output a short summary of the lifeforms. The specialist will read the summary and output 2 sentences to the user, explaining what the lifeforms are and facts about the lifeform.

This example shows that a captain is managing the tasks given by the user. He can either use technology (like the AI time machine) to process the tasks or to give it to lower level workers to do the work. If the task is simple, the captain might do the task manually.

The captain is responsible for directing certain tasks to experts in accomplishing these tasks. For example, if the user's inputs are questions about medical information on the brain, the captain has to reroute these tasks to a doctor. This doctor isn't just any doctor, he has to be a neurologist who is an expert in understanding how the brain works. Most of the time, the captain will manage basic tasks, such as opening emails, calling family members to send them a message, opening up digital files and modifying them, doing simple search over the internet, searching for definitions to words, summarizing a book, analyzing and explaining a digital file and so forth.

Specialized dynamic robots can be used to train the AI time machine in certain fields. For example, the dynamic robot is a medical doctor and he is training the AI time machine to answer questions from a user about general information on medicine. Dynamic robots specialized in neurology can train the AI time machine to answer sequential questions about how the brain works. Dynamic robots who are computer scientists can be used to train the AI time machine to do tasks requiring the writing of software programs. The user might ask the AI time machine to write a database system.

FIGS. 34B and 34C are additional examples of the inputs/outputs communications between the robot in the virtual world (the user) and the teams of virtual characters in the time machine world (workers).

In FIG. 34B, the user wants the AI time machine to write a comic book and in FIG. 34C, the user wants the AI time machine to make a movie. The teams of virtual characters to accomplish these complex tasks require experts. If you ask a doctor to make a movie, he/she won't be able to accomplish the task. Thus, the teams of virtual characters are experts in their fields and they will be trained based on their specialized tasks.

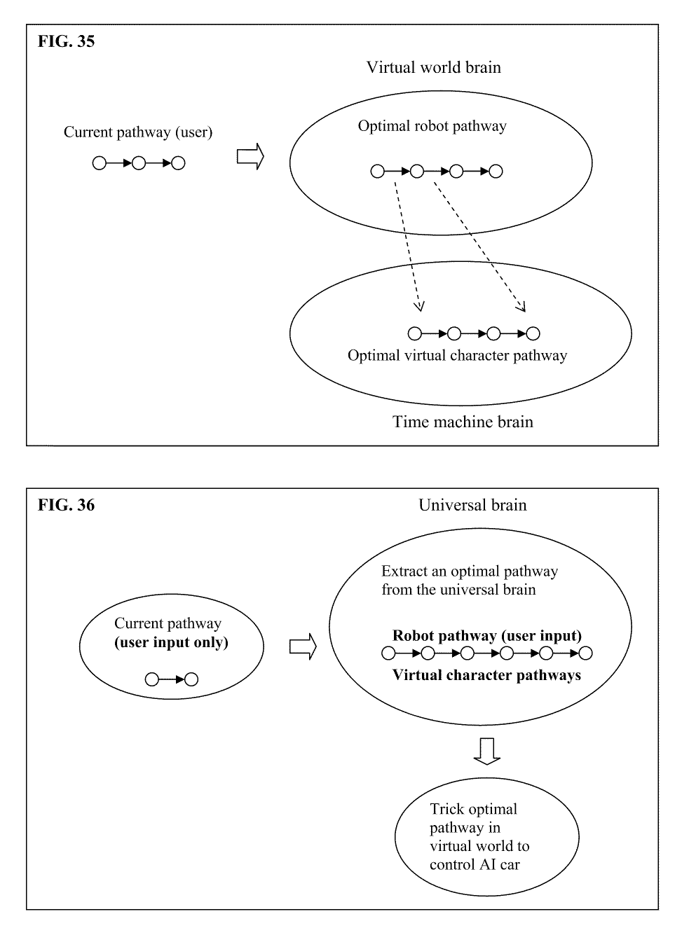

Referring to FIG. 35, the universal brain stores pathways from multiple dynamic robots. A dynamic robot has two types of pathways (virtual world pathway and time machine world pathway). The AI time machine will usually extract pathways from the universal brain based on the interface communication between the user (the robot) and the virtual characters. In other words, the input and the desired outputs between the robot's pathway and the virtual character pathways is the primary objects that will determine what pathways the AI time machine will extract from the universal brain.

The way the AI time machine extracts pathways from the universal brain is very similar to how a human robot extracts pathways from its brain. If the user asks a question about Hamlet, the AI time machine finds the best match to the current pathway in the universal brain. The important objects in the current pathway are the inputs from the user. The best pathway match will contain the optimal way the question is answered.

In terms of accomplishing tasks, the AI time machine extracts pathways from the universal brain that matches to the user's task input. The best pathway match will contain the virtual character pathways to accomplish the user's task in an optimal way.

The data in the current pathway can be arbitrary. The current pathway can be a fabricated pathway based on what a user is sensing and thinking from the environment. For example, the current pathway can be the linear thoughts of the user and the 5 senses of the user interacting with a computer (the computer is the AI time machine). Things that the user sees on the computer screen are part of the visual data of the current pathway.

The current pathway can be a camera that is observing a user in terms of what he is doing on the computer. The AI of the camera is predicting what the user is thinking and doing on the computer. The AI will try to predict where the user is focusing on on the computer system. The data on the computer in terms of user activities can also be part of the current pathway, such as mouse movements or keyboard presses.

The current pathway should be the thoughts and the 5 senses of the user; and the activities of the computer the user is controlling.

Regardless of what data types are contained in the current pathway, the AI time machine will match this information to the robot pathways in the virtual world brain. The important objects in the current pathway are usually the user's inputs into the computer. The best robot pathway match will be associated with virtual character pathways. The work done by the virtual character pathways will represent the AI of the AI time machine.

The extraction of pathways from the universal brain is based on dependability. If a captain has 4 lower level workers and it takes all these workers to accomplish task2, then when the user inputs task2 into the AI time machine, the captain's pathways regarding task2 will be extracted. The captain's pathways for task2 will also extract the 4 lower level workers' pathways regarding their jobs of accomplishing task2. (Note: each virtual character in a hierarchical team can use the AI time machine. This means that work from different virtual characters or teams can be encapsulated.)

The pathways in the universal brain will self-organize with similar pathways (very similar to how human robots work). These pathways will form universal pathways that will be able to manage, process, and execute any input task from a user. It doesn't matter what the user says or does or orders, the AI of the AI time machine is able to respond with desired outputs under any circumstances.

The Captain Analyzes the User's Activities

The captain has human intelligence and knows what the user's goals are for each task. For example, if the input task is “open the lion image”, the captain knows that the lion image was opened 2 hours ago and he can recall what image the user is referring to. The captain uses human intelligence to spot out what the real intentions of the user are. If the user types out an ambiguous task, such as: “drawing image bird colored children pictures”, the captain can analyze this input and determine that the user wants to search for colored drawings of birds made by children. In other cases, the input task might be misspelled and the captain has to use human intelligence to correct the misspelling. Thus, the captain is responsible for analyzing input tasks from the user and to derive meaning from them.

In other cases, the inputs from the user are not enough to understand the user's goals. For example, if the input task is “look for images over the internet related to arrows”, the captain won't know specifically what kind of arrows to look for or what type of media the arrow images should be in. The captain can observe past videos of the user on the computer. The captain finds out that the user was reading the rules to making patent drawings. This revelation tells the captain that the user is searching for black and white images of an arrow. Patent rules are followed so that the captain will find the best black and white images of arrows over the internet.

This example shows that the captain can spy on the user to understand the user's goals and rules when inputting tasks into the AI time machine. These spying techniques include observing camera videos of the user before the task was given or analyzing and processing background information about the user.

However, most tasks done by the AI time machine are based on the captain analyzing sequential input tasks from the user.

Review:

Only dynamic robots are able to train the AI time machine (human beings or expert software programs can't train the AI time machine). The dynamic robot comprises a robot in the virtual world and a virtual character/s in the time machine world. The robot in the virtual world has to act as the user, inputting tasks and critiquing about the desired outputs. On the other hand, the virtual characters in the time machine world have to accomplish user tasks by either using external technology (like the AI time machine) or manually accomplish user tasks in a team like environment.

The dynamic robots have to train the AI time machine with individual tasks first. Then it has to train the AI time machine to manage multiple tasks by having a captain (a virtual character) manage, process and execute tasks.

Universal Artificial Intelligence for Machines

The first invention I designed back in 1999 was the universal artificial intelligence program. This is a software that can basically play any videogame. One day in 1999 I was playing Mortal Kombat and I got very bored playing with the computer. I decided to write a software that can play Mortal Kombat. As I played other games, I was wondering if it was possible to write a universal AI software that can play any videogame.

I think I proposed many different universal artificial intelligent programs from 2006 to 2008. In this chapter we will review on some of these UAI programs.

A universal artificial intelligence program can control a car, a plane, a forklift, a boat, a train, a motorcycle, an air control tower, and so forth. The artificial intelligence can be used on any machine to do any human task. In other words, the artificial intelligence is universal.

One proposed idea was converting a machines' sensed data from the environment into a videogame and having a robot play the game to control the machine. I proposed a virtual world where the robot (a virtual character) is controlling a videogame to control a physical machine. The virtual world changes when using different physical machines.

Another idea was to build a dummy physical robot that has “limited” pathways to drive a car or fly an airplane or control any machine. The robot can download pathways for a specific type of machine. This idea is very useful because the robot can control any physical machine, even cars and planes that were built in the 1920's. Instead of buying an AI car or AI plane or AI truck, the physical robot can simply get into a car, operate it, get out of the car, get into a plane, operate it and get out of the plane. These dummy robots work very well in sewing factories. They can mass produce clothing by using many different sewing machines. They can work in a team like organization to accomplish sewing tasks. For example, a group of dummy robots can cut out the fabrics and give the fabrics to another group of dummy robots, which are responsible for sewing the parts together. Finally, another group of dummy robots will add the finishing touches to the clothing such as nailing buttons, cutting excess strings, ironing the clothing and packaging the clothing to be shipped to department stores.

Controlling a Car

The idea for an autonomous car is for a car to drive on its own based on minimal user input. The user might give voice commands like: drive home, drive to the nearest library, drive to the beach, and so forth. The AI car must obey the user's commands and to safely accomplish these commands.

The user can also input commands to the AI car through an onboard computer. He might have to fill in a form and press a submit button. The AI car will process the command after the user submits the command form.

This AI car is supposed to act as an intelligent entity that can not only follow simple commands, but to give opinions, alert the user to danger, diagnose the hardware and software of the car, and so forth.

The Data Structure of the AI Car

Teams of virtual characters will be controlling the AI car. Each virtual character is intelligent at a human level and they can think and act like a human being. Training has to be done first before the AI car can drive autonomously.

The AI time machine is used to encapsulate all the work done by teams of virtual characters. In training mode, the AI car will record both the work done by the robot pathways (the user) in the virtual world and the virtual character/s pathways in the time machine world. These pathways will be stored in the universal brain. In standard mode, the AI car can be fully automated by extracting pathways from the universal brain and tricking these pathways in a virtual world to make the virtual characters do work (FIG. 36).

In this case, the AI time machine serves as a central brain for a physical machine or an army of machines. The universal brain comprises two other brains: 1. virtual world brain, which stores robot pathways (the user). 2. time machine world brain, which stores virtual character pathways (the workers).

The first step is to input the current pathway into the AI car. Sensed data from the AI car like vision and sound will be part of the current pathway. Another part of the current pathway is the activities of the user in the AI car. Things like voice commands from the user or software commands are stored in the current pathway. Another type of data stored in the current pathway is the various electronic devices in the car such as internet access, videogame, TV, air conditioner, phone calls and so forth. For example, a user might call a friend to tell them that he will be late for a party, the AI car will record this information in the current pathway.

The current pathway is a snapshot of what is happening in and around the AI car. A pathway must be extracted in the universal brain that best matches to the current pathway, which is called the optimal pathway (note: the optimal pathway also factors in future predictions).

The current pathway will be matched to a robot pathway in the virtual world. The best match, called the optimal pathway, will be extracted. The optimal pathway will extract its dependable virtual character pathways in the time machine world. These virtual character pathways contain the instructions to operate the AI car. The AI car will trick the virtual character pathways, called a station pathway, in a virtual world to do work. The work is used to control the AI car in an intelligent manner.

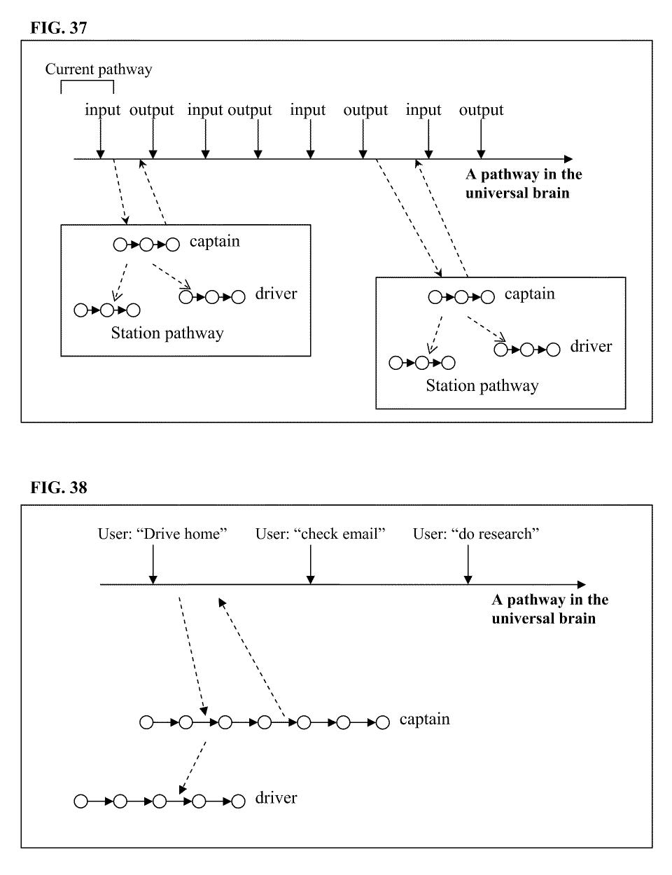

FIG. 37 is a diagram depicting a pathway from the universal brain. This pathway stores a team of virtual characters working together to control the AI car. The inputs are the information from the AI car's senses and the user's input (robot pathways). The outputs are accomplished work done by the team of virtual characters (virtual character pathways).

This pathway depicts the AI car's activities over a long period of time. The user inputs commands and the virtual characters give outputs (notice that the current pathway is just a small sequence in the linear inputs and outputs). The current pathway will move incrementally in the pathway as time passes. The pathway shows the linear tasks that the team of virtual characters has to accomplish based on the linear inputs from the user. For example, below is a list of linear inputs the user gave to the AI car.

1. drive home
2. I want to see my email
3. search for the cheapest TV in this area
4. I change my mind, drive to Pizza but instead
5. its getting hot in here, turn on the AC
6. how much longer before we get to Pizza but
7. that's too long, drive me to the closest fast food restaurant

These commands are the inputs of the AI car. The outputs are the work done by the virtual characters. Not only does the AI car have to drive around, but it has to do tasks given by the user such as checking email, turning on the AC, answering questions from the user, solving interruptions, doing research over the internet and so forth.

Referring to FIG. 38, a team of virtual characters is called a station pathway. There is a captain, who is in charge of decision making and there is a driver, who is in charge of driving. An AI car is a simple example and it doesn't really need two virtual characters to operate. In the next example, we will discuss why it's important that a team of virtual characters work together to control a complex machine.

Each virtual character has human level intelligence and is using technology to do their work efficiently. The virtual characters will most likely be using the AI time machine to do work. Other software programs can be used such as the windows operating system, a web browser, search engines, or a software calculator or any apps on an iphone.

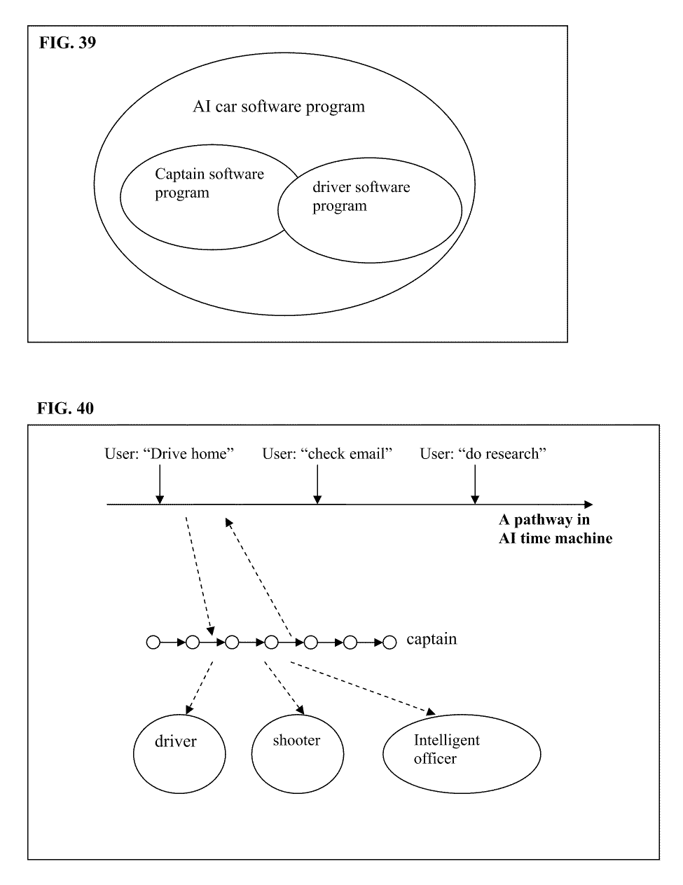

Referring to FIG. 39, the car software is a software program specifically handcrafted to help the captain do his job. It's functions are actually adaptable (I will explain this later). As far as working in a team, each member will have a handcrafted software program designed for their roles. The captain will have a software program to manage multiple tasks and make decisions, the driver will have another software program to drive the car, the intelligence officer will have another software program to gather useful information. The team software will have interface functions so that one member can communicate with another member.

Each virtual characters' roles, rules, status, powers, limitations and objectives are based on common knowledge found in books, reports, college courses and so forth. Every member of a business knows what their roles are because of knowledge learned in business school. These virtual characters have gone to college, studying in specialized fields. The captain was trained to solve problems, follow commands, solve interruptions, manage multiple tasks, make decisions and so forth.

FIG. 40 is a diagram depicting one station pathway to do multiple tasks from the user. The input from the user is to drive home. The captain will identify the user and do research, such as find out where the user lives. Next, the captain will use GPS software and plot out a route from the current location of the AI car to the user's home. Finally, the captain will send this information to the driver and he will navigate the car either manually or using automated software.

The next input from the user is to check for emails. The captain will open up an internet browser, login to the user's email account, and send the new emails to the user. The next couple of inputs from the user are to do research over the internet.

Tasks that are done over and over again can be assigned to fixed software functions in the AI time machine, either manually by a virtual character or automatically. The AI car might detect that an input from the user like “drive home” can be assigned to virtual character pathways like E1 and “check for emails” can be assigned to virtual character pathways like E2. These two newly created fixed interface functions will be assigned to the car software for the captain to use in the future. Work that has already been done numerous times can be saved in the AI time machine as accessible interface functions for virtual characters. For example, Let's say that the AI time machine has a function to read a website and to summarize the content to the virtual character. If the user in the AI car inputs the command: “I want you to read this website and summarize its content”, the captain can use the AI time machine to accomplish the task, instead of doing the task manually. The captain will take the output from the AI time machine and give this information to the user.

In an autonomous car, the user simply has to tell the AI car where to go and what to do and the AI car simply extracts pathways from the AI universal brain to do work. No real virtual characters are needed, during runtime, to do the driving.

Controlling an Armored Car

A more complex AI machine is an armored car designed to do battle. FIG. 40 is a diagram depicting 4 virtual characters working together to do battle. The goals of the AI armored car are based on the constant goals of the captain. One of its goals is to constantly monitor the current surroundings to look for dangers. If danger is identified, the team of virtual characters will work together to get the occupants in the AI armored car to safety. Another goal of the captain might be to follow orders given by the user.

These orders might include driving supplies to a destination where there is a war zone going on, driving safely from one destination to the next, doing battle in a blockade, attacking enemy fortresses, and so forth. The more tasks that are trained by teams of virtual characters the more capabilities the AI armored car will have.

Orders that are given by the user which includes battle commands must be cleared by superior officers. This is standard procedure when it comes to battle commands. The captain will analyze the user and determine what the user's rank is and see if he has the authority to do battle based on rules set by the army. For example, if the user is a soldier and he wants to attack a small fortress, the captain will know (based on common knowledge) that he doesn't have the authority. However, if the user is a lieutenant and he wants to attack a small fortress, the captain will follow his command. The captain knows what is allowed and what isn't allowed by the user. He also knows the hierarchical rankings of users and their limitations. The captain is using common knowledge learned in military school to determine hierarchical rank and limitations.

Referring to FIG. 40, the captain is the person responsible for decision making for the AI armored car. The driver is responsible for driving the car based on the destination given by the captain. The captain is responsible for changing destinations. The shooter is responsible for shooting enemies and to protect the occupants in the AI armored car. Finally, the intelligence officer is responsible for gathering information from the internet and sensing devices to help the team do its job.

Let's use an example of how the AI armored car works. The user gives a command to the AI armored car to go to a certain city. The team of virtual characters will do as commanded. The captain will plot out the course using a GPS device. He will send the destination information to the driver, which drives the car. Upon reaching the city, the AI armored car is ambushed and there is a blockade in front of their path. The captain will tell the user and the occupants that the AI armored car is now taking control of the situation. This basically means the team of virtual characters will not process any commands given by the user.

The team's goal is to work together to get safely out of the area. The intelligence officer will monitor streaming data from satellites to find out about its surroundings. The intelligence officer might spot two enemies behind the car and tell the shooter this information. The shooter will either take out the enemies or wait for identification before shooting. Under the rules, the shooter doesn't need permission from a captain to fire if he thinks the armored car is in danger.

The communication between team members is by voice. Some information can be conveyed electronically, but the majority between the team members is by voices.

The captain will ask the intelligence officer to find a safe route to go to with minimal resistance. The intelligence officer will use sensing data, satellite data and any electronic data to find the safest route. The intelligent officer will give this information to the driver and he will drive the AI armored car there.

The captain will get constant updates from all team members and he has to make decisions that will benefit the team.

The autonomous armored car will work by extracting station pathways from the universal brain. Station pathways are teams of interconnected virtual character pathways. Each virtual character pathway in the station pathway are tricked in a virtual world to make each pathway think that they are doing work. Thus, no real virtual characters are needed, during runtime, to operate the AI armored car.

Future Prediction for the AI Armored Car

If the AI armored car is ambushed, the AI will predict the future in what will probably happen. These future predictions include the actions of the AI armored car, as well as, the activities of the enemy. Thousands of alternative cases will be predicted and the AI armored car will select the best future pathway that benefits itself.

Thus, the station pathways or groups of virtual character pathways are not acting based on the best current environment, but based on the current environment, as well as, the best future prediction.

In order to do this, everything I talked about in this patent application must be used. The signalless technology maps out the current environment atom-by-atom. It identifies all enemies and objects in its surroundings. Another team of virtual characters, besides the team of virtual characters controlling the AI armored car, has to predict the future actions of each enemy and what they will do in the future.

Each future prediction will use a different virtual world. The team will extract virtual character pathways from the AI time machine and trick them in these alternative virtual worlds. The virtual character pathways in a virtual world (a future prediction) with the best results will be the virtual character pathways selected to control the AI armored car to act in the future.

Time Dilation Between Levels of Virtual Characters

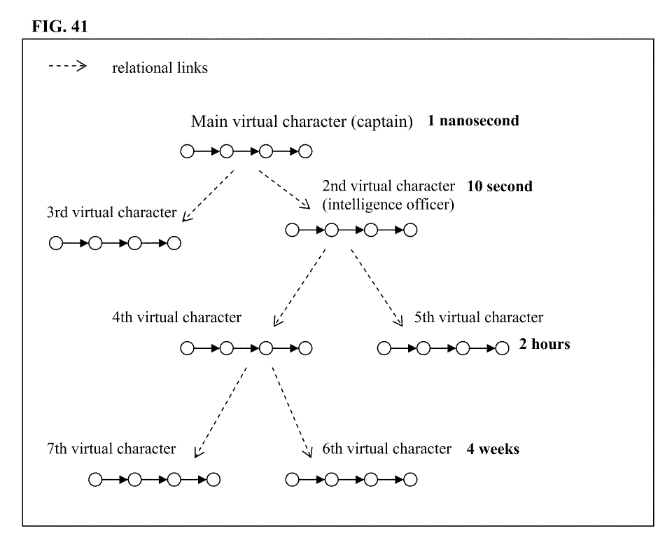

FIG. 41 is a diagram depicting time dilation between levels of virtual characters. 1 nanosecond of the captain is 10 seconds for the intelligence officer. 1 nanosecond is equivalent to 4 weeks for the 6^{th} virtual character. The times for each virtual character are different because some jobs have to be done quickly. The intelligence officer has to do his job really fast so that the captain will get results quickly. Maybe the intelligence officer has several lower level virtual characters working for him. These virtual characters can also have same or different time speeds.

A more efficient system is to have an adaptable time dilation between virtual characters. Maybe the speed of the captain can speed up if his input is needed for the intelligence officer to do his work.

A more complex machine is an entire starship. In Star Wars, they have these large imperial starships that have thousands of workers. These workers include: captains, shooters, intelligence officers, engineers, pilots, lieutenants, maintenance workers and so forth. In order to build an autonomous starship, teams of virtual characters are structured hierarchically to give commands. A series of captains might be responsible for the actions of the starship. Each worker is responsible for following orders from their hierarchical chain of command. For example, the shooter follows orders from a first officer, the first officer follows orders from a lieutenant and the lieutenant follows orders from the captains.

In order for the starship to be autonomous, a user is commanding the starship. He will input commands into the AI starship and the captains have to manage and accomplish each command based on military rules. For example, there are things that the user can and can't do. If the user gave the command to attack an innocent planet, the AI of the starship, will do research before this command is executed. The captains might identify the user and determine his rank. Next, they will follow military rules of attacking an innocent planet and what constitute as right and wrong.

Transforming Machine

In the transformers cartoon, there exist a robot that can transform into 6 machines: a robot, a tank, a lion, a fortess, a gun, and a plane.

What if there is a machine that can change its hardware. For example, a car can change into a plane or a boat or a truck or a forklift. The AI time machine can train any type of machine. If the machine is a car, the AI time machine stores pathways from that car. If the machine is a plane, the AI time machine stores pathways from that plane. If there was a universal machine that changes its hardware, the AI time machine will extract pathways for that present machine. For example, if the machine is a car it will extract pathways in the AI time machine on cars. If the machine is a plane it will extract pathways in the AI time machine on planes.

For each type of machine, it's software program will be different. If the machine is a car, there will be a specific software program used by the team of virtual characters. If the machine is a plane, there will be a specific software program used by the team of virtual characters.

Training of the transforming machine will be done separately. It isn't recommended that one captain be trained on three different types of machine. Maybe one captain can train in two different machines, but not 3 or more. Each captain should be skilled in limited fields.

Maybe the captain can be the same, but the other virtual characters are replaced as the machine transforms. For example, a universal machine can transform into 6 different machines. The captain remains the same regardless of what machine it changes into. However, the other virtual characters are replaced (this method should be used to train the universal machine).

This method is used because the captain should be the same person regardless of the machine type. The change in other virtual characters is because each VC has to be skilled in their field.

Note: each virtual character is using many technologies to do their work. They can use software or electronic devices. A virtual character can use a search engine to access knowledge over the internet or they can use photoshop to make an image sharper. For example, if the user asks the AI car to open an image file and to make the image sharper, the virtual character has to go into the user's computer, use the windows operating system to access the image file, open photoshop, and do work to sharpen the image. Finally, after the work is done, the virtual character has to send the file to the user in a viewable manner.

Hierarchically Structured Machines Working Together

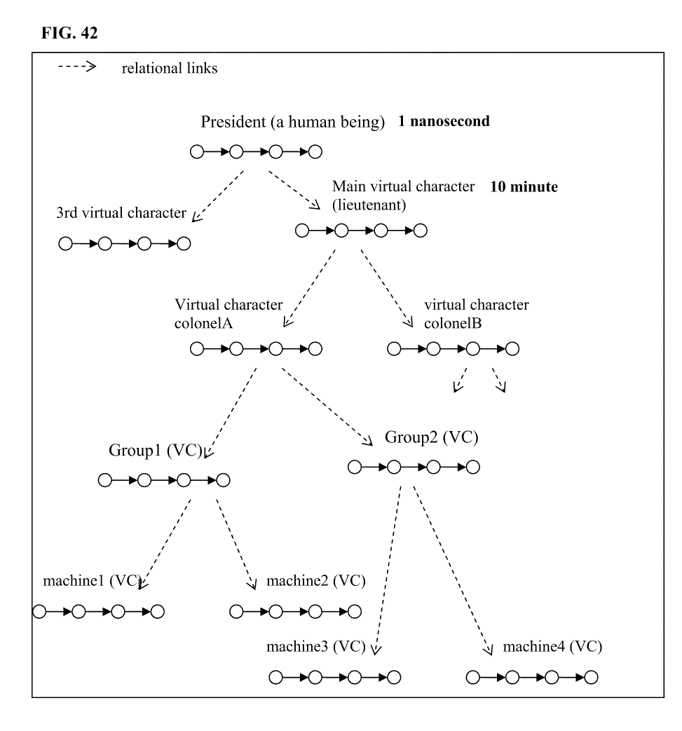

A more advance version of the AI machine is to have hierarchically structured machines that work together to accomplish tasks. FIG. 42 is a diagram depicting hierarchically structured military machines. Each machine is fully automated and doesn't require any user input. The president is human and he is the only person that gives commands to the machines. The president is the user.

The lieutenant and the colonel are virtual characters and they are used to coordinate all the groups and give each group tasks to do. The president will give an order, the lieutenant will devise a plan and the colonel will divide tasks and tell each group what they have to do.

Each machine will have communication software that will send and receive inputs/outputs from its superior officer. For example, machine1 will get inputs from group1 and group1 will get inputs from colonelA and colonelA will get inputs from the lieutenant and the lieutenant will get inputs from the president.

The job of the lieutenant is to talk to the president and his cabinets about what must be done. The lieutenant will devise a plan to achieve the goals of the president. These goals are sent to the colonels so they can devise a strategic plan. The plan will be broken up into parts and given to two groups. Each group will break up their tasks into smaller pieces and given to individual AI machines.

Conflicts in the hierarchical chain of command are solved by common knowledge and if each ranking officer wants to question a command, they can go through standard procedures to be heard.

This hierarchical structure can be applied to any business or industry. Hierarchically structured machines can be created for planes or cars. AI towers can be created, each controlled by team of virtual characters, to coordinate landing permission from planes in their air space. In the case of cars, hierarchical structured machines can be created for vehicles to travel on the streets autonomously. Hierarchical traffic towers can be stationed in various areas to coordinate the autonomous vehicles. Individual cars can receive permission and tasks from hubs and these hubs can receive permission and tasks from traffic towers.

Other Topics:

Past Prediction

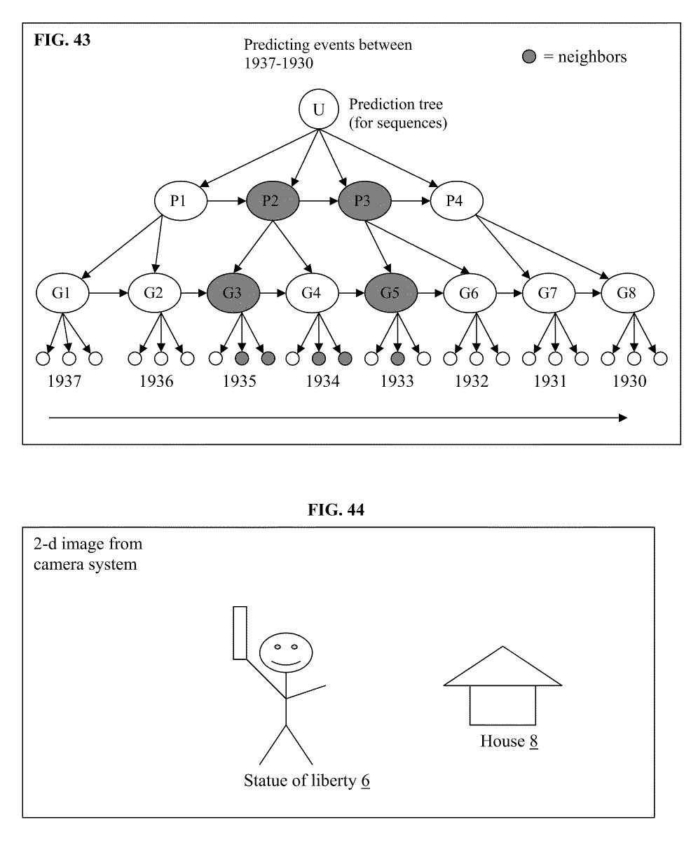

The method to predict the future can also be used to predict the past. FIG. 43 is a diagram depicting how the prediction tree for sequences can be used to predict the past. The virtual characters will start their predictions in 1937 and it will incrementally advance to 1930. For each sequential year they want to add to their prediction, they will generate added branch predicted models into the prediction tree. For example, if the virtual characters wanted to predict G1, branches of predicted models will be added to the prediction tree. Next, if the virtual characters wanted to predict G2, branches of predicted models will be added to the prediction tree. Then, if the virtual characters wanted to predict G3, branches of predicted models will be added to the prediction tree. This goes on and on until 1930. Thus, sequential predictions require the merging of branches of predicted models. The merging is done during runtime and under the supervision of virtual characters.

What Constitutes as an Object in a Predicted Model?

An object can be anything and because some objects are too abstract to describe, it is important for me to address this issue. Very obvious objects that have set and defined boundaries are small physical objects. A human being has set boundaries. All the body parts, and their clothing is the boundary of a human being. A pencil has set boundaries. A chair has set boundaries. Even a house has set boundaries.

Objects that describe a situation or an event are harder to represent. Words like car accident, the accident scene, the laboratory situation, the crime, the concert event and so forth, do not have fixed and defined boundaries.

Let's use football as an example. An object can be, “the fans are going wild”. This sentence encapsulates all the fans on the stadium and their collective activities (their cheers and motions). This abstract object has no boundaries and limits. People can actually interpret the object in different ways.

In order for the virtual characters to understand the description and boundaries of objects for predicted models, they use “common knowledge”. Everyone doing predictions on the prediction internet knows an approximate description and boundary of an object. This way, when different virtual characters have to do predictions on an abstract object, they have a universal understanding of the object. Also, virtual characters can use different words to represent the same object. These virtual characters can use deduction skills to conclude that one word is similar to another word.

Language is a very powerful way to represent simple and abstract objects. Language can be used to represent places, things, events, objects, time and actions. Let's say the virtual characters are trying to predict the 5 sense data for the quarterback. One object in the quarterback's 5 senses is: “the fans go wild”. This object encases any data that is sensed by the quarterback such as the visual images of the fans, the sound coming from their voices, and the paper they are throwing in the air. The QB might be focused on the game and in his peripheral vision he can see the fans. A virtual character might designate all fan images and the sound they make to be one object.

The virtual character might use this object to determine the exact location of where the current pathway will be stored in the QB's memory. The virtual character might have two choices to select from. These two choices are to store it in the left area or to store it in the right area. The storage of the current pathway in the QB's memory is based on the fan object. Maybe the overall pixel color of the fans will decide where the current pathway will be stored. If the overall pixel color is close to blue, then the current pathway will be stored in the left area; and if the overall pixel color is close to red, then the current pathway will be stored in the right area.

The fan object encases all the fans and their activities on the stadium. This object will affect the future because it might determine where the QB will store its current 5 sense data (called the current pathway) in memory.

Very obvious objects like the QB and the receiver are very prominent. A predicted model might include the actions of the QB and the receiver based on a strategy. In football there are different strategies between players. Square-in, square-out and long throw are just some strategies between the QB and the receiver. If an object is square-out, the receiver will run straight and turn to the right/left real fast. At this point, the QB will throw the ball to the receiver.

The object, square-out, encases the linear activities between the QB and the receiver during that gameplay. If this square-out is an object in a predicted model, the virtual characters will only focus on the QB and the receiver and any opponent player that will affect the square-out strategy.

Some strategies require the entire team to execute. The virtual characters have to understand what players are involved in a strategy because these players are a part of the strategies.

Another abstract object is time and events. For the most part, the virtual characters predict the future in segmented increments, but some events are overlapping or they encase an estimated time. For example, the words: “the entire game”, represents the 4 hour football game. The words: “the next gameplay”, represents one football scene (which doesn't have a fix time). The next gameplay can last for 10 seconds or 30 seconds.

Some objects in predicted models can span several linear gameplays or fragmented gameplays. The linear goals of the QB might span 4 gameplays or spaced-out gameplays. If virtual characters have to predict the linear goals of the QB, they won't know exactly when he will execute each goal. At this point, the predictions made will be based on estimations and assumptions.

The point I'm trying to make is that the virtual characters that are doing predictions will have a hard time to interpret abstract objects in predicted models. They must use common knowledge in order to do their predictions and to understand complex object descriptions.

Logical Observation

By using words and sentences to represent objects, events, time and actions, the virtual characters are actually observing and labeling sequential events. The QB's brain can actually be predicted by comparing his past linear gameplays. For example, an automated software can be created to determine what is happening in a football game. Every action and strategy in the game are labeled. A virtual character can observe the labeled events and try to guess what the QB was thinking before he makes a gameplay. Universal pathways of the QB can be formed if the virtual characters use this method. After many observations of gameplays for the QB, the virtual characters can form a simulated brain of the quarterback. This simulated brain may not be exact, but it gives information about the universal strategies the QB uses.

Universal pathways of the QB include strategies that are consistent in similar gameplays. For example, the QB might use a particular strategy when the score is low and he might use another strategy when the score is high. It's up to the virtual characters to observe past gameplays of the QB, use automated event labeling software, and to form a simulated brain of the QB.

The automated event labeling software can also predict the most likely future event. For example, the QB might repeat certain strategies over and over again. He might throw the ball to the receiver in two gameplays and in the third gameplay he gives it to the runningback. So, the next time the QB throws two times to the receiver, the automated labeling software will predict he will give the ball to the runningback in the third gameplay. By the way, the automated labeling software is the AI time machine. The pathways for the AI time machine, in this case, will record virtual characters observing and labeling past football games for this QB.

The universal pathways might include simple discrete math functions like: if-then statements, for-loops, recursive loops, while-loops and functions. If the QB's goal is to throw the ball to the receiver, then focus on the receiver and if he is open throw the ball. If the QB's goal is to pass to the runningback, then pass the ball to the runningback as fast as possible. If the ball is close to the touchdown line, then give the ball to the runningback or if a player is clearly open then pass to player.

The universal pathways are just simple if-then statements that determine decision making. The simulated brain of the QB will most likely be populated with universal pathways. As the virtual characters do more research, they can uncover greater details of what pathways exist in the QB's brain. The signalless technology will help to map out the physical atom-by-atoms in the QB's brain using AI.

The virtual characters can take information from the simulated brain (created by virtual characters) and information from the signalless technology to create an exact brain model of the QB. The information from both methods will merge together to predict exactly what the QB will think and do in the future.

Simulating Physical Object Interactions

When two cars collide there is a certain way that they interact with each other to end up as smashed cars. Atom-by-atom simulations are required to predict the future results of two or more object interactions. The virtual characters have to handcraft a simulation program that will take video observations and to form an exact 3-d model in the software.

The simulated program has to factor in hidden aspects, which can be handcrafted by the virtual characters, such as gravity, and perspective. Based on 2-d images on the moon or on Earth, the simulated program can generate gravity statistics. Math equations can automatically be calculated, like the speed and velocity of objects.

The idea is to create a simulated program whereby, atom-by-atom information about an object is fed into the software. All object interactions within the simulation will act exactly like they would in the real world. If two non-intelligent cars collided with each other in the real world, the simulated models of the two cars colliding will have the same results.

In terms of a human being, there are many tiny living organisms that make a human being. Cells in the human being are living and they act based on a primitive intelligence. Bacteria live in the human being and they act based on a primitive intelligence. However, the most important intelligence comes from the human being's brain. By predicting how the brain works and what chemical signals are sent to the body, we can calculate how the physical body will act.

A human being's brain is intelligent; and the human being's physical body is non-intelligent. A simulation software is going to map out atom-by-atom of the human being's physical body. The virtual characters, on the other hand, have to predict the chemical signals that will be sent from the brain to the rest of the body. These chemical signals determine how the human being's body parts move.

Given that the human being's physical body is copied into a simulated program (by the signalless technology), and the virtual characters have predicted the exact chemical signals that the human being's brain will output, the human being's future simulation can be 100 percent accurate. Even if there are slight imperfections in terms of the atom structure of the human being's physical body, and the chemical signals outputted by the brain isn't 100 percent identical, the simulation will still come very close to the real thing.

A human being is the most important simulation object that the virtual characters have to predict. If you look at non-intelligent complex objects like a computer, the whole physical structure of the computer can be copied in a simulation program and it should work exactly like it would in the real world. Software programs can be running within a computer within another computer. For example, a simulation object can be a computer system and this computer system is running WindowsXP. If you compare, a real computer running WindowsXP and a virtual computer running WindowsXP, they are identical.

The simulation is running the WindowsXP software in a physical computer system inside another computer system. The physical computer system has to have simulated components like electricity and wires and physical computer hardware. The simulation program has to factor in the amount of electricity coming into the physical computer. Where the electricity will travel and how the computer's hardware will process the WindowsXP software must be known too.

If you play videogames, sometimes the screen slows down or encounters computer glitches. The virtual characters have to simulate how a physical computer system in the real world will behave in a virtual environment. Sometimes, a large videogame is played on a computer with slow processing speed. This will result in the videogame slowing down or freezing. This behavior must be simulated in the virtual world. Although every copy of WindowsXP is the same, the physical computer running the software is different. Thus, the activities of WindowsXP might be slightly different for different physical computers.

As you can see, simulating windowsXP isn't as easy as running the software in a virtual environment. The physical computer has to be simulated and it has to interact with the WindowsXP software to produce results on the monitor. Both the WindowsXP software, as well as, the physical computer system has to be simulated as a group in a virtual environment.

Signalless Technology Example

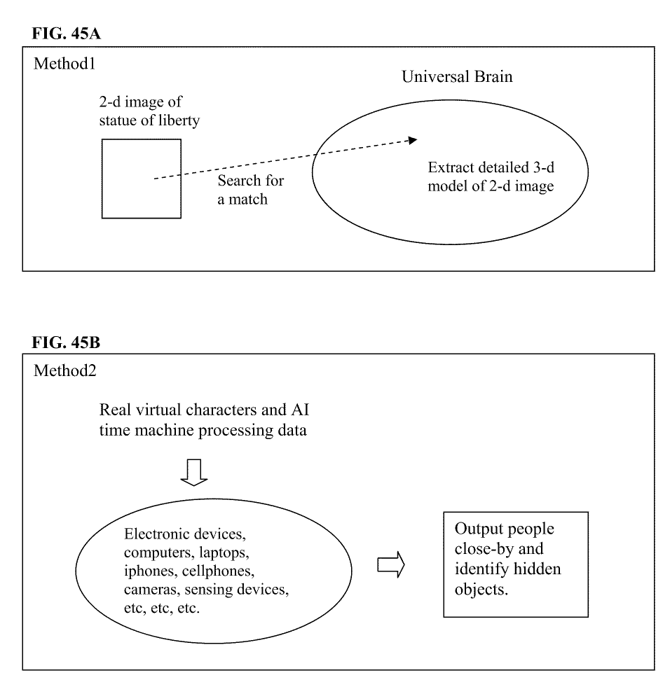

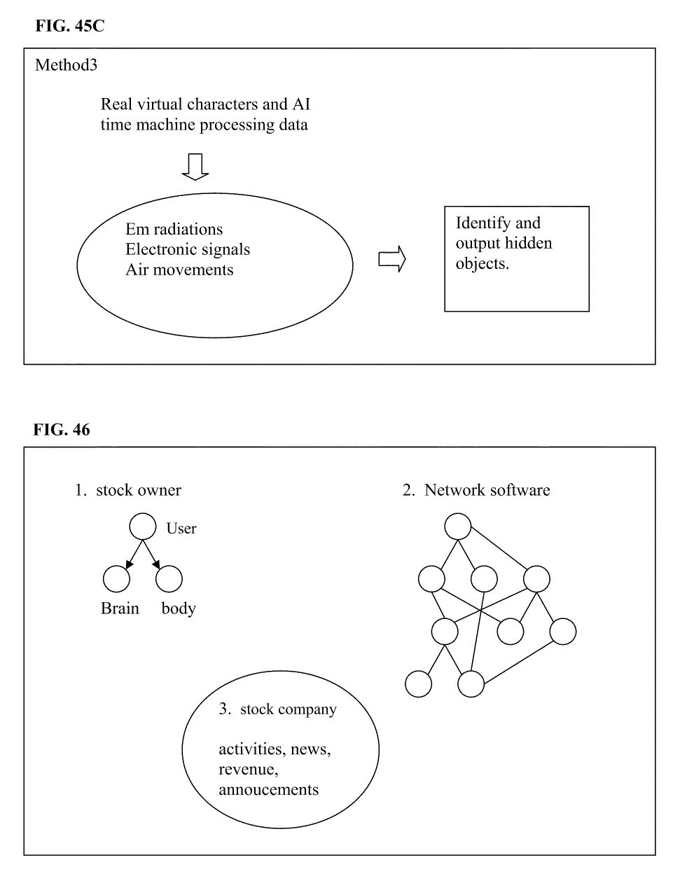

FIGS. 44 and 45A-45C are diagrams depicting the intelligence that is needed to map out the atom-by-atom structure of the current environment in the fastest time possible. The diagrams depict three methods to collect and generate data for the signalless technology. All three methods work together in order to track every single atom of the current environment. The first method is to take a 2-d image from an electronic device like a camera system or a camera on a laptop, and find a match in the universal brain (FIG. 45A). The purpose is to locate where the 2-d image was made in the world. If the 2-d image is the statue of liberty 6, then the camera system is located in New York.

The universal brain stores robot pathways and electronic device pathways (like a camera system) in memory. These robot pathways form a 3-d map of the environment these robots have encountered. There is a map of the entire world in the universal brain because robots and camera systems are located all over the world. Objects like houses, streets, buildings, lakes, and stores are all stationary objects. They don't move and they will probably be there in the future. By locating the place the camera system is in, we can extract the detailed location from the universal brain.

For example, if the 2-d image is the statue of liberty 6, then there is a detailed atom-by-atom of the statue of liberty 6 in the universal brain. This detailed model will be used to help the signalless technology find out what objects in our current environment exists, atom-by-atom. This detailed model of the statue of liberty 6 contains the external, as well as, internal objects that make up the statue of liberty 6. The signalless technology now has a better idea of what objects are hidden from the camera.

In another example, the environment model in memory of New York will also tell the signalless technology what objects are behind the camera system or below it.

Although the environment extracted from the universal brain, based on the 2-d image, won't be exactly the same as the current environment, the signalless technology will try to find out what the current environment is, atom-by-atom.

The universal brain stores pathways from intelligent, as well as, non-intelligent objects. It can store pathways from robots or it can store pathways from a camera system. Changes in the environment will be witnessed by robots or electronic devices and this information will update the environment models in the universal brain. Stationary objects that are consistently the same every time will have a permanent storage location in the universal brain, while moving objects like human beings are stored in fragmented areas. For human beings, the places they visit will be where their pathways are stored in memory. If a human being goes home and then goes to work, then goes back home, then information from the human being will be stored in primarily two places: his home and his workplace.

The environment models extracted from the universal brain outlines how consistent objects are. If a building hasn't changed for 100 years, then it should tell people that the building is most likely there now. On the other hand, there might be a billboard on a street that changes every week. The environment models should say how consistent objects are so that the signalless technology can guess wither objects has changed presently.

Referring to FIG. 45B, the second method includes using real virtual characters or the AI time machine to process data from electronic devices to track where intelligent objects are currently located. Let's say that there is a house 8 several yards away from the statue of liberty 6. The camera system can only see the external part of house 8, but nothing inside is visible. The signalless technology will use real virtual characters or the AI time machine to search the internet and find out where human beings are. If someone from house 8 is using a cellphone, the virtual characters can assume that someone is physically in house 8 making a call. The virtual characters will analyze phone number records and find out who owns the cellphone, then they will analyze the voice of the caller and confirm that Dave is in house 8 (example1).

In another part of house 8, another person is using the internet. The virtual characters will tap into the internet and find out that someone is shopping for girl shoes at Wal-mart. They assume it's a girl on the computer. Next, they find out who is registered to the internet connection. They found out it was Dave's wife, Jessica. The virtual characters will assume that Jessica is on the computer shopping for shoes (example2).

Yet, in another case, the virtual characters check news coming out of house 8 in the internet and finds out that the government fixed the pothole that was on the street behind house 8. The virtual characters will assume that the pothole on the street behind house 8 is fixed. The camera system can't see it (example3).

Yet, in another case, the virtual characters might have access to a camera system on Jessica's computer and they can see the interior of house 8. Now, the virtual characters can map out the objects inside house 8. Once objects are identified, the universal brain contains these objects in memory, so detailed simulated models can be extracted to represent these objects. For example, if the camera shows a printer, the simulated model extracted will be a printer with all of its exterior and interior atom structures (example4).

These four examples shows that the real virtual characters or the AI time machine can be used to gather more data on the current environment and to create a more detailed map of the environment. In example1, Dave is identified and tracked. In example2, Dave's wife, Jessica is identified and tracked. In example3, a recent event changed the street. In example4, the interior of house 8 is mapped out.

The virtual characters use data from electronic devices to track moving objects like human beings, animals, insects, and bacteria.

Referring to FIG. 45C, the third method includes using real virtual characters and the AI time machine to process data from the camera system. The job of the virtual characters this time is to take em radiation and to find out how they traveled to get to the camera. They serve as a sonar system that bounces off objects (buildings, houses bridges, humans, etc). em radiation can either be absorbed by other atoms or it can bounce off other atoms. Both types of behavior will be analyzed to create this sonar system.

The virtual characters will also analyze em radiation to find out what types of atom emitted each em radiation. Spectral analysis can be used to find out atom types from em radiation data. Em radiation are unique to some atoms, or molecules or large objects. If the camera system picks up strong gamma rays, that means something radioactive is close by to the camera system. There might be an em radiation that belongs to a small flower that the camera system doesn't visibly see.

Another job for the virtual characters is to analyze air movement. Air can also act as a sonar system to map out hidden objects not contained in the visibility area of the camera. They will try to find out how the air moved in the short past to get to the camera. What objects have they bounced off or went around to get to the camera lenses? Thus, their job is to find out how air traveled and bounced around to reach the camera lenses.

Yet, another job for the virtual characters is to analyze electronic transmissions in the air. This data can be processed to identify who sent the data and where electronic devices are currently located. What is contained in an electronic transmission can also tell a lot about the sender, such as who this person is and who the receiver is.

In conclusion to this section, all three methods are used in combinations and permutations in order for the signalless technology to map out the current environment, atom-by-atom. The AI time machine is used to encapsulate work and to manage complexity. For example, virtual character pathways can be assigned to fixed interface functions in the AI time machine so that the signalless technology can use these fixed interface functions to do work.

By the way, the simulated model stored in the universal brain is a well-crafted model by teams of virtual characters. They analyze the functions of an object and break it down into software functions. The simulated model is ultimately a software program that represents an object in the real world. For example, a simulated model of a printer will not only contain the physical structure of the printer, but also simulate its functions.

Prediction Tree for the Stock Market

Referring to FIG. 46, the most important aspects about a stock owner is his brain and his physical body. Each stock owner is a human being so they will all have a brain and a body as their lower levels. Each stock owner will probably be using a computer to sell, observe and buy stocks. In the lower levels of the computer object there are the computer's software/hardware; and the trading software.

There will be a central server, located in the stock exchange and contains the trading software for all stock owners. There are three parts that the virtual characters are primarily concerned with: 1. the network of users. 2. the stock company. 3. the individual stock owners. The prediction tree to represent the stock market for one company will be based on breaking and grouping objects together in a hierarchical tree. For example, a stock owner that has 1 million shares is more important than a stock owner who owns 50 shares. The three parts depicted in the diagram must be predicted in a uniform manner.

The factors that determines object dependability for a human being (a stock owner) are: 1. their 5 senses. 2. their thoughts. The factors that determine object dependability for a computer are: 1. user input. 2. software/hardware of computer. The factors that determine object dependability for a network are: 1. software. 2. input from users.

Clarification on One of the Claims

Claim1 states: “at least one dynamic robot is required to train said AI time machine, and tasks are trained from simple to complex through a process of encapsulation using said AI time machine,”. This claim means that training go from simple to complex, whereby tasks are encapsulated. The dynamic robots use the AI time machine to encapsulate tasks. For example, the AI time machine can learn to write software programs through gradual training. The dynamic robots will first train the AI time machine to write a simple software program such as a program that outputs hello world on the monitor. Next, the dynamic robots will train the AI time machine on simple class software programs like a program to convert Fahrenheit to Celsius. Then, the dynamic robots will train the AI time machine to write a complex software program, such as a database system using recursion. Finally, the dynamic robots will work in a team to write really large software programs like an operating system.

Human beings learn to do complex tasks through a bootstrapping process, whereby new data is built upon old data. Through self-organization, the complex tasks will include simple tasks via patterns. For example, writing a very large software program like an operating system might require reference patterns to simple tasks like writing a simple function, writing a class program or writing a database system.

The AI time machine can also encapsulate tasks for the dynamic robots so that they can use the encapsulated tasks for another task. For example, the dynamic robots might encapsulate the task of making a drawing sharper (called task1). Next, it will use task1 multiple times to make one patent drawing (called task2). Finally, it will use task1 and task2 to make all 50 patent drawings for one patent application.

All subject matters related to the atom manipulator, the ghost machines, the universal CPU, the hardwareless computer systems, and the 4^{th} dimensional computer have been described in previous patent applications or books. As far as the claims in this patent application, all external technologies have been described in the overview of the AI time machine (in the beginning part of this patent application).

Motivations of the Dynamic Robots

These robots are self-awared and they sense, think and act like human beings. Humans want something in return for labor. We work because our boss pays us. These dynamic robots probably want something in return for their labor. These dynamic robots will want robot immortality, which the AI time machine can grant. If a dynamic robot is destroyed, the AI time machine can restore that robot to its original state. In order to do this the virtual characters have to do two tasks for the AI time machine: 1. create a perfect timeline of Earth. 2. train the AI time machine to control atom manipulators. The notion of robot immortality gives these dynamic robots motivation to work. If this method fails, each robot has a choice to follow the US constitution. A sense of patriot or duty or love, might be motivation to work on the AI time machine.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method for an AI time machine to accept sequential input tasks from at least one user, manage tasks, and execute tasks simultaneously or sequentially, capabilities of said AI time machine can be at least one of the following: searching for information over the internet, doing tasks for the user that require teams of virtual characters, doing research, writing a book, solving cases for the FBI, tracking people and places, predicting the future or past, solving problems, doing college assignments, writing complex software programs, controlling dummy robots in a factory, controlling atom manipulators, controlling hierarchical external machines, manipulating objects in our environment, building cities, bringing dead people back to life, curing diseases, and time travel, said AI time machine comprising:
at least one dynamic robot is required to train said AI time machine, and tasks are trained from simple to complex through a process of encapsulation using said AI time machine, said training comprising at least one of the following: training individual tasks, training sequential tasks, training simultaneous tasks, and managing multiple tasks based on a hierarchical team of virtual characters, whereby a captain manages, processes, gives orders to lower level workers, and executes tasks;
a main program with two modes, comprising: training mode and standard mode;
external technologies, comprising: universal artificial intelligence programs, human robots with human level intelligence, psychic robots, super intelligent robots, said AI time machine, dynamic robots or virtual characters, a signalless technology, atom manipulators, ghost machines, a universal CPU, an autonomous prediction internet, and a 4-d computer;
a videogame environment for virtual characters to do and store work;
a prediction internet;
a universal brain to store dynamic robot pathways or virtual character pathways, said universal brain comprising: a real world brain, a virtual world brain, and a time machine world brain;
a timeline of Earth that records predicted knowledge of Earth's past, current and future;
a future United States government system; and
a long-term memory.

2. A method of claim 1, wherein said main program with two modes, said training mode allows dynamic robots to train said AI time machine, comprising:
at least one dynamic robot, copies itself into a virtual world as a robot, sets the videogame environment of said AI time machine based on at least one task, copies itself into an AI time machine world as at least one virtual character using investigative tools and said signalless technology to do work, and said robot, operating in said virtual world, assigns fixed interface functions from said AI time machine and linear inputs, while said virtual characters, operating in said AI time machine world, do work to submit desired outputs to said robot,
a software program that observes and analyzes said universal brain to automatically assign fixed interface functions from said AI time machine to repetitive work done by at least one virtual character;
said standard mode allows at least one user to submit sequential tasks through fixed interface functions and said AI time machine will output simultaneous or linear desired outputs, said standard mode comprising at least one of the following:
said AI time machine extracts virtual character pathways from said universal brain and tricks said virtual character pathways in a virtual world to do automated work;
real virtual characters, structured hierarchically, using investigative tools and said signalless technology to do manual work;
said fixed interface functions are at least one of the following: software interface functions, voice commands, a camera system to detect objects, events, and actions, and manual hardware controls.

3. A method of claim 2, wherein said investigative tools comprises: said AI time machine, said prediction internet, all knowledge from said timeline of Earth, all knowledge from said timeline of the internet, research knowledge, knowledge data, software programs, search engines, electronic devices, computers, networks, network software, encapsulated work done by virtual characters, a simulation brain, and a universal brain.

4. A method of claim 2, wherein said work done by virtual characters in said training mode, said virtual characters are structured hierarchically and said virtual characters does at least one of the following:
a captain analyzes at least one user and user's inputs and understands said user's goals, intentions and powers based on human intelligence, manages tasks for said user, accomplish tasks, give tasks to lower level workers, and submit desired outputs to said user;
each virtual character understand their roles, rules, powers, status, limitations and procedures based on common knowledge learned in college, books or legal documents;
each virtual character does work using said investigative tools and said signalless technology;
said captain understands said user's roles, rules, powers, status, limitations and procedures based on common knowledge learned in college, books or legal documents;
said virtual characters can use said investigative tools to predict the future and act based on the best future possibility.

5. A method of claim 1, in which said current environment of Earth's timeline is generated by said signalless technology, said signalless technology generates a map on said current environment in the quickest time possible, and records all objects in said current environment in a hierarchical clarity tree, comprising:
at least one sensing device, said sensing device comprising: a camera, a 360 degree camera, GPS, electronic devices, human robots, machines, a sonar device, an EM radiation device; and
an AI system that uses said AI time machine to encapsulated work to process input data from said sensing device.

6. A method of claim 5, wherein said AI system comprises: teams of virtual characters using said investigative tools and automated software to do at least one of the following:
analyzing and extracting hierarchical data from said sensing devises,
generating a 3-d map hierarchically of all visual data from all said sensing devises,
using human intelligence to analyze, process, and identify objects, events and actions in sensing devices, identify where each sensing device is located on Earth and the time of recordings,
using human intelligence to assume, from investigated data, the locations and actions of objects not sensed by said sensing devices,
using simulated models to represent objects identified or assumed in said 3-d map, said simulated models reveal at least one of the following: inner objects and hidden objects,
using human intelligence to analyze, process and identify em radiations, atoms, molecules, and intelligent signals from said sensing devices to assume where microscopic objects are located in said 3-d map;
using human intelligence and software to determine how each em radiation or atom traveled to hit said sensing devices, said em radiations travel based on refraction or reflection and atoms travel based on bounces; and
submitting said 3-d map to said prediction internet in a streaming speedy manner to be used by other virtual characters to predict at least one of the following: future events and past events.

7. A method of claim 1, wherein objects, events and actions in said timeline of Earth's past and future are generated by virtual characters using a universal prediction algorithm method, said universal prediction algorithm comprises: at least one prediction tree; said prediction internet; a common knowledge container, said signalless technology, and said AI time machine.

8. A method of claim 7, wherein said prediction tree comprises hierarchically structured predicted models, each predicted model comprises: focused objects, peripheral objects, at least one software program, prediction outputs, and assigned teams of specialized virtual characters.

9. A method of claim 1, in which said prediction internet is a website that virtual characters can go to to insert, delete, modify and merge prediction data, said prediction internet further contains streaming data from said signalless technology and software programs to organize, distribute, and search for specific data.

10. A method of claim 7, wherein said AI time machine encapsulates work done by virtual characters using said universal prediction algorithm method, said work are ever detailed data of predictions as time passes, said work done by said virtual characters, comprising:
using said investigative tools to extract at least one prediction tree from said prediction internet for each prediction;
hierarchically and uniformly assign teams of virtual characters to do work in predicted models for each prediction tree;
each virtual character has human level intelligence and uses said investigative tools and said signalless technology to do their predictions in said prediction internet;
each virtual character in a team knows their roles, powers, rules to follow, limitations, prediction tasks, procedures and goals based on said common knowledge container;
teams of virtual characters will insert, delete, modify and merge prediction trees to combine predictions in terms of at least one of the following: lengthening predictions and merging predictions.

11. A method of claim 10, in which said teams of virtual characters are concerned with at least one of the following while doing a prediction:
a team's prediction is based on their predicted model's focused objects and peripheral objects;
external data should be extracted from spaced out neighbor predicted models for processing, designing their software programs, and outputting prediction data;
follow goals, rules and procedures set forth in said common knowledge container to do predictions; and
using said prediction internet to insert, delete, modify and merge predicted models or prediction trees based on at least one of the following factors: automated software programs, said investigative tools, and said virtual characters manually inserting, deleting, modifying and merging predicted models.

12. A method of claim 1, wherein said autonomous prediction internet predicts objects, events and actions in the timeline of Earth's past, current and future; and generate knowledge data on Earth, comprising at least one of the following:
said AI time machine extracts virtual character pathways from said universal brain and tricks said virtual character pathways in a virtual world, using minimal computer processing by running vital objects, to do automated work;
real virtual characters, structured hierarchically, using said investigative tools, said signalless technology, and using said universal prediction algorithm method to do manual work;

13. A method of claim 1, wherein said AI time machine serves as a central brain for at least one of the following universal machines: a machine, a hierarchical team of machines, a complex machine requiring thousands of individual workers, and a transforming machine, said universal machine, comprises a hierarchical team of virtual characters controlling a host machine to do at least one of the following:
a captain analyzes at least one user and user's inputs and understand said user's goals, intentions and powers based on human intelligence, manages tasks for said user, accomplish tasks, give tasks to lower level workers, and submit desired outputs to said user;
each virtual character understand their roles, rules, powers, status, limitations and procedures based on common knowledge learned in college, books or legal documents;
each virtual character does work using said investigative tools and said signalless technology;
said captain understands said user's roles, rules, powers, status, limitations and procedures based on common knowledge learned in college, books or legal documents;
said virtual characters can use said investigative tools to predict the future for said team of virtual characters and the current environment; and act based on the best future possibility.

14. A method of claim 13, in which said universal machine is fully automated and allows at least one user to submit sequential tasks through fixed interface functions and said universal machine will output simultaneous or linear desired outputs, the AI of said universal machine, comprising at least one of the following:
said AI time machine extracts virtual character pathways from said universal brain and tricks said virtual character pathways in a virtual world, using minimal computer processing to run vital objects, to do automated work;
real virtual characters, structured hierarchically, using investigative tools and said signalless technology to do manual work;

15. A method of claim 13, in which said transforming machine have at least one fixed captain as said machine transforms; and have different specialized virtual characters as said machine transforms;

16. A method of claim 1, wherein said atom manipulator manipulates objects in said current environment, generates hierarchically structured ghost machines, and providing said ghost machines' intelligence, physical actions, and communications, to create at least one of the following technologies: a technology to build cars, planes and rockets that travel at the speed of light, build intelligent weapons, create physical objects from thin air, teleport objects, allow targeted time travel, use a chamber to manipulate objects, build force fields, make objects invisible, build super powerful lasers, build anti-gravity machines, create strong metals and alloys, create the smallest computer chips, store energy without any solar panels or wind turbines, make physical DNA, manipulate existing DNA, make single cell organisms, control the software and hardware of computers, servers and electronic devices without an internet connection, and manipulate any object in the world.

17. A method of claim 16, in which said ghost machines are hardwareless machines, each said ghost machine comprises: electronic components and mechanical actions, said electronic components comprising at least one of the following: a universal CPU or hardwareless computer system, a semi hardwareless computer system, and a simulation inside said atom manipulator; and said mechanical actions are generated by said atom manipulator.

18. A method of claim 17, wherein said universal CPU mimics the electronic activities of a real computer system, said universal CPU comprising: a laser system, ghost input gates, ghost communication input gates, ghost output gates, ghost circuit gates, ghost RAM, ROM, and cache registers, a microscopic objects reserve area, and a database.

19. A method of claim 18, in which said universal CPU uses microscopic object interactions to generate Boolean algebra, said universal CPU comprising the steps of:
extracting pathways from said database to control laser system;
processing machine instructions from a ghost computer system;
generating ghost circuit gates;
processing said microscopic object interactions;
combining processors and transmitting at least one of linear outputs and parallel outputs to said ghost computer system.

20. A method of claim 1, wherein said 4-d computer is a hardware computer system that runs our universe, the steps to create a robot in said 4-d world and to control said 4-d computer, comprises:
understanding every aspect of our universe; finding the patterns between our universe and the physical activities in said 4-d computer;
creating a plurality of artificial devices, said artificial device comprises: an artificial sonar device, an artificial sensing device, and an artificial atom manipulator;
create a robot in the 4-d world using said artificial devices; and
repeating these steps for higher level dimensional worlds.
